(19) United States
(12) Patent Application Publication
(10) Pub. No.: US 2017/0102826 A1
(43) Pub. Date: Apr. 13, 2017

(54) TOUCH PANEL SYSTEM AND ELECTRONIC EQUIPMENT

(71) Applicant: SHARP KABUSHIKI KAISHA, Osaka (JP)

(72) Inventor: Mutsumi HAMAGUCHI, Osaka (JP)

(73) Assignee: Sharp Kabushiki Kaisha, Osaka (JP)

(21) Appl. No.: 15/310,623

(22) PCT Filed: Apr. 15, 2015
(86) PCT No.: PCT/JP2015/061595

§ 371 Date: Nov. 11, 2016

(30) Foreign Application Priority Data
Jun. 30, 2014 (JP) 2014-135317

(51) Int. Cl. G06F 3/041; G06F 3/0354; G06F 3/038; G06F 3/044

(52) U.S. Cl. CPC G06F 3/0418; G06F 3/044; G06F 3/03545; G06F 3/0383

(57) ABSTRACT

The influence of noise which changes over time in touch detection is suppressed in a timely manner. A touch panel system (1b) is provided with a touch panel (2), a driving circuit (4), a reading unit (40), a period definition unit (41) which defines a noise reading period for reading a noise signal while the driving circuit (4) does not drive capacitors, and a driving definition unit (42) which defines a driving pattern based on a noise signal read in the noise reading period.

### TECHNICAL FIELD

The present invention relates to a system which uses a touch panel and electronic equipment which uses the system.

### BACKGROUND ART

In PTL 1, the present inventors disclosed an electrostatic capacitance value distribution detection apparatus capable of determining the presence or absence of external noise. In the electrostatic capacitance value distribution detection apparatus of PTL 1, the noise is detected by switching a connection state between drive lines and sense lines of a touch panel.

### CITATION LIST

### Patent Literature

PTL 1: International Publication No. 2014/042128 (published Mar. 20, 2014)

### SUMMARY OF INVENTION

### Technical Problem

However, in order to detect the noise, the electrostatic capacitance value distribution detection apparatus of PTL 1 needs to compare the electrostatic capacitance value distribution before switching the connection state between the drive lines and sense lines and the electrostatic capacitance value distribution after switching the connection state. It is necessary to have a configuration and an operation for switching the connection state between the drive lines and the sense lines in order to perform this operation (comparison). In addition, there is a problem in that it takes time to detect the noise and carry out convergence to a pattern which is able to suppress the influence of detected noise (that is, to select a touch panel driving pattern where the influence of noise is small).

In view of the above problems, the present invention has an object of detecting noise in touch detection in a timely manner and suppressing the influence of noise which changes over time, regardless of the presence or absence of a configuration for switching a connection state between drive lines and sense lines.

### Solution to Problem

In order to solve the above problems, a touch panel system according to an aspect of the present invention is provided with a touch panel which has a plurality of capacitors respectively formed at intersections between a plurality of first signal lines and a plurality of second signal lines, and a controller which controls the touch panel, in which the controller is provided with a driving circuit which drives the capacitors along the first signal lines based on a driving pattern in a touch detection period which is a period for detecting a touch position on the touch panel, a reading unit which is provided to read a linear sum signal along the second signal lines based on electrical charges stored in the capacitors driven by the driving circuit, a period definition unit which defines a noise reading period for reading a noise signal mixed into the touch panel in a period in which the driving circuit does not drive the capacitors, and a driving definition unit which defines the driving pattern of the touch detection period based on the noise signal read by the reading unit in the noise reading period.

### Advantageous Effects of Invention

According to the aspect of the present invention, it is not necessary to switch a connection state between drive lines and sense lines in order to detect noise. The aspect of the present invention exhibits an effect in which it is possible to read the noise in the operation of the touch panel, and suppress the influence of noise which changes over time in the touch detection in a timely manner. Furthermore, the aspect of the present invention exhibits an effect in which it is possible to read the noise in a timely manner without the need to operate the touch panel simply to read the noise.

### BRIEF DESCRIPTION OF DRAWINGS

FIG. 1 is a block diagram which shows a configuration of a signal processing system according to reference embodiment 1.

FIG. 2 is a graph which shows frequency characteristics between noise amounts and sampling frequencies of a time-sequence signal which is processed by the signal processing system and a signal change amount of the time-sequence signal.

FIG. 3 is a circuit diagram which shows a configuration of a touch panel system according to reference embodiment 1.

FIG. 4 is a circuit diagram for illustrating a driving method of the touch panel system.

FIG. 5 is a diagram for illustrating formulae which show the driving method of the touch panel system.

FIG. 6 is a circuit diagram which shows a situation in which noise is applied to the touch panel system.

FIG. 7 is a circuit diagram for illustrating a parallel driving method of the touch panel system.

FIG. 8 is a diagram for illustrating formulae which show the parallel driving method of the touch panel system.

FIG. 9 is a diagram for illustrating formulae which show a method for parallel driving the touch panel system according to M-sequence codes.

FIG. 10 is a circuit diagram which shows a configuration of another touch panel system according to reference embodiment 1.

FIGS. 11(a) to 11(d) are diagrams for illustrating embodiment units which drive capacitors according to the other touch panel system.

FIGS. 12(a) to 12(c) are diagrams for illustrating a method for reverse driving the capacitors according to the other touch panel system.

FIG. 13 is a waveform diagram of a driving signal and the like when implementing driving using a second vector following driving using a first vector according to the other touch panel system.

FIG. 14(a) is a waveform diagram of a driving signal and the like when implementing driving using a first vector continuously according to the other touch panel system, and FIG. 14(b) is a waveform diagram of a driving signal and the like when implementing driving according to a phase 0 of the first vector continuously.

FIG. 15(a) is a waveform diagram of a driving signal and the like when implementing driving using a first vector continuously according to the other touch panel system, and FIG. 15(b) is a waveform diagram of a driving signal and the like in a case of reversing the driving using the first vector at even-numbered times.

FIG. 16(a) is a waveform diagram of a driving signal and the like when implementing driving using phase 0 of a first vector continuously, and FIG. 16(b) is a waveform diagram of a driving signal and the like in a case of reversing the driving using the phase 0 of the first vector at even-numbered times.

FIG. 17(a) is a waveform diagram of a driving signal and the like when implementing driving using a first vector to a third vector continuously according to the other touch panel system, and FIG. 17(b) is a waveform diagram of a driving signal and the like in a case of reversing the driving using the first vector to the third vector at even-numbered times.

FIGS. 18(a) and 18(b) are graphs which show frequency characteristics of 4-fold sampling according to the other touch panel system.

FIG. 19 is a graph which shows frequency characteristics of other 4-fold sampling according to the other touch panel system.

FIGS. 20(a) and 20(b) are graphs which show frequency characteristics of still other 4-fold sampling according to the other touch panel system.

FIGS. 21(a) and 21(b) are diagrams for comparing the driving method of the other touch panel system.

FIG. 22 is a circuit diagram which shows a configuration of a touch panel system according to reference embodiment 2.

FIG. 23 is a block diagram which shows a configuration of electronic equipment according to reference embodiment 3.

FIG. 24 is a block diagram which shows a configuration of a touch panel system according to reference embodiment 4 of the present invention.

FIG. 25 is a schematic diagram which shows a configuration of a touch panel provided on a touch panel system according to reference embodiment 4 of the present invention.

FIG. 26 is a circuit diagram which shows a schematic configuration of a multiplexer according to reference embodiment 4 of the present invention.

FIG. 27 is a circuit diagram which shows an example of a specific configuration of a connection switching unit according to reference embodiment 4 of the present invention.

FIG. 28(a) is a diagram which shows a synchronization waveform of a pseudo-random sequence which has Manchester coded periodicity transmitted from the touch panel controller to the stylus pen in the touch panel system in reference embodiment 5 of the present invention, and FIG. 28(b) is a waveform diagram which shows a synchronization waveform and a touch detection waveform.

FIG. 29 is a block diagram which shows a configuration of the touch panel system.

FIG. 30 is a wiring diagram which shows a configuration of a touch panel provided in the touch panel system.

FIG. 31 is a circuit diagram which shows a configuration of a multiplexer for switching the connection between signal lines connected to the touch panel and drive lines connected to a driver and senses line connected to a sense amplifier.

FIG. 32 is a block diagram which shows a configuration of a stylus pen in the touch panel system.

FIG. 33 is a timing chart which shows a basic operation for obtaining synchronization in the stylus pen.

FIG. 34(a) is a diagram which shows an output relationship between the touch panel and the stylus pen in the touch panel controller and in the drive lines of the driver and the sense lines of the sense amplifier, and FIG. 34(b) is a waveform diagram which shows a synchronization waveform and a touch detection waveform.

FIG. 35(a) is a waveform diagram which shows a driving waveform such as a synchronization waveform and a touch detection waveform, which is transmitted from the touch panel controller to the stylus pen, and low-frequency noise, FIG. 35(b) is a waveform diagram which shows a state where the driving waveform and the low-frequency noise are superimposed, and FIG. 35(c) is a waveform diagram which shows a state which is reset according to a reset timing.

FIG. 36 is a diagram which shows a configuration of a reset circuit provided in a synchronization signal detection circuit in the stylus pen.

FIG. 37(a) is a waveform diagram which shows an example of a synchronization waveform transmitted from the touch panel controller, FIG. 37(b) is a waveform diagram which shows an input waveform received by a stylus pen, FIG. 37(c) is a waveform diagram which shows an internal waveform when a reference potential is determined at a reset timing R1 in FIG. 37(b), and FIG. 37(d) is a waveform diagram which shows an internal waveform when a reference potential is determined at a reset timing R2 in FIG. 37(b).

FIG. 38(a) is a waveform diagram which shows a synchronization waveform using an M-sequence code “1110010” in a case of not using Manchester encoding, and FIG. 38(b) is a waveform diagram which shows a synchronization waveform using a Manchester coded M-sequence code “1110010”.

FIG. 39(a) is a waveform diagram which shows an example of a long synchronization waveform of a High period transmitted from the touch panel controller, FIG. 39(b) is a waveform diagram which shows a reset timing R3 of an input waveform received by a stylus pen, and FIG. 39(c) is a waveform diagram which shows an internal waveform when a reference potential is determined at the reset timing R3 in FIG. 39(b).

FIG. 40 is an operation image diagram which shows a correspondence relationship between a driving operation of a touch panel controller and a driving operation of a stylus pen.

FIGS. 41(a) to 41(c) are diagrams which show specific driving operations in a synchronization signal detection period, a rest period, and a normal driving period shown in FIG. 40.

FIG. 42(a) is a waveform diagram which shows a touch panel system in reference embodiment 6 of the present invention and which shows an input waveform of a signal received by the stylus pen, and FIG. 42(b) is a waveform diagram which shows an internal waveform when a reference potential is determined at reset timings R1 to R6.

FIG. 43(a) is a waveform diagram which shows an example of a synchronization waveform transmitted from the touch panel controller, FIG. 43(b) is a waveform diagram which shows reset timings R7, R8, and R9 of the input waveform received by a stylus pen, and FIG. 43(c) is a waveform diagram which shows a synchronization waveform when a reference potential is determined at reset timings R7, R8, and R9 shown in FIG. 43(b).

FIG. 44 is a timing chart which shows an output waveform of a touch panel controller provided with a fixed period directly before a synchronization waveform is output.

FIG. 45(a) is a waveform diagram which shows an example of a synchronization waveform transmitted from the touch panel controller, FIG. 45(b) is a waveform diagram which shows reset timings R11, R12, and R13 of the input waveform received by a stylus pen, and FIG. 45(c) is a waveform diagram which shows a synchronization waveform when a reference potential is determined at reset timings R11, R12, and R13 shown in FIG. 45(b).

FIG. 46(a) is a diagram which shows a transmission method of a synchronization waveform transmitted by drive lines DL₁ to DL_{L} of a driver in the touch panel controller, FIG. 46(b) is a waveform diagram which shows an input waveform received by a stylus pen, and FIG. 46(c) is a waveform diagram which shows a synchronization waveform when a reference potential is determined by initially carrying out resetting in a fixed period shown in FIG. 46(b).

FIG. 47 is an operation image diagram which shows a correspondence relationship between a driving operation of a touch panel controller and a driving operation of a stylus pen.

FIG. 48 is a diagram which shows a specific driving operation in a fixed period shown in FIG. 47.

FIG. 49 is a circuit diagram which shows a configuration of the touch panel system of embodiment 1 of the present invention.

FIGS. 50(a) and 50(b) are timing charts which illustrate an operation in which a period definition unit defines a noise reading period in the touch panel system shown in FIG. 49; FIG. 50(a) shows an operation before defining the noise reading period, and FIG. 50(b) shows an operation after defining the noise reading period.

FIGS. 51(a) and 51(b) are timing charts which illustrate an operation in which the period definition unit defines the noise reading period in the touch panel system shown in FIG. 49 of embodiment 2 of the present invention; FIG. 51(a) shows an operation before the noise reading period is defined, and FIG. 51(b) shows an operation after the noise reading period is defined.

FIGS. 52(a) and 52(b) are timing charts which illustrate an operation in which the period definition unit defines the noise reading period in the touch panel system shown in FIG. 49; FIG. 52(a) represents an operation before the noise reading period is defined, and FIG. 52(b) represents an operation after the noise reading period is defined.

FIGS. 53(a) to 53(d) are block diagrams which show a reading unit provided in the touch panel system shown in FIG. 49 of embodiment 3 of the present invention in a simplified manner; FIG. 53(a) shows a simplified configuration of the reading unit, FIG. 53(b) shows a simplified operation of the reading unit, FIG. 53(c) shows another simplified operation of the reading unit, and FIG. 53(d) shows still another simplified operation of the reading unit.

FIGS. 54(a) and 54(b) are graphs which show the results of simple addition-averaging two continuous outputs of an AD conversion circuit according to a setting of a phase length in embodiment 4 of the present invention; FIG. 54(a) shows a graph of a case where the sampling frequency of the AD conversion circuit is 400 kHz, and FIG. 54(b) shows a case where the sampling frequency is 600 kHz.

FIGS. 55(a) and 55(b) are graphs which show noise transfer characteristics in the same vector continuous driving of FIG. 11(c) in which the number of the sampling is 8 and in the same vector continuous reverse driving of FIG. 12(b), in embodiment 5 of the present invention; FIG. 55(a) shows a relationship of a signal change amount with respect to the normalization frequency, and FIG. 55(b) shows a noise estimate amount with respect to the sampling frequency.

### DESCRIPTION OF EMBODIMENTS

### Reference Examples

Description will be given of examples as references for understanding the embodiments of the present invention.

<<Configuration of Touch Panel System>>

### Reference Embodiment 1

### Configuration of Signal Processing System 10

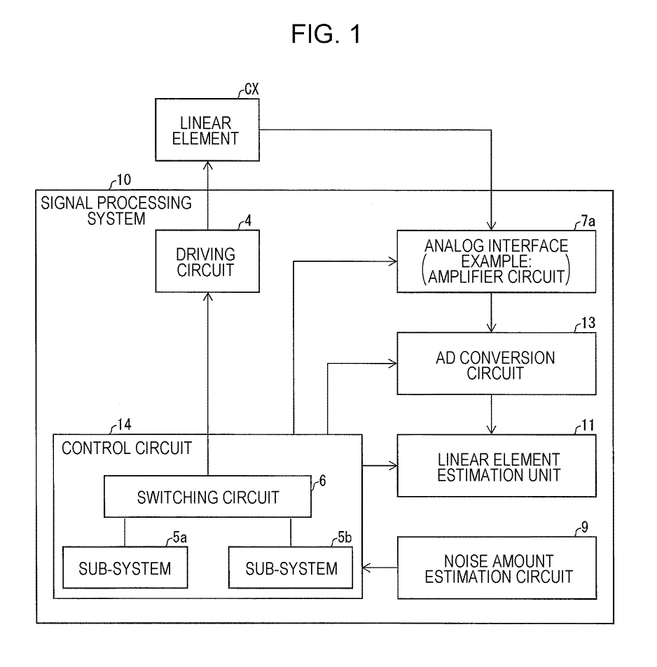

FIG. 1 is a block diagram which shows a configuration of a signal processing system 10 according to reference embodiment 1. The signal processing system 10 is provided with a driving circuit 4 which drives a linear element CX, and a control circuit 14 which controls the driving circuit 4.

The control circuit 14 has sub-systems 5a and 5b having different input and output transfer performances from each other, and a switching circuit 6 which connects either of the sub-systems 5a and 5b to the driving circuit 4.

The linear element CX is driven by the driving circuit 4 controlled by the sub-system 5a or 5b to supply a time-sequence signal having a value which changes from moment to moment while being continuously or discontinuously measurable to an analog interface circuit 7a (for example, an amplifier circuit). The analog interface circuit 7a amplifies the time-sequence signal for output to an AD conversion circuit 13. The AD conversion circuit 13 AD converts the time-sequence signal supplied from the analog interface circuit 7a and supplies a plurality of the time-sequence signals sampled at discontinuous times and changing from moment to moment to a linear element estimation unit 11. The linear element estimation unit 11 estimates the value of the linear element CX or the input of the linear element CX by performing signal processing based on addition and subtraction on the plurality of time-sequence signals based on the AD converted linear element CX. The signal processing system 10 is provided with a noise amount estimation circuit 9 which estimates the noise amount which is mixed into the time-sequence signals from the estimated value of the linear element CX or the estimated value of the input of the linear element CX according to the linear element estimation unit 11.

Based on the noise frequency, noise amount, and input and output transfer performance mixed in to the time-sequence signals, the switching circuit 6 links to the driving circuit 4 by switching the sub-systems 5a and 5b so as to reduce the influence of noise mixed into the results estimating the value or the input of the linear element CX by performing signal processing based on addition and subtraction.

The control circuit 14 controls the analog interface circuit 7a. For example, the control circuit 14 controls the signals corresponding to even-numbered phase driving and odd-numbered phase driving which switch the input state to the amplifier circuit. In addition, the control circuit 14 controls the sampling frequency of the AD conversion circuit 13 and the multiplex sampling number. Furthermore, the control circuit 14 controls the operation of the linear element estimation unit 11.

The multiplex sampling number of the time-sequence signal from the linear element CX based on the sub-system 5a and the multiplex sampling number of the time-sequence signal from the linear element CX based on the sub-system 5b may be different. Then, the sampling frequency of the time-sequence signal from the linear element CX based on the sub-system 5a and the sampling frequency of the time-sequence signal from the linear element CX based on the sub-system 5b may be different.

The positive and negative codes of the plurality of time-sequence signals based on the sub-systems 5a and 5b may be reversed in time series. In addition, the positive and negative codes of the plurality of time-sequence signals based on the sub-systems 5a and 5b may be constant in time series.

The switching circuit 6 switches the sub-systems 5a and 5b based on the estimation results of the noise amount estimation circuit 9.

The linear element CX may, for example, be a capacitor. The linear element CX may be a thermometer provided with a thermocouple. In such a case, the signal processing system 10 is established even without the driving circuit 4. After amplifying a small voltage (micro-current) which is able to be measured using a thermocouple using the amplifier circuit, sampling is carried out by the AD conversion circuit 13 and, by changing the sampling number and the sampling frequency of the multiplex sampling, it is possible to realize a configuration where it is possible to reduce the influence of noise.

(Frequency Characteristics Between Noise Amount and Sampling Frequency and Signal Change Amount)

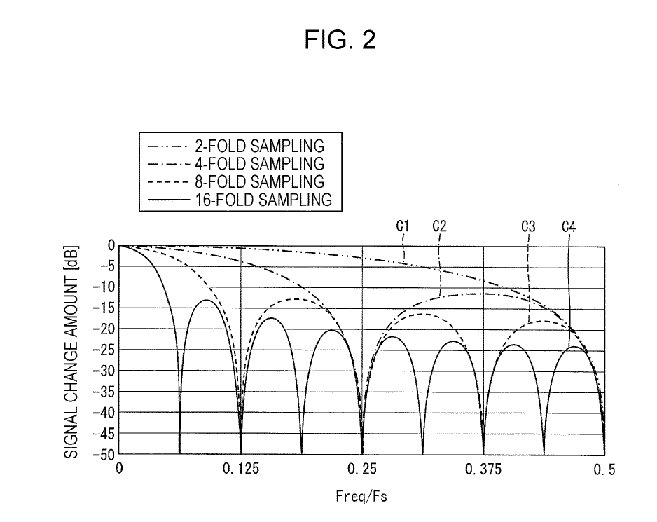

FIG. 2 is a graph which shows the frequency characteristics between the noise amount and the sampling frequency of the time-sequence signals processed by the signal processing system 10 and the signal change amount of the time-sequence signals. The horizontal axis indicates the normalization coefficient which is the ratio of the signal frequency and the sampling frequency. The vertical axis indicates the signal change amount of the signals.

Characteristic C1 indicates the frequency characteristic of 2-fold sampling for outputting a simple moving average by sampling two signals. Characteristic C2 indicates the frequency characteristic of 4-fold sampling for outputting a simple moving average by sampling four signals, and characteristic C3 indicates the frequency characteristic of 8-fold sampling for outputting a simple moving average by sampling eight signals. Then, characteristic C4 indicates the frequency characteristic of 16-fold sampling for outputting a simple moving average by sampling 16 signals.

From the graph of the frequency characteristics, in 2-fold sampling, the signal change amount when the normalization coefficient is 0.5 is −∞ dB as shown by characteristic C1. Accordingly, when the sampling frequency is set to twice the noise frequency, it is possible to eliminate the influence of noise. In addition, it is possible to reduce the influence of noise even when the sampling frequency is changed such that the normalization frequency approaches 0.5.

In 4-fold sampling, the signal change amount is −∞ dB when the normalization coefficient is 0.5 and 0.25 as shown by characteristic C2. Accordingly, when the sampling frequency is set to 2 times or 4 times the noise frequency, it is possible to eliminate the influence of noise. It is possible to reduce the influence of noise even when the sampling frequency is changed such that the normalization frequency approaches 0.5 or 0.25.

In 8-fold sampling, when the normalization coefficient is 0.5, 0.375, 0.25, and 0.125, the signal change amount is −∞ dB as shown by characteristic C3. Accordingly, when the sampling frequency is set to 2 times, 2.67 times, 4 times, or 8 times the noise frequency, it is possible to eliminate the influence of noise. It is possible to reduce the influence of noise even when the sampling frequency is changed such that the normalization frequency approaches 0.5, 0.375, 0.25, or 0.125.

Even in 16-fold sampling, as shown by the characteristic C4, it is possible to eliminate or reduce the influence of noise by setting or changing the sampling frequency.

In this manner, it is possible to eliminate or reduce the influence of noise by setting or changing the sampling frequency with respect to the noise frequency.

For example, when the normalization frequency is 0.25, the signal change amount in 2-fold sampling is −3 dB; however, the signal change amount in 4-fold sampling, 8-fold sampling, and 16-fold sampling is −∞ dB. Accordingly, when the multiplicity of the multiplex sampling is changed from 2-fold to any one of 4-fold sampling, 8-fold sampling, and 16-fold sampling, it is possible to eliminate the influence of noise. In this manner, changing the multiplicity of the multiplex sampling also makes it possible to eliminate or reduce the influence of noise.

Accordingly, it is possible to eliminate or reduce the influence of noise by setting the sampling frequencies of the plurality of sub-systems shown in FIG. 1 to be different or setting the multiplicity of the multiplex sampling to be different and then switching with the switching circuit 6 to the sub-system in which the multiplicity and the sampling frequency are set such that the signal change amount “dB” shown in FIG. 2 is small (a negative value with a large absolute value) based on the frequency of the noise.

(Configuration of Touch Panel System 1)

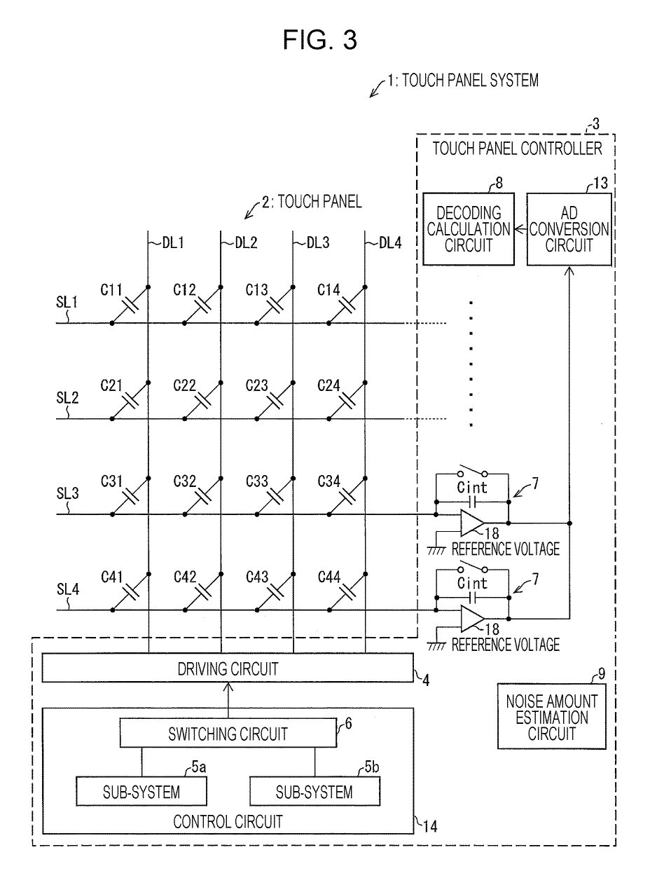

FIG. 3 is a circuit diagram which shows a configuration of a touch panel system 1 according to reference embodiment 1. The touch panel system 1 is provided with a touch panel 2 and a touch panel controller 3. The touch panel 2 has capacitors C11 to C44 respectively formed at intersections of drive lines DL1 to DL4 and sense lines SL1 to SL4.

The touch panel controller 3 has the driving circuit 4 for driving the capacitors C11 to C44 along the drive lines DL1 to DL4.

The touch panel controller 3 is provided with amplifier circuits 7 which are respectively connected to the sense lines SL1 to SL4. Each amplifier circuit 7 reads and amplifies a plurality of linear sum signals along the sense lines SL1 to SL4 based on the electrostatic capacitance accumulated in the respective capacitors C11 to C44 driven by the driving circuit 4. The amplifier circuits 7 have an amplifier 18, and an integral capacity Cint and a reset switch connected in parallel to the amplifier 18.

The touch panel controller 3 has the AD conversion circuit 13 which analog-to-digital converts the output of the amplifier circuits 7, and a decoding calculation circuit 8 which estimates the respective accumulated electrostatic capacitance in the capacitors C11 to C44 based on the analog-to-digital converted output of the amplifier circuits 7.

The touch panel controller 3 has the control circuit 14 which controls the driving circuit 4. The control circuit 14 has sub-systems 5a and 5b having different input and output transfer performances, and the switching circuit 6 which links to the driving circuit 4 by switching the sub-systems 5a and 5b such that the influence of noise mixed in to the results of estimating the electrostatic capacitance of the capacitors C11 to C44 by the decoding calculation circuit 8 is reduced based on the noise frequency mixed in to the linear sum signals, the noise amount, and the input and output transfer performances.

The control circuit 14 controls the sampling frequency and the multiplex sampling number of the AD conversion circuit 13. Furthermore, the control circuit 14 controls the operation of the decoding calculation circuit 8.

A noise amount estimation circuit 9 is provided, which estimates the amount of noise mixed into the linear sum signal from the estimated value of the electrostatic capacitance according to the signal processing based on the addition and subtraction of the linear sum signal. The switching circuit 6 switches the sub-systems 5a and 5b based on the estimation results of the noise amount estimation circuit 9.

(Operation of Touch Panel System 1)

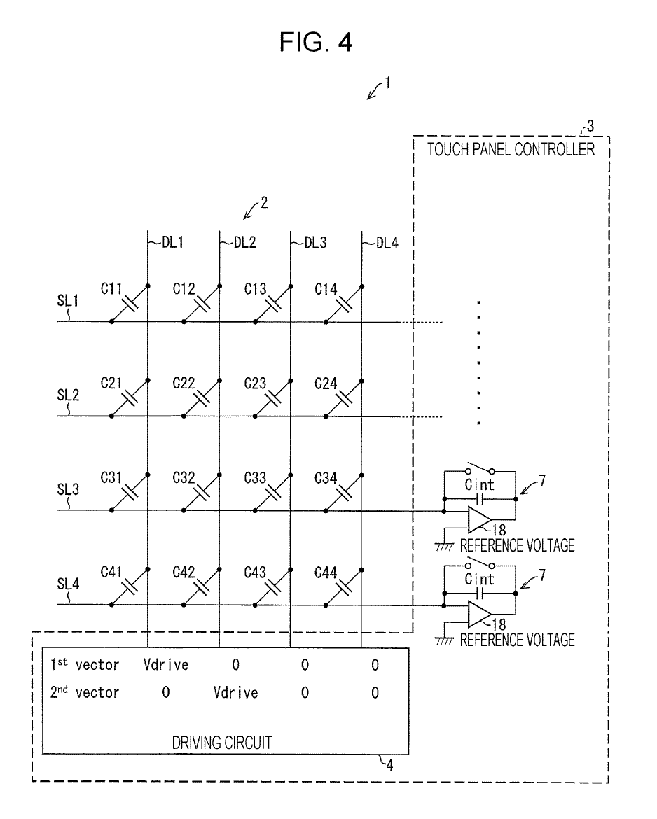

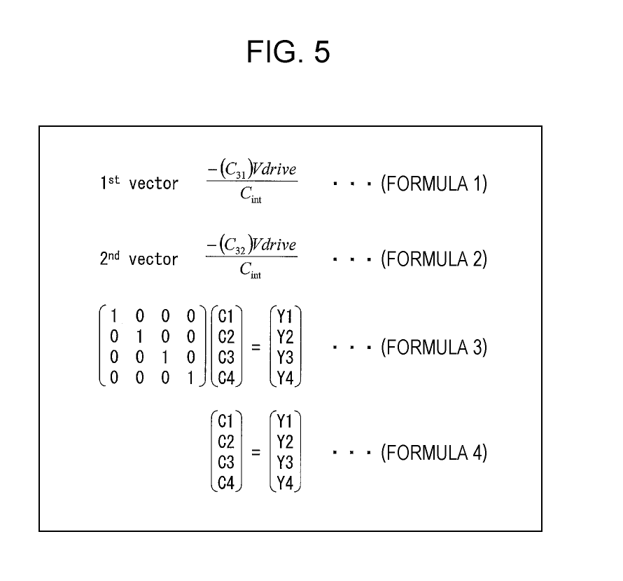

FIG. 4 is a circuit diagram for illustrating the driving method of the touch panel system 1 and FIG. 5 is a diagram for illustrating a formula which shows the driving method of the touch panel system 1.

The driving circuit 4 drives the drive lines DL1 to DL4 based on the four rows and four columns of code sequences shown in Formula 3 in FIG. 5. If the element of the code matrix is “1”, the driving circuit 4 applies a voltage Vdrive, if the element is “0”, the driving circuit 4 applies zero volts.

The amplifier circuits 7 receive and amplify the linear sum measurement values Y1, Y2, Y3, and Y4 of the electrostatic capacitance along the sense lines based on the electrical charges accumulated in the capacitors driven by the driving circuit 4.

For example, in the initial driving out of four times of driving according to the code sequences of the four rows and four columns, the driving circuit 4 applies the voltage Vdrive to the drive line DL1 and applies zero volts to the remaining drive lines DL2 to DL4. By so doing, for example, the measurement value Y1 from the sense line SL3 corresponding to the capacitor C31 where the electrostatic capacitance C₃₁ shown in Formula 1 in FIG. 5 is accumulated is output from the amplifier circuit 7.

Then, in the second time of driving, the voltage Vdrive is applied to the drive line DL2 and zero volts are applied to the remaining drive lines DL1, DL3, and DL4. By so doing, the measurement value Y2 from the sense line SL3 corresponding to the capacitor C32 where the electrostatic capacitance C₃₂ shown in Formula 2 in FIG. 5 is accumulated is output from the amplifier circuit 7.

Next, in the third time of driving, the voltage Vdrive is applied to the drive line DL3 and zero volts are applied to the remaining drive lines. Thereafter, in the fourth time of driving, the voltage Vdrive is applied to the drive line DL4 and zero volts are applied to the remaining drive lines.

By so doing, as shown in Formula 3 and Formula 4 in FIG. 5, the measurement values Y1, Y2, Y3, and Y4 themselves are associated with electrostatic capacitance values C1, C2, C3, and C4, respectively. Here, in Formula 3 and Formula 4 in FIG. 5, for simplicity of notation, the measurement values Y1 to Y4 are written with the coefficient (−Vdrive/Cint) omitted.

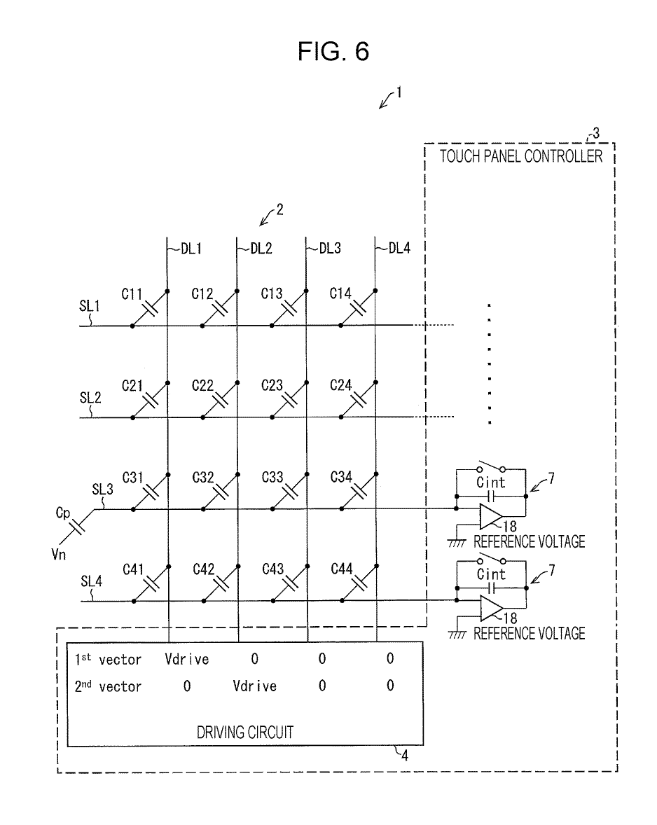

FIG. 6 is a circuit diagram which shows a situation in which noise is applied to the touch panel system 1. When describing the sense line SL3 as an example for the sake of brevity, the linear sum signal is as follows when noise is applied to the linear sum signal read along the sense line SL3 via a parasitic capacitance Cp which is coupled to the sense line SL3.

(−C×Vdrive/Cint)+(−Cp×Vn/Cint)

Accordingly, the noise represented by Ey=−Cp×Vn/Cint is mixed into the linear sum signal.

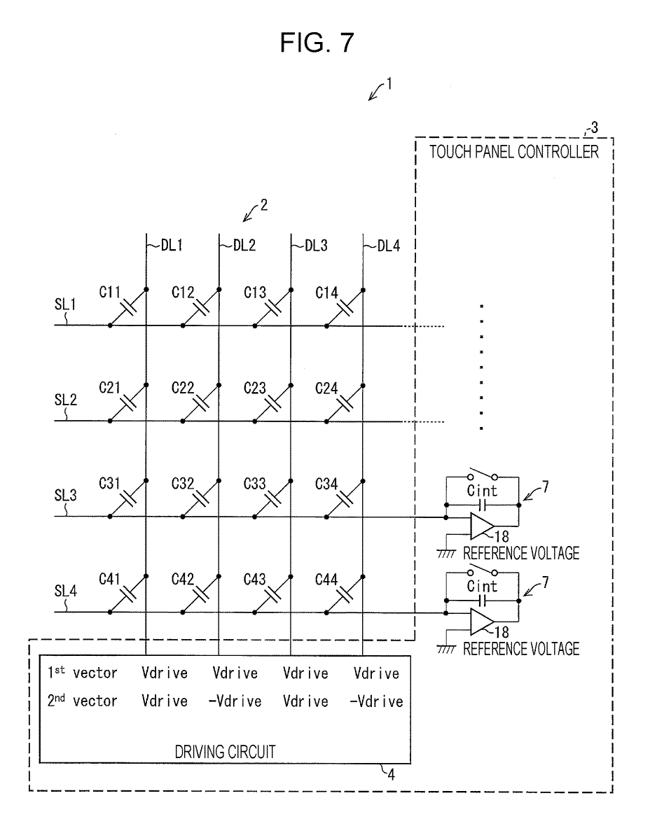

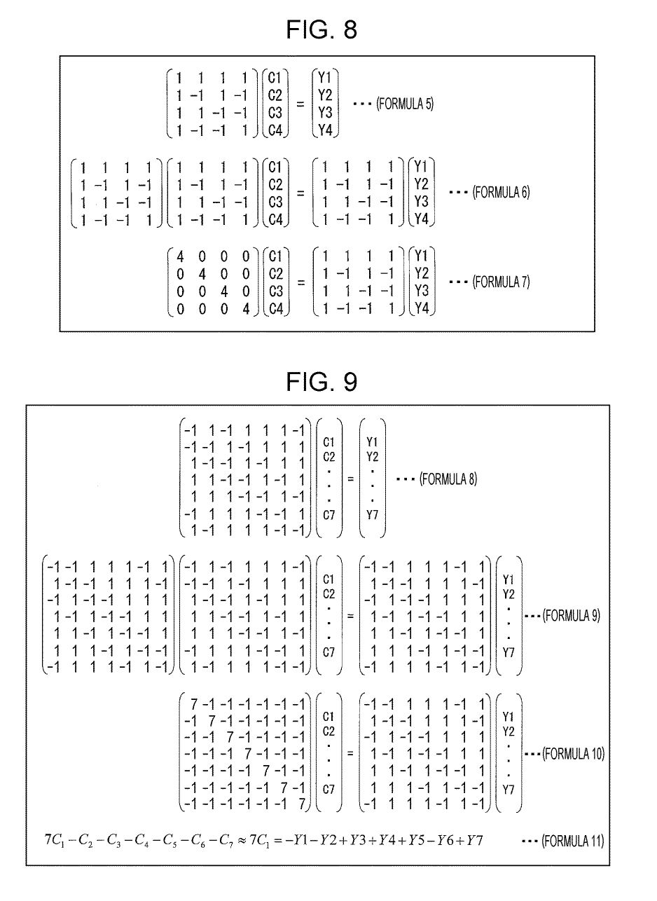

FIG. 7 is a circuit diagram for illustrating a parallel driving method for the touch panel system 1 and FIG. 8 is a diagram for illustrating a formula which shows a parallel driving method for the touch panel system 1.

The driving circuit 4 drives the drive lines DL1 to DL4 based on orthogonal code sequences of four rows and four columns as shown in Formula 5 of FIG. 8. The elements of the orthogonal code sequences are either “1” or “−1”. If the element is “1”, a driving unit 54 applies a voltage Vdrive and if the element is “−1”, the driving unit 54 applies a −Vdrive. Here, the voltage Vdrive may be a power supply voltage or may be a voltage other than the power supply voltage.

Then, as shown in Formula 6 in FIG. 8, it is possible to estimate the electrostatic capacitances C1 to C4 by taking the inner product of the measurement values Y1, Y2, Y3, and Y4 and the orthogonal code columns, as shown in Formula 7.

Since the noise is comparatively large in the touch panel system, the operation is performed a plurality of times and the averaged linear sum signal data may be taken as the true value. By changing the timing of the operation performed a plurality of times, it is possible to realize the sub-systems 5a and 5b (refer to FIG. 3) having different input and output transfer performances.

FIG. 9 is a diagram for illustrating a formula which shows a method for parallel driving the touch panel system 1 using an M-sequence code. It is also possible to estimate the electrostatic capacitance of the capacitors by parallel driving the capacitors using the M-sequence code. As shown in Formula 8 to Formula 11, it is possible to estimate the electrostatic capacitances C1 to C7 by taking the inner product of the measurement values Y1 to Y7. An “M-sequence” is a type of binary pseudo-random number sequence and is formed of only two numbers of 1 and 0 (or 1 and −1 when the 0 is switched to −1). Note that more detailed description will be given below of M-sequences. The length of one period of the M-sequence is 2n−1. An example of an M-sequence where the length=2³−1=7 includes “1, −1, −1, 1, 1, 1, −1”.

(Configuration of Touch Panel System 1a)

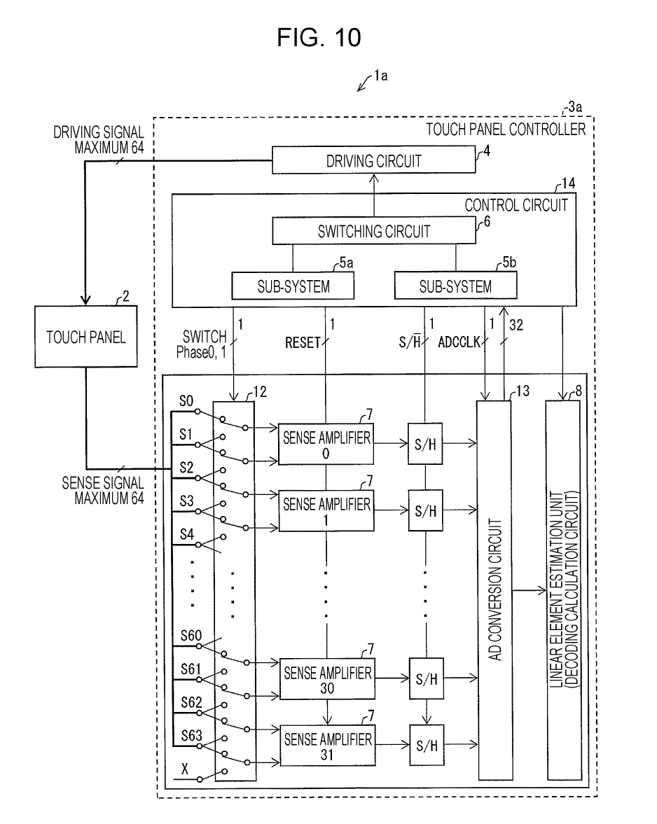

FIG. 10 is a circuit diagram which shows a configuration of another touch panel system 1a according to reference embodiment 1. The constituent elements illustrated in FIG. 3 and the same constituent elements are denoted with the same reference numerals. Accordingly, detailed description of these constituent elements will be omitted.

The touch panel system 1a has a touch panel controller 3a. The touch panel controller 3a has a switching circuit 12. The switching circuit 12 switches the input state of each of the amplifier circuits (sense amplifiers) 7 between an even-numbered phase state (phase 0) in which the (2n)^{th} sense line and the (2n+1)^{th} sense line are input and an odd-numbered phase state (phase 1) in which the (2n+1)^{th} sense line and the (2n+2)^{th} sense line are input. Here, n is an integer of zero or more to 31 or less.

The control circuit 14 controls the amplifier circuits 7. For example, the control circuit 14 controls a signal applied to the switching circuit 12 corresponding to the even-numbered phase driving and the odd-numbered phase driving switching the input state to the amplifier circuits 7. In addition, the control circuit 14 controls the sampling frequency and the multiplex sampling number of the AD conversion circuit 13. Furthermore, the control circuit 14 controls the operation of the decoding calculation circuit 8.

(Driving Method of Touch Panel System 1a)

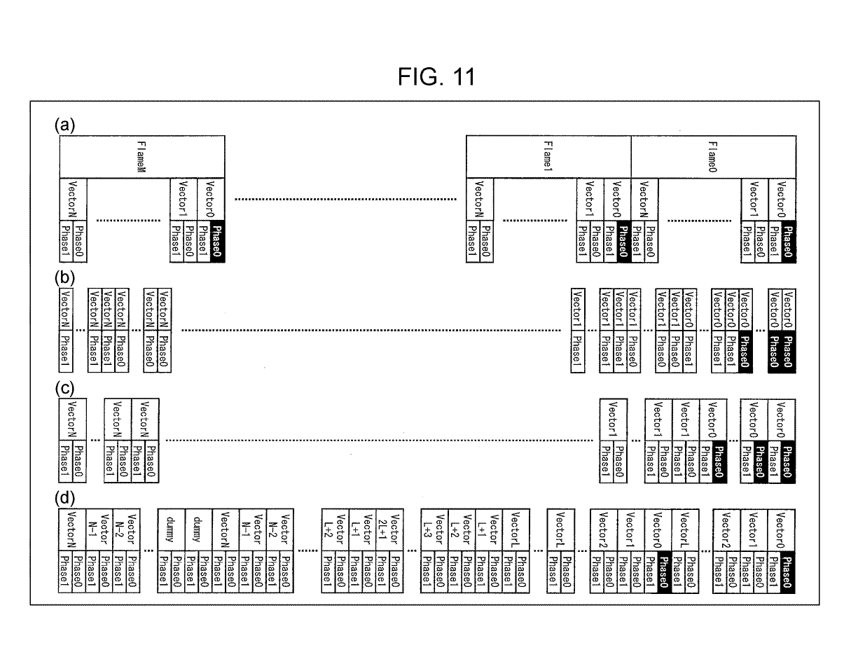

FIGS. 11(a) to 11(d) are diagrams for illustrating an embodiment unit for driving capacitors according to the other touch panel system 1a.

FIG. 11(a) is a diagram for illustrating frame unit driving for driving the capacitors in frame units. The touch panel system 1a repeats frame driving Frame 0 to Frame M (M+1) times in this order. Each frame driving Frame 0 to Frame M includes (N+1) vector driving Vector 0 to Vector N. Each vector driving Vector 0 to Vector N includes an even-numbered phase driving Phase 0 and an odd-numbered phase driving Phase 1.

The even-numbered phase driving Phase 0 (in FIG. 11(a), notated as “Phase 0” in black with white text) of the vector driving Vector 0 included in each of the frame driving Frame 0 to Frame M shown in FIG. 11(a) corresponds to the “plurality of time-sequence signals based on linear elements sampled at discontinuous times” described in the claims.

FIG. 11(b) is a diagram for illustrating phase continuous driving for driving the capacitors continuously at the same phase. First, in the order of phase driving Phase 0 included in the vector driving Vector 0 of frame driving Frame 0, phase driving Phase 0 included in the vector driving Vector 0 of frame driving Frame 1, phase driving Phase 0 included in the vector driving Vector 0 of frame driving Frame 2, . . . , and phase driving Phase 0 included in the vector driving Vector 0 of frame driving Frame M, continuous driving was carried out only with the phase driving Phase 0 of the vector driving Vector 0 included in each of frame driving Frame 0 to Frame M.

Then, in the order of phase driving Phase 1 included in the vector driving Vector 0 of frame driving Frame 0, phase driving Phase 1 included in the vector driving Vector 0 of frame driving Frame 1, phase driving Phase 1 included in the vector driving Vector 0 of frame driving Frame 2, . . . , and phase driving Phase 1 included in the vector driving Vector 0 of frame driving Frame M, continuous driving was carried out only with the phase driving Phase 1 of the vector driving Vector 0 included in each of frame driving Frame 0 to Frame M.

Next, in the order of phase driving Phase 0 included in the vector driving Vector 1 of frame driving Frame 0, phase driving Phase 0 included in the vector driving Vector 1 of frame driving Frame 1, phase driving Phase 0 included in the vector driving Vector 1 of frame driving Frame 2, . . . , and phase driving Phase 0 included in the vector driving Vector 1 of frame driving Frame M, continuous driving was carried out only with the phase driving Phase 0 of the vector driving Vector 1 included in each of frame driving Frame 0 to Frame M. Hereinafter, the driving is carried out up to the vector driving Vector N in the same manner.

FIG. 11(c) is a diagram for illustrating same vector continuous driving for driving the capacitors continuously in the same vector. First, in the order of the vector driving Vector 0 of frame driving Frame 0, the vector driving Vector 0 of frame driving Frame 1, the vector driving Vector 0 of frame driving Frame 2, . . . , and the vector driving Vector 0 of frame driving Frame M, continuous driving was carried out only with the vector driving Vector 0 included in each of the frame driving Frame 0 to Frame M.

Then, in the order of the vector driving Vector 1 of frame driving Frame 0, the vector driving Vector 1 of frame driving Frame 1, the vector driving Vector 1 of frame driving Frame 2, . . . , and the vector driving Vector 1 of frame driving Frame M, continuous driving was carried out only with the vector driving Vector 1 included in each of the frame driving Frame 0 to Frame M.

Next, in the order of the vector driving Vector 2 of frame driving Frame 0, the vector driving Vector 2 of frame driving Frame 1, the vector driving Vector 2 of frame driving Frame 2, . . . , and the vector driving Vector 2 of frame driving Frame M, continuous driving was carried out only with the vector driving Vector 2 included in each of the frame driving Frame 0 to Frame M. Hereinafter, the driving is carried out up to the vector driving Vector N in the same manner.

FIG. 11(d) is a diagram for illustrating a plural vector continuous driving for driving capacitors continuously at a plurality of vectors and the driving is carried out with L+1 continuous vectors as one unit. Here, L is an integer which satisfies 1≦L≦(N−1).

First, in the order of the vector driving Vector 0 to L of frame driving Frame 0, the vector driving Vector 0 to L of frame driving Frame 1, the vector driving Vector 0 to L of frame driving Frame 2, . . . , and the vector driving Vector 0 to L of frame driving Frame M, continuous driving was carried out only with the vector driving Vector 0 to L included in each of the frame driving Frame 0 to Frame M.

Then, in the order of the vector driving Vector L+1 to 2L+1 of frame driving Frame 0, the vector driving Vector L+1 to 2L+1 of frame driving Frame 1, the vector driving Vector L+1 to 2L+1 of frame driving Frame 2, . . . , and the vector driving Vector L+1 to 2L+1 of frame driving Frame M, continuous driving was carried out only with the vector driving Vector L+1 to 2L+1 included in each of the frame driving Frame 0 to Frame M.

Next, in the order of the vector driving Vector 2L+2 to 3L+2 of frame driving Frame 0, the vector driving Vector 2L+2 to 3L+2 of frame driving Frame 1, the vector driving Vector 2L+2 to 3L+2 of frame driving Frame 2, . . . , and the vector driving Vector 2L+2 to 3L+2 of frame driving Frame M, continuous driving was carried out only with the vector driving Vector 2L+2 to 3L+2 included in each of the frame driving Frame 0 to Frame M. In the same manner, the process continues up to the driving of the vector driving Vector N included in the frame driving Frame M.

Here, at the time of driving when the vector driving Vector N included in Frame 0 to Frame M−1, in a case where the number of the vector which is the next vector is not L+1, dummy driving is performed for the shortfall amount or a blank period corresponding to the shortfall period is provided.

In addition, when L=0, the plural vector continuous driving is the same as the same vector continuous driving shown in FIG. 11(c) and, when L=N, the same as the frame unit driving shown in FIG. 11(a).

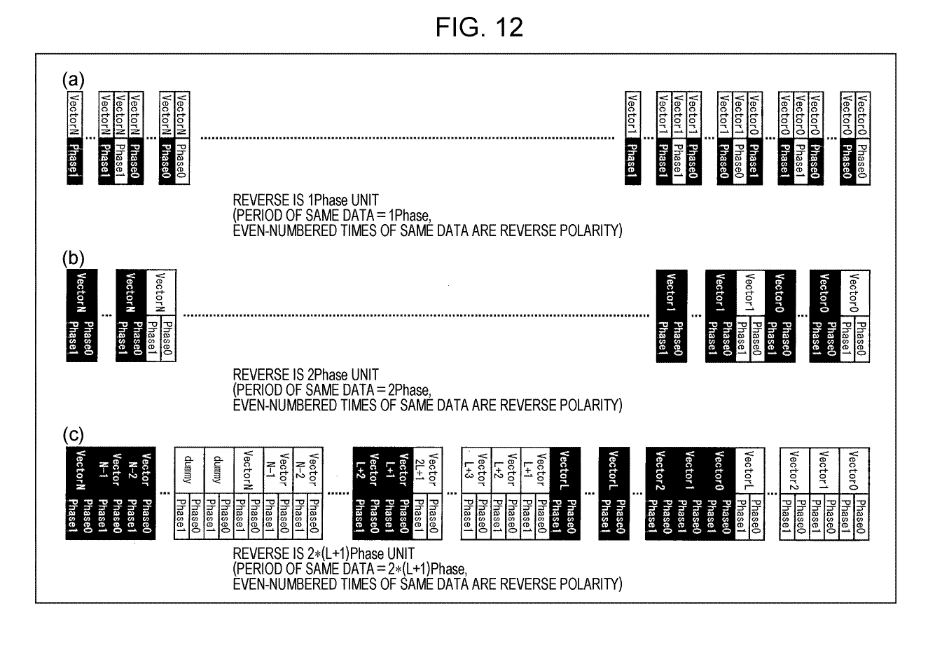

FIGS. 12(a) to 12(c) are diagrams for illustrating a method of reverse driving the capacitors using the touch panel system 1a.

FIG. 12(a) is an example of phase continuous reverse driving which reverses the driving for even-numbered times in the phase continuous driving shown in FIG. 11(b) (the driving location which is reversed is notated in black with white text). First, driving is carried out at phase driving Phase 0 included in the vector driving Vector 0 of the frame driving Frame 0. Then, reverse driving is carried out at phase driving Phase 0 included in the vector driving Vector 0 of the frame driving Frame 1.

Next, driving is carried out at phase driving Phase 0 included in the vector driving Vector 0 of the frame driving Frame 2. After that, reverse driving is carried out at phase driving Phase 0 included in the vector driving Vector 0 of the frame driving Frame 3.

The reversal in the phase continuous reverse driving is performed in one phase driving unit. Then, the acquisition period of the same data for the averaging process is a period corresponding to one phase driving. The polarity of the same data is reversed in the even-numbered times.

FIG. 12(b) shows the same vector continuous reverse driving which reverses the driving for two even-numbered phases in the same vector continuous driving shown in FIG. 11(c) (the even-numbered driving locations which are reversed are notated in black with white text). First, driving is carried out at vector driving Vector 0 of the frame driving Frame 0. Then, reverse driving is carried out at vector driving Vector 0 of frame driving Frame 1. Next, driving is carried out at vector driving Vector 0 of the frame driving Frame 2. After that, reverse driving is carried out at vector driving Vector 0 of frame driving Frame 3.

The reversal in the same vector continuous reverse driving is performed in two phase driving units. Then, the acquisition period of the same data for the averaging process is a period corresponding to the two phase driving. In the same vector continuous reverse driving, the polarity of the even-numbered times of the two phase driving is reversed.

FIG. 12(c) shows the plural vector continuous reverse driving which reverses plurality of even-numbered vectors driving in the plural vector continuous driving shown in FIG. 11(d) (the even-numbered driving locations which are reversed are notated in black with white text). First, driving is carried out at vector driving Vectors 0 to L of frame driving Frame 0. Then, reverse driving is carried out at vector driving Vectors 0 to L of frame driving Frame 1. Next, driving is carried out at vector driving Vectors 0 to L of frame driving Frame 2. After that, reverse driving is carried out at vector driving Vectors 0 to L of frame driving Frame 3.

The reversal in the plural vector continuous reverse driving is performed at the 2×(L+1) phase driving unit. Then, the acquisition period of the same data for the averaging process is a period corresponding to the 2×(L+1) phase driving. In the plural vector continuous reverse driving, the polarity of the even-numbered (2×(L+1)) phase driving is reversed.

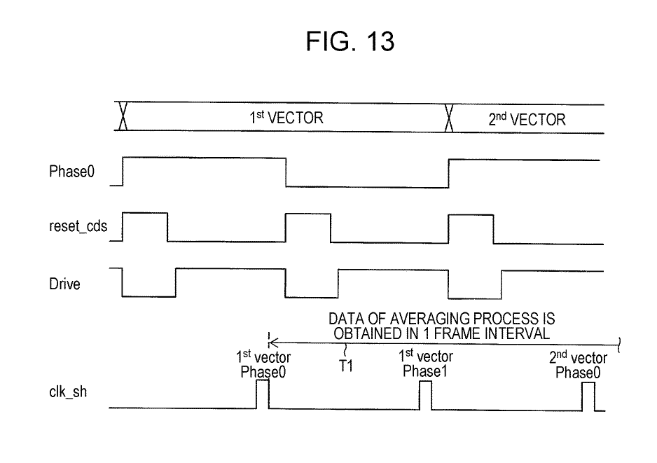

FIG. 13 is a waveform diagram of a driving signal and the like when implementing the driving using the second vector following the driving using the first vector according to the touch panel system 1a. FIG. 11(a) shows a waveform diagram corresponding to the phase driving Phase 0 of vector driving Vector 0 and vector driving Vector 1 in the frame unit driving. When the signal Phase 0 is on, the driving is performed according to the even-numbered phase driving Phase 0, and when the signal Phase 0 is off, the driving is performed according to the odd-numbered phase driving Phase 1. When the reset signal reset_cds is on, the amplifier circuits 7 are reset. If the driving signal Drive is on, the capacitors C11 to C44 are driven. The linear sum signal when the clock signal clk_sh is on is read along the sense lines. The linear sum signal based on the even-numbered phase driving Phase 0 of vector driving Vector 0 is acquired at one frame interval (period T1).

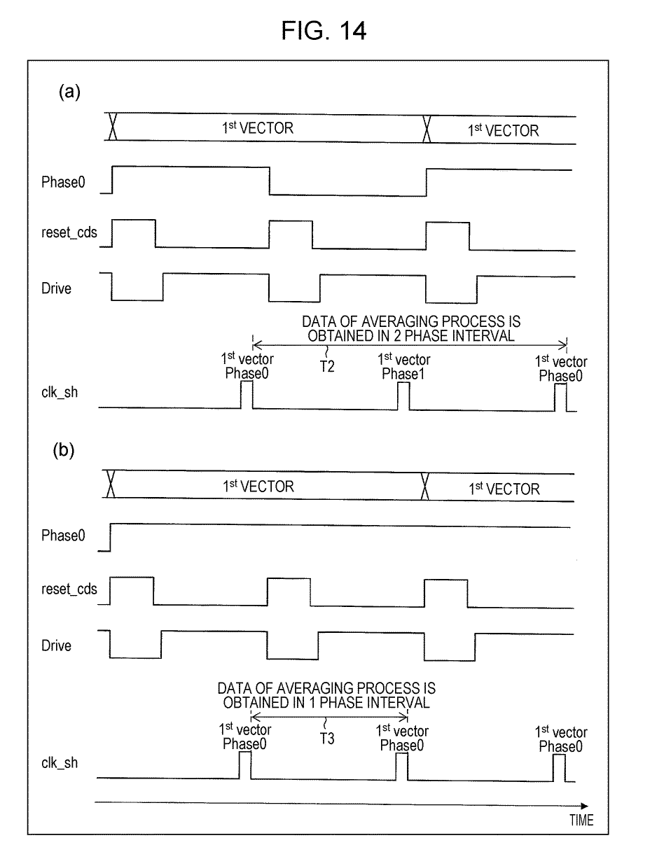

FIG. 14(a) is a waveform diagram of a driving signal and the like when continuously implementing the driving using the first vector according to the touch panel system 1a, and FIG. 14(b) is waveform diagram of a driving signal or the like when continuously implementing the driving using the phase 0 of the first vector.

At the time of same vector continuous driving continuously implementing the vector driving Vector 0 (first vector) as shown in FIG. 11(c), as shown in FIG. 14(a), the linear sum signal according to the vector driving Vector 0 is acquired at a 2 phase interval (period T2).

At the time of phase continuous driving continuously implementing the phase driving Phase 0 included in the vector driving Vector 0 (first vector) as shown in FIG. 11(b), as shown in FIG. 14(b), the linear sum signal according to the phase driving Phase 0 is acquired at a one phase interval (period T3).

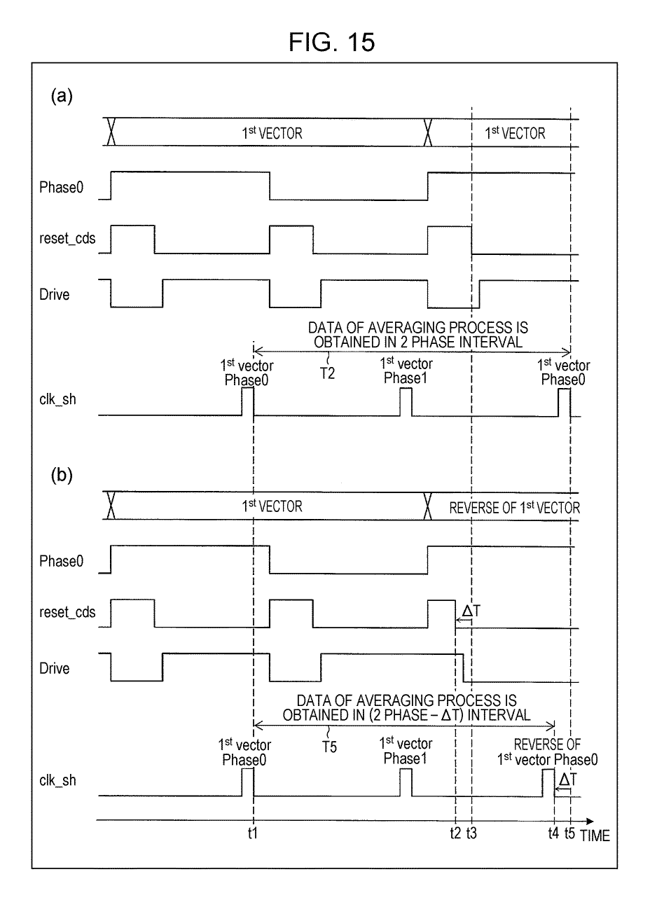

FIG. 15(a) is a waveform diagram of a driving signal and the like when continuously implementing the driving using the first vector according to the touch panel system 1a and FIG. 15(b) is a waveform diagram of a driving signal and the like in a case where the driving using the first vector is reversed at even-numbered times.

As shown in FIG. 15(a), the driving signal Drive falls when the reset signal reset_cds rises and the driving signal Drive rises after the reset signal reset_cds falls at a time t3.

As shown in FIG. 15(b), the reversal of the driving is performed by the driving signal Drive falling from high to low. For this reason, when the reset signal rises, it is not necessary to lower the driving signal Drive as shown in FIG. 15(a). For this reason, it is possible to set the falling of the reset signal before the reverse driving at a time t2 which is ΔT earlier than the reset signal falling time t3 in FIG. 15(a), and it is possible to shorten the reset time in which the reset signal reset_cds is on by ΔT. For this reason, the linear sum signal according to the vector driving Vector 0 was acquired at a 2 phase interval (a period T2 from time t1 to time t5) in FIG. 15(a); however, it is possible to acquire the linear sum signal at an interval (a period T5 from time t1 to time t4) of (2 phases−ΔT) in FIG. 15(b).

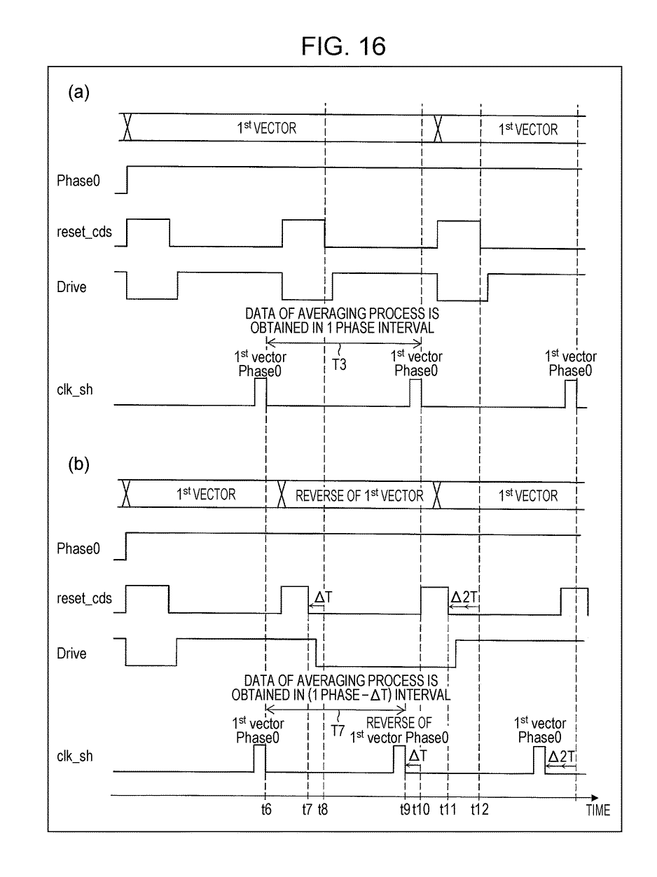

FIG. 16(a) is a waveform diagram of a driving signal and the like when continuously implementing the driving using phase 0 of the first vector and FIG. 16(b) is a waveform diagram of a driving signal and the like in a case where the driving using phase 0 of the first vector is reversed in the even-numbered times.

Referring to FIG. 16(b), it is possible to set the falling of the reset signal before reverse driving to time t7 which is ΔT earlier than the reset signal falling time t8 in FIG. 16(a), and it is possible to shorten the reset time in which the reset signal reset_cds is on by ΔT. Then, it is possible to set the falling of the next reset signal to a time t11 which is Δ2T earlier in total than the reset signal falling time t12 in FIG. 16(a).

For this reason, the linear sum signal using phase driving Phase 0 of vector driving Vector 0 is acquired at a 1 phase interval (a period T3 from time t6 up to time t10) in the example in FIG. 16(a); however, it is possible to acquire the linear sum signal at an interval (a period T7 from time t6 up to time t9) of (1 phase−ΔT) in FIG. 16(b).

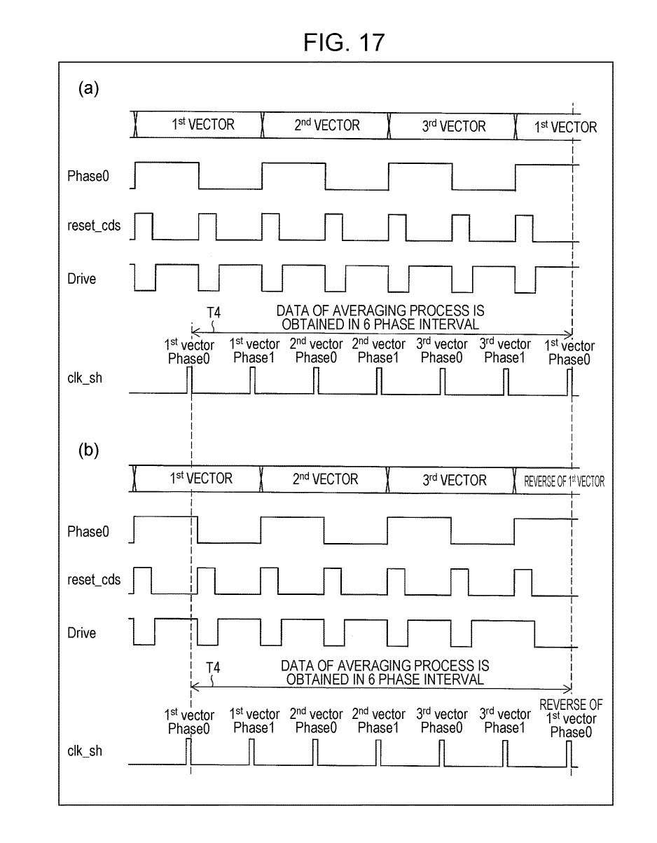

FIG. 17(a) is a waveform diagram of a driving signal and the like when continuously implementing the driving using the first vector to the third vector according to the touch panel system 1a, and FIG. 17(b) is a waveform diagram of a driving signal and the like in a case where the driving using the first vector is reversed at even-numbered times.

In the plural vector continuous driving shown in FIG. 11(d), in a case where L=2, vector 0 (first vector) to vector 2 (third vector) are continuously implemented and, as shown in FIG. 17(a), the linear sum signal according to vector driving Vector 0 is acquired at a 6 phase interval (period T4).

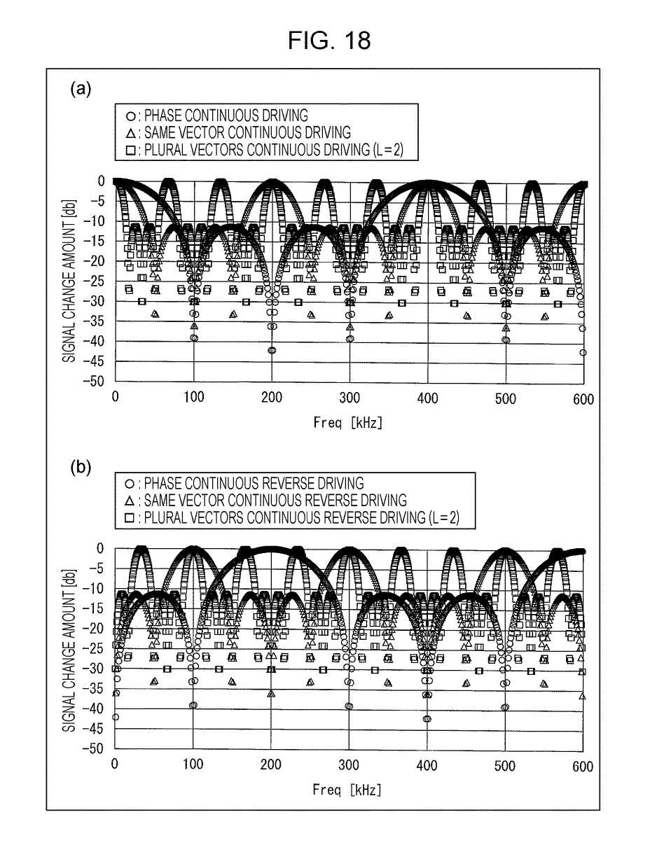

FIGS. 18(a) and 18(b) are graphs which show the frequency characteristics of 4-fold sampling according to the touch panel system 1a. The horizontal axis represents the frequency and the vertical axis represents the signal change amount. In each of the graphs, the time of one phase is 2.5 microseconds (μs).

In a case where reverse driving is not performed, FIG. 18(a) shows the frequency characteristics when continuously implementing the phase driving (the phase continuous reverse driving in FIG. 11(b)), the frequency characteristics when continuously implementing the vector driving (the same vector continuous driving in FIG. 11(c)), and the frequency characteristics when continuously implementing the driving of three vector units (the plural vector continuous driving in FIG. 11 (d) (L=2)).

In a case where reverse driving is performed and the reset signal shortening time ΔT=0.0 μs, FIG. 18(b) shows the frequency characteristics when continuously implementing the phase driving (the phase continuous reverse driving in FIG. 12(a)), the frequency characteristics when continuously implementing the vector driving (the same vector continuous reverse driving in FIG. 12(b)), and the frequency characteristics when continuously implementing the driving of three vector units (the plural vector continuous reverse driving in FIG. 12(c) (L=2)).

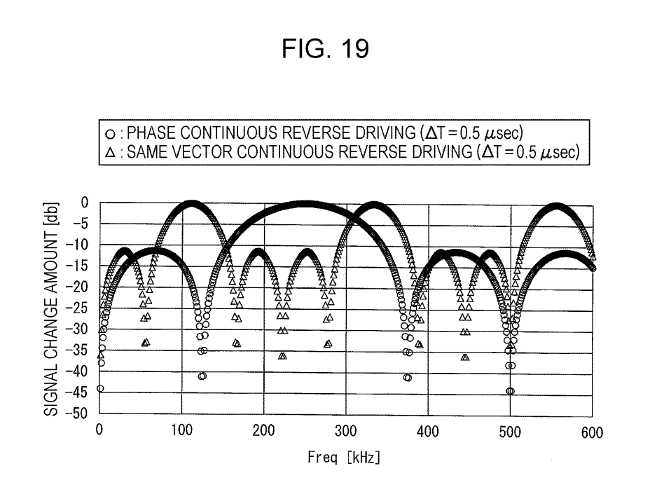

In a case where reverse driving is performed and the reset signal shortening time ΔT=0.5 μs, FIG. 19 shows the frequency characteristics when continuously implementing the phase driving (the phase continuous reverse driving in FIG. 12(a)), and the frequency characteristics when continuously implementing the vector driving (the same vector continuous reverse driving in FIG. 12(b)).

The graphs shown in FIG. 18 and FIG. 19 show that the frequency band where the signal change amount is approximately 0 dB is weak against noise and that the smaller the signal change amount “dB” (a negative value having a large absolute value) in the frequency band, the stronger the signal change amount is against noise. In the examples shown in FIG. 18 and FIG. 19, since there is no frequency band at 0 dB under any conditions, if there is one noise frequency, it is possible to expect suppression of the influence of noise by changing the sampling operation. Here, under the sampling conditions, in a case where there is no dummy driving period or blank period in the plural vector continuous driving, the operation speed (report rate) does not fall.

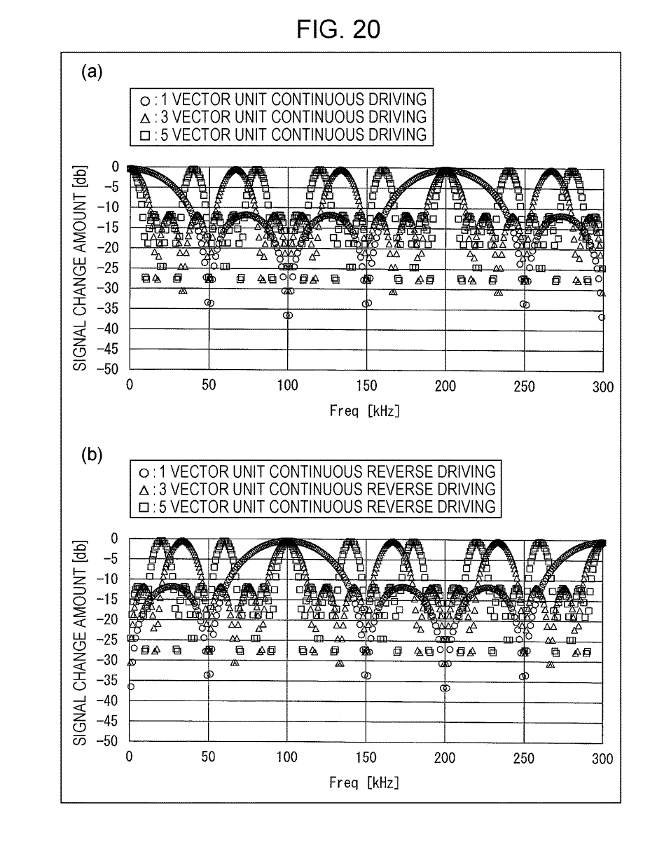

FIG. 20 is a graph which shows other 4-fold sampling frequency characteristics according to the touch panel system 1a. In each of the graphs, the time of one phase is 2.5 μs.

In a case where reverse driving is not performed, FIG. 20(a) shows the frequency characteristics when continuously implementing the driving in one vector unit (the same vector continuous driving in FIG. 11(c)), the frequency characteristics when continuously implementing the driving in three vector units (the plural vector continuous driving (L=2) in FIG. 11(d)), and the frequency characteristics when continuously implementing the driving in five vector units (the plural vector continuous driving (L=4) in FIG. 11(d)).

In a case where reverse driving is performed, FIG. 20(b) shows the frequency characteristics when continuously implementing the driving in one vector unit (the same vector continuous driving in FIG. 12(b)), the frequency characteristics when continuously implementing the driving in three vector units (the plural vector continuous driving (L=2) in FIG. 12(c)), and the frequency characteristics when continuously implementing the driving in five vector units (the plural vector continuous driving (L=4) in FIG. 12(c)).

In the example shown in FIG. 20, when the number of continuous vector units is increased, the interval between the frequency band where the damping characteristics are poor and the frequency band where the damping characteristics are good changes to be narrowed. By appropriately changing the number of continuous vector units, it is possible to expect the same for the noise frequency band which is desired to be cancelled and the frequency band where the signal change amount “dB” is small (a negative value having a large absolute value). Here, under these sampling conditions, in a case where there is no dummy driving period or blank period in the driving of the plurality of vector units, the operation speed (report rate) does not fall.

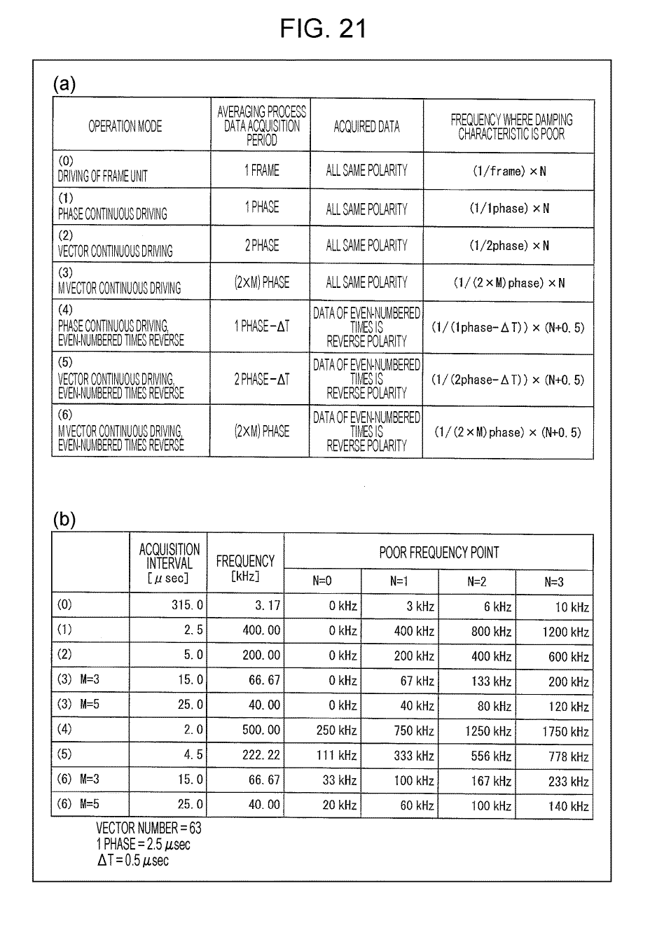

FIGS. 21(a) and 21(b) are diagrams for comparing driving methods of the touch panel system 1a.

In the operation mode of the frame unit driving illustrated in FIG. 11(a) (driving in the (0) frame unit), the acquisition time interval of the linear sum signal data for the averaging process is one frame, and the polarity of the linear sum time-sequence signal to be acquired is the same in all cases. The frequency where the damping characteristic is poor is (1/Frame)×N.

In the operation mode of the phase continuous driving illustrated in FIG. 11(b) ((1) phase continuous driving), the acquisition time interval of the linear sum signal data for the averaging process is one phase, and the polarity of the linear sum time-sequence signal to be acquired is the same in all cases. The frequency where the damping characteristic is poor is (1/phase)×N.

In the operation mode of the same vector continuous driving illustrated in FIG. 11(c) ((2) vector continuous driving), the acquisition time interval of the linear sum signal data for the averaging process is two phases, and the polarity of the linear sum time-sequence signal to be acquired is the same in all cases. The frequency where the damping characteristic is poor is (½ phase)×N.

In the operation mode of the plural vector continuous driving illustrated in FIG. 11(d) ((3) M vector continuous driving), the acquisition time interval of the linear sum signal data for the averaging process is 2 phase×M, and the polarity of the linear sum time-sequence signal to be acquired is the same in all cases. The frequency where the damping characteristic is poor is (1/(2×M)phase)×N.

In the operation mode of the phase continuous reverse driving which reverses the driving of even-numbered times after continuing the phase driving illustrated in FIG. 12(a) and FIG. 16(b) ((4) phase continuous driving, even-numbered reversing), the acquisition time interval of the linear sum signal data for the averaging process is (1 phase−ΔT) and the polarity of the linear sum time-sequence signal to be acquired is reversed at even-numbered times. The frequency where the damping characteristic is poor is (1/(1 phase−ΔT))×(N+0.5).

In the operation mode of the same vector continuous reverse driving which reverses the driving of even-numbered times by continuing the vector driving illustrated in FIG. 12(b) and FIG. 15(b) ((5) vector continuous driving, even-numbered reversing), the acquisition time interval of the linear sum signal data for the averaging process is (2 phase−ΔT) and the polarity of the linear sum time-sequence signal to be acquired is reversed at even-numbered times. The frequency where the damping characteristic is poor is (1/(2 phase−ΔT))×(N+0.5).

In the operation mode of the plural vector continuous reverse driving which reverses the driving of even-numbered times by continuing the vector driving illustrated in FIG. 12(c) and FIG. 17(b) ((6) M vector continuous driving, even-numbered reversing), the acquisition time interval of the linear sum signal data for the averaging process is (2×M) phases and the polarity of the linear sum time-sequence signal to be acquired is reversed at even-numbered times. The frequency where the damping characteristic is poor is (1/(2×M)phase)×(N+0.5).

(Operation of Noise Amount Estimation Circuit 9)

The noise amount estimation circuit 9 carries out determination using the output of a plurality of linear element estimation units (the value of the linear element CX by performing signal processing based on addition and subtraction, or a plurality of estimated results of the input of the linear element CX). The switching circuit 6 switches the sub-systems 5a and 5b based on the estimation results of the noise amount estimation circuit 9. Essentially, the plurality of estimates should be the same value, and when not the same value, the noise amount estimation circuit 9 estimates that the influence of noise mixed into the estimation results is increased.

(Sub-System Configuration)

A plurality of sub-systems which are provided in the control circuit 14 can be configured as various types based on the description above in order to reduce the influence of external noise.

For example, a sub-system in which the embodiment unit which adds and averages a plurality of linear sum signals based on the same phase driving in the same vector driving is set as a frame unit, a sub-system in which the embodiment unit which adds and averages is set as a phase unit, a sub-system in which the embodiment unit which adds and averages is set as a vector unit, and a sub-system in which the embodiment unit which adds and averages is set as a plurality of vector units are provided, and these sub-systems may be configured to be selected in order to reduce the influence of external noise based on the frequency characteristics between the normalization frequency and the signal change amount.

In a case where the addition-averaging embodiment unit is a phase unit, a vector unit, or a plurality of vector units, a sub-system provided with a function of reversing the code of the driving signal may be provided. In such a case, a sub-system in which the driving reverse period is set as N phase units (N is an integer) is provided, and these sub-systems may be configured to be selected in order to reduce the influence of external noise based on the frequency characteristics.

In addition, in a case where there is a driving reversal function for the driving signal, a sub-system which shortens the reset time of the reset signal which resets the amplifier circuit may be provided.

### Reference Embodiment 2

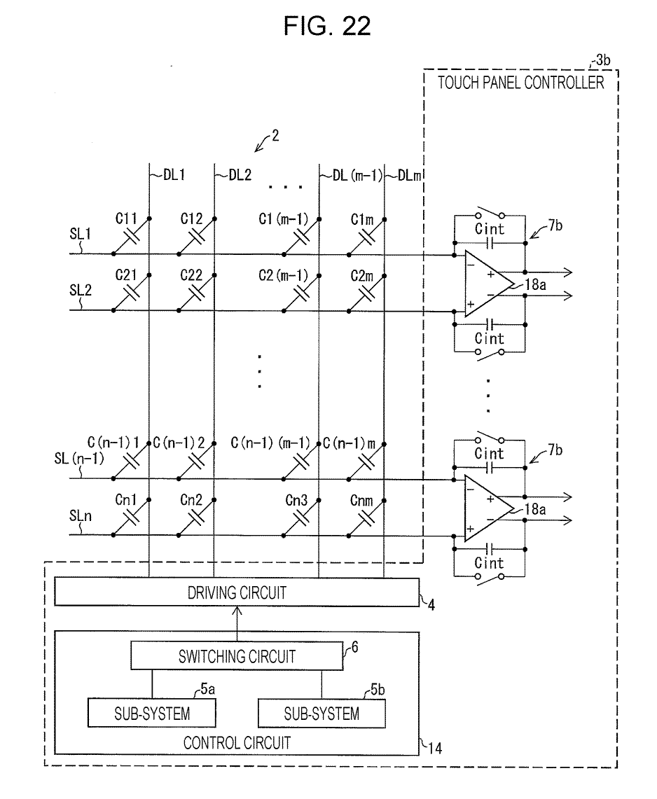

For other reference embodiments in the present invention, description will be given as follows based on FIG. 22. Here, for convenience of explanation, the same reference numerals are given to the members having the same functions as in the diagrams described for the reference embodiment and description thereof will be omitted.

FIG. 22 is a circuit diagram which shows a configuration of a touch panel system according to reference embodiment 2. The touch panel system according to reference embodiment 2 is provided with a touch panel controller 3b. The touch panel controller 3b is provided with an amplifier circuit 7b. The amplifier circuit 7b has a differential amplifier 18a. The differential amplifier 18a receives and amplifies linear sum signals read along the sense lines adjacent to each other.

In this manner, when the amplifier circuit is configured by a differential amplifier, it is possible to further strengthen the noise tolerance of the touch panel controller.

### Reference Embodiment 3

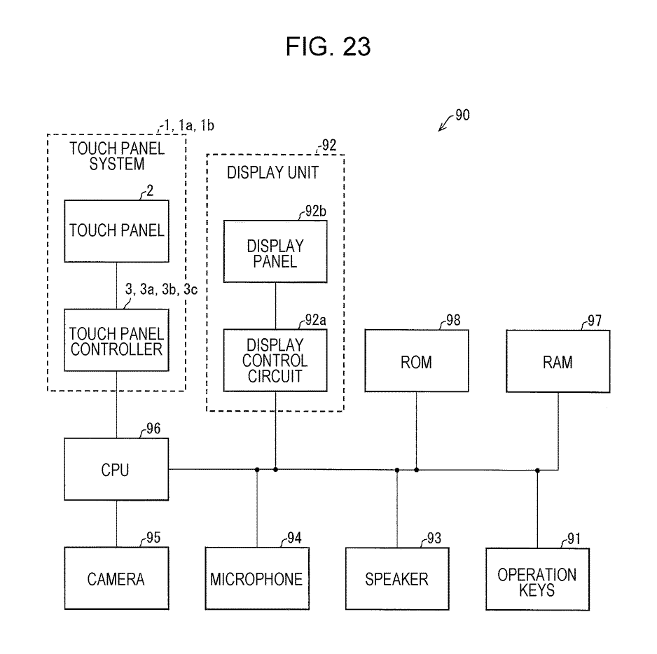

FIG. 23 is a block diagram which shows a configuration of a mobile phone 90 (electronic equipment) according to reference embodiment 3. The mobile phone 90 is provided with a CPU 96, a RAM 97, a ROM 98, a camera 95, a microphone 94, a speaker 93, operation keys 91, a display unit 92 including a display panel 92b and a display control circuit 92a, and the touch panel system 1 (may be the touch panel system 1a or a touch panel system 1b to be described below). Each constituent element is connected to each other by a data bus.

The CPU 96 controls the operation of the mobile phone 90. The CPU 96, for example, executes a program which is stored in the ROM 98. The operation keys 91 receive the input of instructions from a user of the mobile phone 90. The RAM 97 stores data generated by execution of the program by the CPU 96 or data input via the operation keys 91 in a volatile manner. The ROM 98 stores data in a non-volatile manner.

In addition, the ROM 98 is a ROM capable of writing and erasing such as an Erasable Programmable Read-Only Memory (EPROM) or a flash memory. Here, although not shown in FIG. 23, the mobile phone 90 may be formed to be provided with an interface (IF) for connecting through a wire to other electronic equipment.

The camera 95 images a subject according to user operation of the operation keys 91. Here, the image data of the imaged subject is stored in the RAM 97 or an external memory (for example, a memory card). The microphone 94 receives the input of the user's voice. The mobile phone 90 digitizes the input audio (analog data). Then, the mobile phone 90 sends digitized audio to a communication partner (for example, another mobile phone). The speaker 93, for example, outputs sound based on music data or the like stored in the RAM 97.

The touch panel system 1 has the touch panel 2 and the touch panel controller 3 (may be the touch panel controller 3a, or the touch panel controller 3b to be described below). The CPU 96 controls the operation of the touch panel system 1.

The display panel 92b displays an image stored in the ROM 98 and RAM 97 using the display control circuit 92a. The display panel 92b is overlapped on the touch panel 2, or the touch panel 2 is installed therein.

<<Configuration for Switching Connection State Between Drive Lines and Sense Lines>>

### Reference Embodiment 4

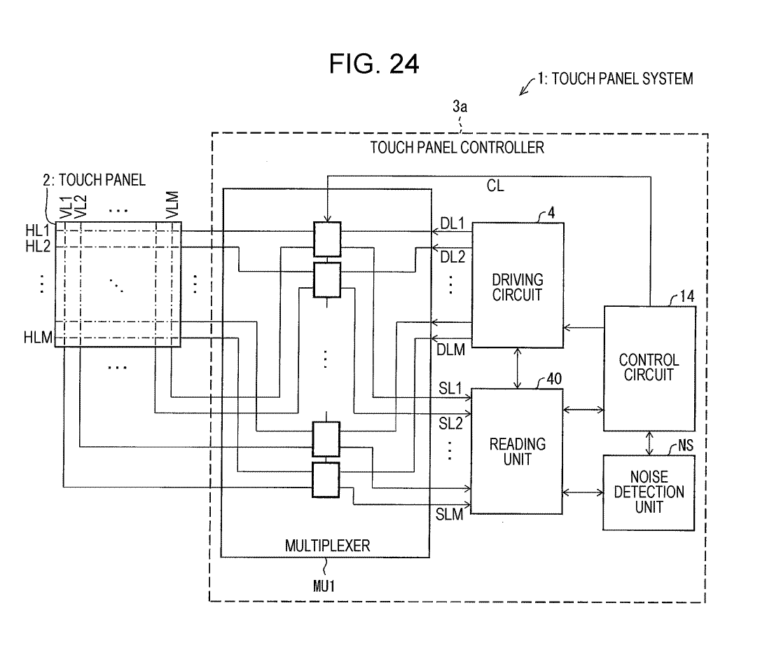

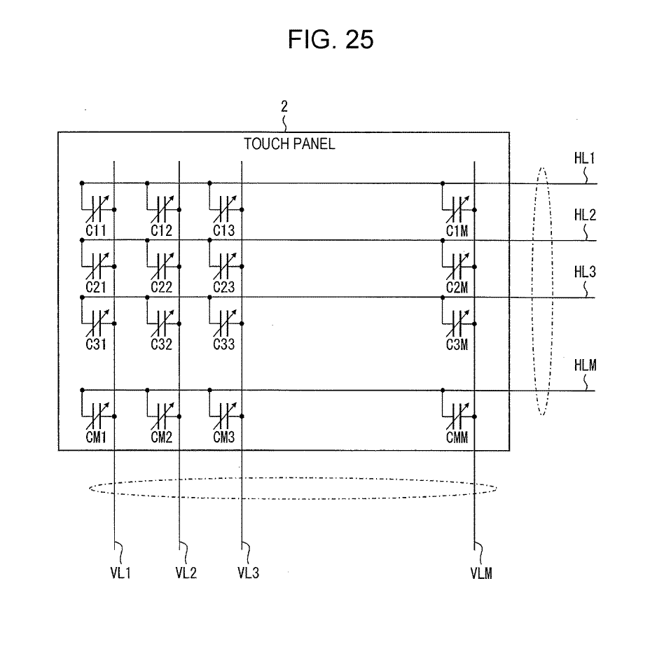

FIG. 24 is a block diagram which shows a configuration of the touch panel system 1 (touch panel apparatus) according to the present reference embodiment. FIG. 25 is a schematic diagram which shows a configuration of the touch panel 2 provided in the touch panel system 1.

The touch panel system 1 is provided with the touch panel 2 and the touch panel controller 3a (electrostatic capacitance value distribution detection apparatus). The touch panel 2 is provided with horizontal signal lines HL1 to HLM (second signal lines) extending in the horizontal direction (lateral direction) and arranged parallel to each other, and vertical signal lines VL1 to VLM (first signal lines) extending in the vertical direction (longitudinal direction) and arranged parallel to each other. Electrostatic capacitances C11 to CMM are formed respectively at intersections between the horizontal signal lines HL1 to HLM and the vertical signal lines VL1 to VLM.

The touch panel controller 3a is provided with a multiplexer MU1, the driving circuit 4, a reading unit 40, the control circuit 14 (external noise cancellation reduction unit), and a noise detection unit NS (external noise determination unit).

The driving circuit 4 supplies a driving signal in time series to drive lines DL1 to DLM. When the driving signal is applied, the touch panel 2 outputs a charge corresponding to the value of the electrostatic capacitance from the sense lines SL1 to SLM.

The reading unit 40 receives a sense signal corresponding to the driving signal and the electrostatic capacitance supplied to the touch panel 2 via the sense lines SL1 to SLM. The reading unit 40 receives a sense signal corresponding to the value of the electrostatic capacitance at each intersection between the horizontal signal lines HL1 to HLM and vertical signal lines VL1 to VLM. The distribution of the intensity of the received sense signals is a signal corresponding to the distribution of the electrostatic capacitance values on the touch panel 2. The reading unit 40 outputs the intensity distribution of the sense signal to the noise detection unit NS.

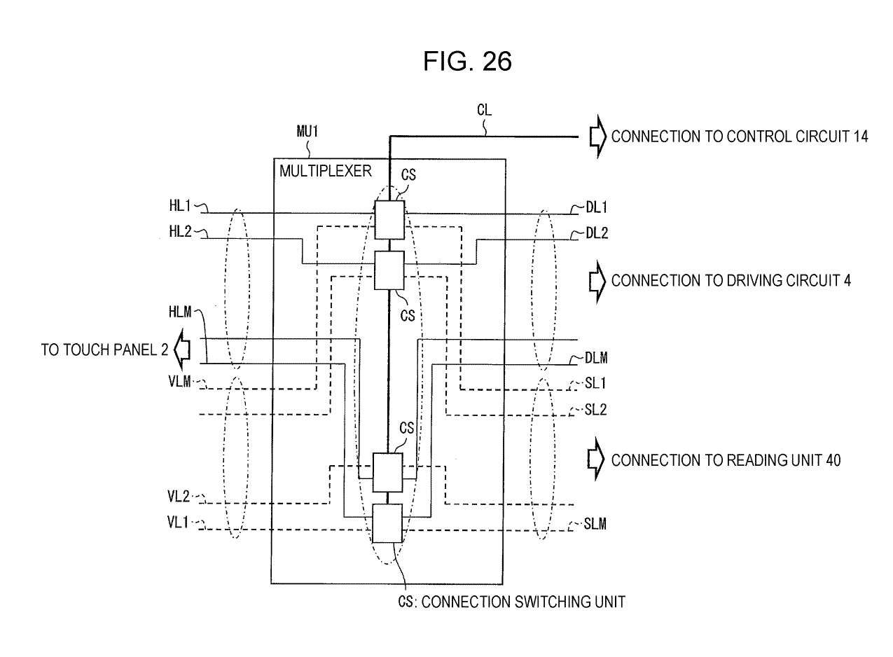

FIG. 26 is a circuit diagram which shows a schematic configuration of the multiplexer MU1. The multiplexer MU1 is provided with M connection switching units CS connected in a cascade. The control line CL from the control circuit 14 is input to the first connection switching unit CS. The multiplexer MU1 switches a first connection state (first operation mode) and a second connection state (second operation mode) according to a control signal input from the control circuit 14 via the control line CL. In the first connection state, the vertical signal lines VL1 to VLM are respectively connected to the drive lines DL1 to DLM of the driving circuit 4 and the horizontal signal lines HL1 to HLM are respectively connected to the sense lines SL1 to SLM of the reading unit 40. In the second connection state, the vertical signal lines VL1 to VLM are respectively connected to the sense lines SL1 to SLM of the reading unit 40 and the horizontal signal lines HL1 to HLM are respectively connected to the drive lines DL1 to DLM of the driving circuit 4.

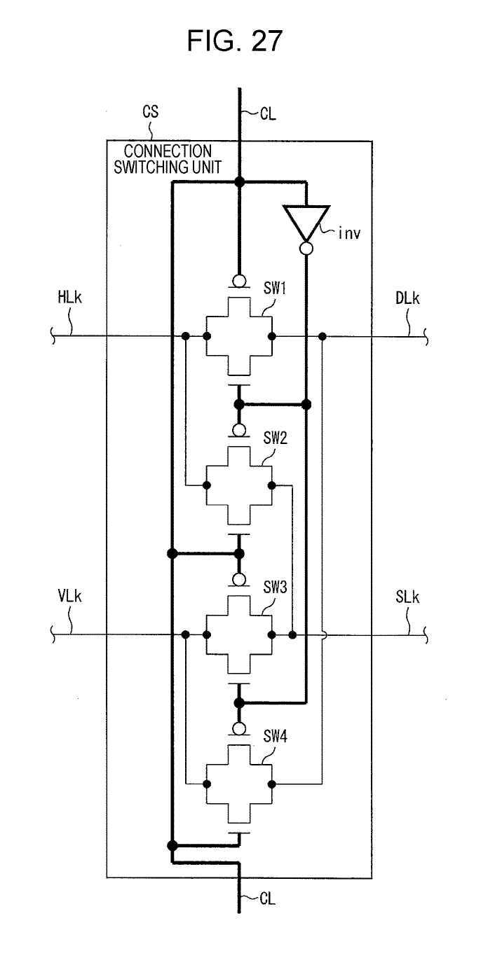

FIG. 27 is a circuit diagram which shows an example of a specific configuration of the connection switching unit CS. The connection switching unit CS has four CMOS switches SW1 to SW4. The control line CL of the connection switching unit CS is connected to the control line CL of the preceding connection switching unit CS and the control line CL of the following connection switching unit CS. That is, the control line CL from the control circuit 14 is shared by each of the connection switching units CS. Here, by providing the plurality of control lines CL, the connection of each of the connection switching units CS may be formed to be individually controllable. The control line CL is connected to the control terminal of a p-type transistor of a CMOS switch SW1, the control terminal of an n-type transistor of a CMOS switch SW2, a control terminal of a p-type transistor of a CMOS switch SW3, a control terminal of an n-type transistor of a CMOS switch SW4, and input of an inverter inv. The output of the inverter inv is connected to the control terminal of the n-type transistor of the CMOS switch SW1, the control terminal of the p-type transistor of the CMOS switch SW2, the control terminal of the n-type transistor of the CMOS switch SW3, and the control terminal of the p-type transistor of the CMOS switch SW4. The horizontal signal line HLk is connected to one end of the CMOS switches SW1 and SW2. The vertical signal line VLk is connected to one end of the CMOS switches SW3 and SW4. A drive line DLk is connected to the other end of the CMOS switches SW1 and SW4. A sense line SLk is connected to the other end of the CMOS switches SW2 and SW3. Here, for example, HLk indicates the k-th (1≦k≦M) horizontal signal line.

When the control signal of the control line CL is set to High, the horizontal signal lines HL1 to HLM are respectively linked to the sense lines SL1 to SLM and the vertical signal lines VL1 to VLM are respectively linked to the drive lines DL1 to DLM (first connection state). When the control signal of the control line CL is set to Low, the horizontal signal lines HL1 to HLM are respectively linked to the drive lines DL1 to DLM and the vertical signal lines VL1 to VLM are respectively linked to the sense lines SL1 to SLM (second connection state).

The control circuit 14 supplies a control signal for instructing the connection state to the multiplexer MU1. The control circuit 14 generates a signal defining the respective operations of the driving circuit 4 and the reading unit 40 and supplies the signal to the driving circuit 4 and the reading unit 40 respectively.

The noise detection unit NS determines the presence or absence of external noise from the intensity distribution of the sense signal. Detailed description will be given below of the processing of the noise detection unit NS. The noise detection unit NS is able to output the determination result of the presence or absence of external noise and the intensity distribution of the sense signal. In the present specification, electromagnetic noise received by a human body or the like being mixed into the touch panel system via a pointer is referred to as “external noise”.

<<Configuration for Using Touch Pen>>

### Reference Embodiment 5

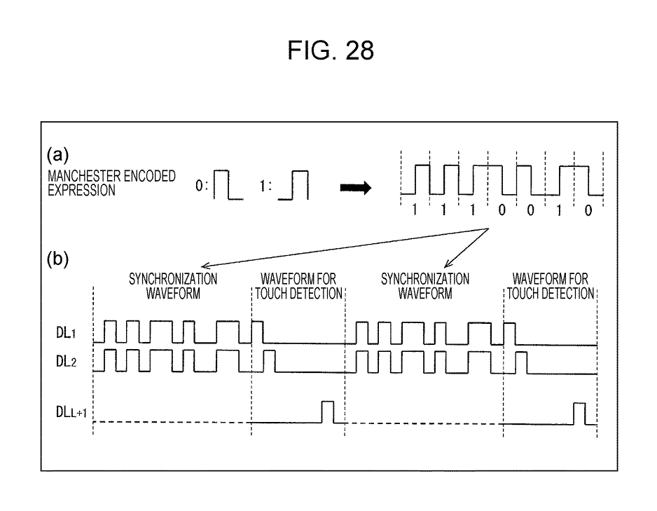

Description will be given below of a reference embodiment of the present invention based on FIG. 28 to FIG. 41.

(Configuration of Touch Panel System)

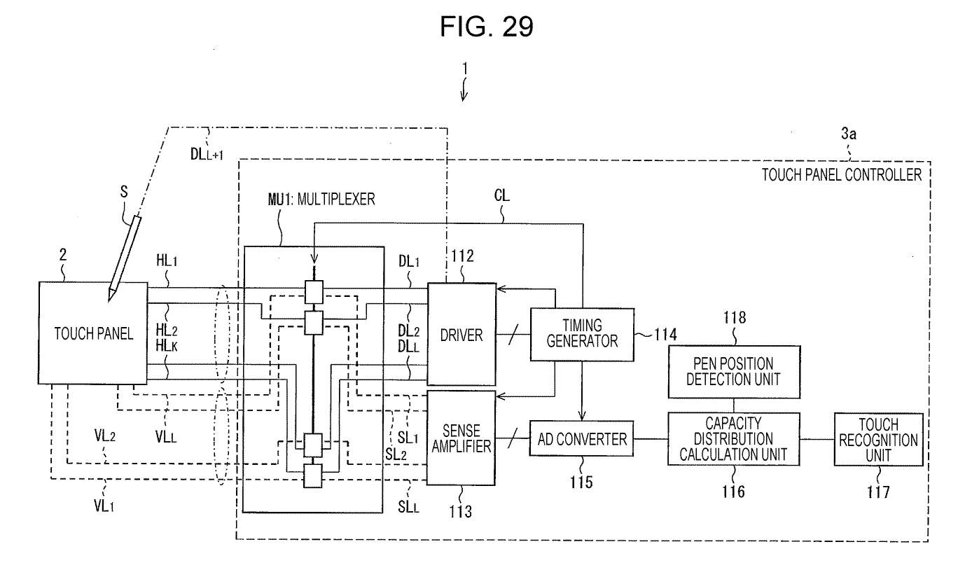

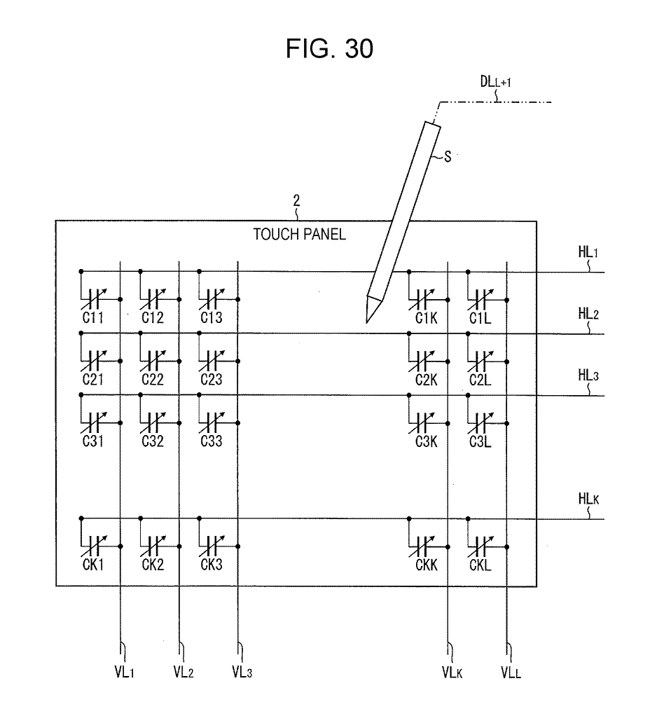

Description will be given of the configuration of the touch panel system 1 of the present reference embodiment based on FIG. 29 and FIG. 30. FIG. 29 is a block diagram which shows a configuration of the touch panel system 1 of the present reference embodiment and FIG. 30 is a wiring diagram which shows the configuration of a touch panel provided on the touch panel system.

As shown in FIG. 29, the touch panel system 1 of the present reference embodiment is provided with the touch panel 2, a stylus pen S as a touch pen and an electronic pen, and the touch panel controller 3a for driving the touch panel 2 and the stylus pen S.

As shown in FIG. 30, the touch panel 2 is provided with a plurality of horizontal signal lines HL₁ to HL_{K} as K (K is a positive integer) first signal lines arranged in parallel to each other along the horizontal direction, and a plurality of vertical signal lines VL₁ to VL_{L} as L (L is a positive integer) second signal lines arranged in parallel to each other along the vertical direction. Each intersection between the horizontal signal lines HL₁ to HL_{K} and the vertical signal lines VL₁ to VL_{L} generates electrostatic capacitances C11 to CKL. Here, K and L may be the same or may be different from each other; however, in the present reference embodiment, description will be given with L≧K. In addition, in the present reference embodiment, the horizontal signal lines HL₁ to HL_{K} and the vertical signal lines VL₁ to VL_{L} intersect each other orthogonally; however, the present invention is not necessarily limited thereto and it is sufficient if the lines intersect each other.

The touch panel 2 preferably has a width which is able to accommodate a hand holding the stylus pen S and may be a size used in smartphones.

In the present reference embodiment, the stylus pen S is not only a touch pen made of a conductive material for contacting the touch panel 2, but also forms a pen which is able to input and output signals. As will be described later, the stylus pen S is provided with a synchronization signal detection circuit 36, and receives and inputs a synchronization signal for synchronization with a dedicated synchronization signal generated in a timing generator 114 of the touch panel controller 3a.

As shown in FIG. 29, the touch panel controller 3a is provided with the multiplexer MU1, a driver 112, a sense amplifier 113, the timing generator 114, an AD converter 115, a capacitance distribution calculation unit 116, a touch recognition unit 117, and a pen position detection unit 118.

The driver 112 applies a voltage to drive lines DL₁ to DL_{K} or drive lines DL₁ to DL_{L} according to the driving of the horizontal signal lines HL₁ to HL_{K} or the vertical signal lines VL₁ to VL_{L} described above in the touch panel 2.

During the driving of the horizontal signal line HL₁ to HL_{K} in a first signal line driving period, the sense amplifier 113 reads an initial charge signal corresponding to each of the electrostatic capacitances C11 to CKL of the touch panel 2, and a linear sum signal corresponding to the first pen charge signal which is a touch-time charge corresponding to the electrostatic capacitance between the stylus pen S during touching and each of the L vertical signal lines VL₁ to VL_{L}, along the sense lines SL₁ to SL_{K} and supplies the result to the AD converter 115. That is, in the first signal line driving period, when an electrical charge corresponding to each of the electrostatic capacitances C11 to CKL is detected, since the electrostatic capacitance at the position changes as the stylus pen S approaches a certain position on the touch panel 2, it is possible to detect the changed electrostatic capacitance as the linear sum signal. Normally, when the stylus pen S approaches the touch panel 2, each of the electrostatic capacitances C11 to CKL of the approached positions increases.

In addition, during the driving of the vertical signal lines VL₁ to VL_{L} in the second signal line drive period, the sense amplifier 113 reads an initial charge signal corresponding to each of the electrostatic capacitances C11 to CKL of the touch panel 2, and a linear sum signal corresponding to the second pen charge signal which is a touch-time charge corresponding to the electrostatic capacitance between the stylus pen S in the touch period and each of the K horizontal signal lines HL₁ to HL_{K}, along the sense lines SL₁ to SL_{L} and supplies the result to the AD converter 115.

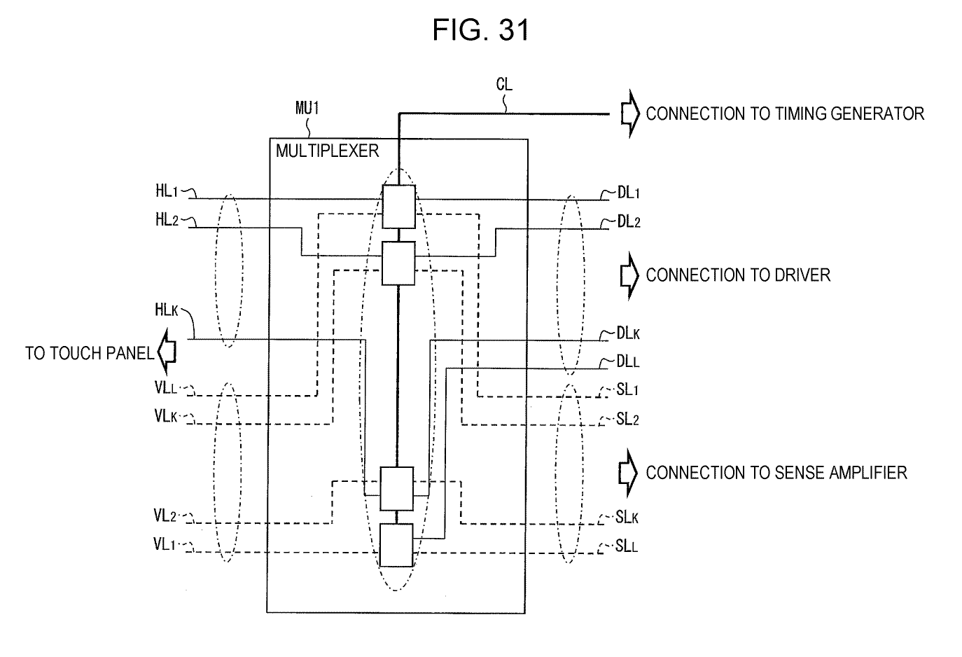

Next, description will be given of the multiplexer MU1 based on FIG. 31. FIG. 31 is a circuit diagram which shows a configuration of a multiplexer which switches a connection between horizontal signal lines HL₁ to HL_{K} or vertical signal lines VL₁ to VL_{K} to VL_{L} provided on the touch panel 2, and the drive lines DL₁ to DL_{K} to DL_{L} connected to the driver or the sense lines SL₁ to SL_{K} to SL_{L} connected to the sense amplifier 113.

The multiplexer MU1 is a connection switching circuit for switching the connection between a plurality of inputs and a plurality of outputs from one to the other. As shown in FIG. 31, in the present reference embodiment, switching is carried out between a first connection state in which the horizontal signal lines HL₁ to HL_{K} connect to the drive lines DL₁ to DL_{K} of the driver 112 and the vertical signal lines VL₁ to VL_{K} to VL_{L} connect to the sense lines SL₁ to SL_{K} to SL_{L} of the sense amplifier 113, and a second connection state in which the horizontal signal lines HL₁ to HL_{K} connect to the sense lines SL₁ to SL_{K} of the sense amplifier 113 and the vertical signal lines VL₁ to VL_{K} to VL_{L} connect to the drive lines DL₁ to DL_{K} to DL_{L} of the driver 112.

In the multiplexer MU1, when the signal of the control line CL shown in FIG. 31 is Low, the horizontal signal lines HL₁ to HL_{K} are connected to the drive lines DL₁ to DL_{K}, and the vertical signal lines VL₁ to VL_{L} are connected to the sense lines SL₁ to SL_{L}. On the other hand, when the signal of the control line CL is High, the horizontal signal lines HL₁ to HL_{K} are connected to the sense lines SL₁ to SL_{K}, and the vertical signal lines VL₁ to VL_{L} are connected to the drive lines DL₁ to DL_{L}.

Next, the timing generator 114 shown in FIG. 29 generates a signal defining the operation of the driver 112, a signal defining the operation of the sense amplifier 113, and a signal defining the operation of the AD converter 115, and supplies these signals to the driver 112, the sense amplifier 113, and the AD converter 115 respectively. In addition, the timing generator 114 generates a synchronization signal. Then, the touch panel controller 3a drives the horizontal signal lines HL₁ to HL_{K} or the vertical signal lines VL₁ to VL_{L}, using the synchronization signal generated by the timing generator 114 as a dedicated synchronization signal.

Next, in the first signal line driving period, the AD converter 115 AD converts a charge corresponding to each of the electrostatic capacitances C11 to CKL read along the vertical signal lines VL₁ to VL_{L} and the sense lines SL₁ to SL_{L}, and a linear sum signal corresponding to a first pen charge signal which is a charge corresponding to electrostatic capacitances between the stylus pen S and each of the L vertical signal lines VL₁ to VL_{L}, and supplies the result to the capacitance distribution calculation unit 116.

In addition, in the second signal line driving period, the AD converter 115 AD converts a charge corresponding to each of the electrostatic capacitances C11 to CKL read along the horizontal signal lines HL₁ to HL_{K} and the sense lines SL₁ to SL_{K}, and a linear sum signal corresponding to a second pen charge signal which is a charge corresponding to electrostatic capacitances between the stylus pen S and each of the K horizontal signal lines HL₁ to HL_{K}, and supplies the result to the capacitance distribution calculation unit 116.

Next, the capacitance distribution calculation unit 116 calculates the distribution of the electrostatic capacitance on the touch panel 2 based on a linear sum signal including the first pen charge signal and the second pen charge signal, and the code column based on the driving, the distribution of the electrostatic capacitance between the stylus pen S and each of the L vertical signal lines VL₁ to VL_{L}, and the distribution of the electrostatic capacitance between the stylus pen S and each of the K horizontal signal lines HL₁ to HL_{K}, to supply the electrostatic capacitance distribution on the touch panel 2 to the touch recognition unit 117, and supply the distribution of the electrostatic capacitance between the stylus pen S and each of the L vertical signal lines VL₁ to VL_{L} and the distribution of the electrostatic capacitance between the stylus pen S and each of the K horizontal signal lines HL₁ to HL_{K} to the pen position detection unit 118 which is a position detecting unit. The touch recognition unit 117 recognizes the touched position on the touch panel 2 based on the electrostatic capacitance distribution supplied from the capacitance distribution calculation unit 116.

The pen position detection unit 118 detects the position of the stylus pen S along the horizontal signal line HL₁ based on the distribution of the electrostatic capacitance between the stylus pen S and each of the L vertical signal lines VL₁ to VL_{L}. In addition, the pen position detection unit 118 detects the position of the stylus pen S along the vertical signal line VL₁ based on the distribution of the electrostatic capacitance between the stylus pen S and each of the K horizontal signal lines HL₁ to HL_{K}.

(Detection Operation of Touch Position of Touch Pen)

Description will be given below of the detection operation of the touch position of the stylus pen S in the touch panel system 1 with the above configuration as time passes. Here, description will be given of the detection operation in a case where the stylus pen S is used as simply as a touch pen.

First, in the first signal line driving period, in the first connection state in which the horizontal signal lines HL₁ to HL_{K} connect to the drive lines DL₁ to DL_{K} of the driver 112 and the vertical signal lines VL₁ to VL_{L} connect to the sense lines SL₁ to SL_{L} of the sense amplifier 113, the driver 112 drives the horizontal signal lines HL₁ to HL_{K} by applying a voltage to the drive lines DL₁ to DL_{K}.

Then, in the first signal line driving period, L first linear sum signals are output from each of the L vertical signal lines VL₁ to VL_{L} based on charges accumulated in each of the electrostatic capacitances C11 to CKL due to the driving of the horizontal signal lines HL₁ to HL_{K} and the first pen charge signal which is a charge corresponding to the electrostatic capacitance between the stylus pen S when the stylus pen S approaches the touch panel 2 and each of the L vertical signal lines VL₁ to VL_{L}.

The sense amplifier 113 reads L first linear sum signals including the first pen charge signal via the multiplexer MU1 and the sense lines SL₁ to SL_{L} and supplies the results to the AD converter 115. The AD converter 115 AD converts the L first linear sum signals including the first pen charge signal and outputs the result to the capacitance distribution calculation unit 116.

Next, switching is carried out from the first connection state to the second connection state to switch the driving signals and the sense signals of the horizontal signal lines HL₁ to HL_{K} and the vertical signal lines VL₁ to VL_{L}. That is, In the second connection state, the horizontal signal lines HL₁ to HL_{K} are connected to the sense lines SL₁ to SLK of the sense amplifier 113 and the vertical signal lines VL₁ to VL_{L} are connected to the drive lines DL₁ to DL_{L} of the driver 112.

After that, the driver 112 drives the vertical signal lines VL₁ to VL_{L} by applying a voltage to the drive lines DL₁ to DL_{L}.

Then, in the second signal line driving period, K second linear sum signals are output to each of K horizontal signal lines HL₁ to HL_{K}, based on charges accumulated in each of the electrostatic capacitances C11 to CKL by driving the vertical signal lines VL₁ to VL_{L} and a second pen charge signal which is a charge corresponding to the electrostatic capacitance between the stylus pen S and each of the K horizontal signal lines HL₁ to HL_{K}. At this time, the sense amplifier 113 reads the K second linear sum signals including the second pen charge signal via the multiplexer MU1 and the sense lines SL₁ to SL_{K} and supplies the signals to the AD converter 115. The AD converter 115 AD converts the K second linear sum signals including the second pen charge signal and outputs the result to the capacitance distribution calculation unit 116.

Next, in the position detection step, the capacitance distribution calculation unit 116 calculates the first linear sum signal including the first pen charge signal, the second linear sum signal including the second pen charge signal, and the distribution of the electrostatic capacitance on the touch panel 2, and supplies the results to the touch recognition unit 117, and calculates the position of the stylus pen S along the horizontal signal line HL₁ and the position of the stylus pen S along the vertical signal line VL₁ and supplies the result to the pen position detection unit 118.

After that, the touch recognition unit 117 recognizes the touched position on the touch panel 2 based on the electrostatic capacitance distribution supplied from the capacitance distribution calculation unit 116.

In addition, the pen position detection unit 118 detects the position of the stylus pen S on the touch panel 2 based on the position of the stylus pen S along the horizontal signal line HL₁ calculated by the capacitance distribution calculation unit 116 and the position of the stylus pen S along the vertical signal line VL₁.

Here, in the description above, in the present reference embodiment, the horizontal signal lines HL₁ to HL_{K} and the vertical signal lines VL₁ to VL_{L} are all driven in parallel at the same time. That is, parallel driving is carried out. However, the present invention is not necessarily limited thereto and the driving of the K horizontal signal lines HL₁ to HL_{K} and the driving of the L vertical signal lines VL₁ to VL_{L} in the touch panel 2 may be either parallel driving or sequential driving. Parallel driving is driving the K horizontal signal lines HL₁ to HL_{K} or driving the L vertical signal lines VL₁ to VL_{L} in parallel at the same time and sequential driving is driving the K horizontal signal lines HL₁ to HL_{K} or driving the L vertical signal lines VL₁ to VL_{L} sequentially in order from the horizontal signal line HL₁ or the vertical signal line VL₁. In terms of speed, parallel driving is preferable and parallel driving is adopted in the present reference embodiment.

In this manner, the touch panel system 1 of the present reference embodiment is provided with the touch panel 2 which has electrostatic capacitances formed at each intersection between the plurality of first signal lines and the plurality of second signal lines, the touch pen, and the touch panel controller 3a. When the touch panel controller 3a outputs the charge signal from the vertical signal lines VL₁ to VL_{L} which are each of the second signal lines based on each of the electrostatic capacitances by driving the horizontal signal lines HL₁ to HL_{K} which are a plurality of first signal lines in the first signal line driving period and repeatedly performs the switching driving which outputs the charge signal from the horizontal signal lines HL₁ to HL_{K} which are each of the first signal lines based on each of the electrostatic capacitances by driving the vertical signal lines VL₁ to VL_{L} which are the plurality of second signal lines in the second signal line driving period, the touch position is detected based on the changes in the electrostatic capacitances due to the touch pen touching the touch panel 2.

In the coordinate position detection method of the touch pen in the touch panel system 1 in this configuration, in a case where the touch pen touched the touch panel 2, the detection position in the first signal line driving period and the detection position in the second signal line driving period are represented at the same position. On the other hand, even when a false signal due to phantom noise generated by a human hand, finger, or the like receiving electromagnetic noise touching the touch panel 2 is represented in the first signal line driving period by switching the first signal line and the second signal line, the false signal is not represented at the same position in the second signal line driving period. Accordingly, by determining the detection position in the logical product of the detection position in the first signal line driving period and the detection position in the second signal line driving period, the touch signal of the touch pen and the false signal according to the phantom noise are distinguished and it is possible to cancel the false signal due to the phantom noise.

Here, phantom noise is noise where a detection signal is generated based on static electricity at a position different from the touch position of the touch pen via the hand which holds the touch pen and, since this signal is different from the correct touch position of the touch pen, the signal is noise.

(Stylus Pen Configuration and Pen Pressure Sensor Function)

The stylus pen S of the present reference embodiment has, for example, a pen pressure sensor for detecting the pen pressure and the pen pressure signal from the pen pressure sensor is set to be output while synchronizing with the touch panel controller 3a. However, the stylus pen S is not necessarily limited thereto and need not have a pen pressure sensor for detecting the pen pressure.

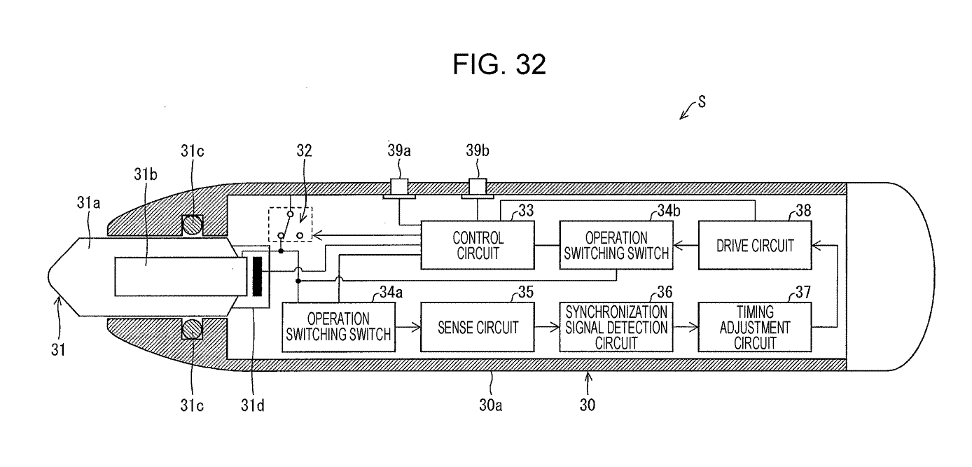

Description will be given of the configuration of the stylus pen S based on FIG. 32. FIG. 32 is a cross-sectional diagram which shows the configuration of the stylus pen S.

As shown in FIG. 32, the stylus pen S has a pen main body 30 which the user holds by hand and which has a conductive holding portion 30a formed to be substantially cylindrical in order for the user to hold by hand, and the leading end of the pen main body 30 is provided with a pen tip 31 which is pushed against the touch panel 2 at the time of the touch operation.

The pen tip 31 has a pen tip cover 31a, a pen tip shaft 31b, an insulator 31c which holds the pen tip cover 31a to be freely movable forward in the axial direction and a pen pressure sensor 31d provided at the back of the pen tip shaft 31b.

The pen tip cover 31a is formed of an insulating material and the pen tip shaft 31b is formed of a conductive material, for example, metal or a conductive synthetic resin material.

In addition, the pen pressure sensor 31d is, for example, formed of a semiconductor piezo resistive pressure sensor, and a semiconductor strain gauge is formed on the surface of a diaphragm (not shown). Accordingly, when the pen tip cover 31a of the pen tip 31 is pushed against the touch panel 2 at the time of the touching operation, the pen tip shaft 31b is pushed in via the pen tip cover 31a to press the surface of the diaphragm of the pen pressure sensor 31d and, due to this, the changes in the electrical resistance due to the piezo resistance effect generated by the diaphragm changing are converted into electrical signals. Due to this, it is possible to detect the pen pressure in the stylus pen S. Here, the principle of pressure detection is not necessarily limited thereto, and it is possible to employ other detection principles.

The interior of the pen main body 30 is provided with a connection switch 32, a control circuit 33, operation switching switches 34a and 34b, a sense circuit 35, the synchronization signal detection circuit 36, a timing adjustment circuit 37, and a driving circuit 38.

In addition, the stylus pen S is provided with, for example, a push type first operation switch 39a and second operation switch 39b and, due to the pushing operation of the first operation switch 39a and the second operation switch 39b, the functions assigned to the first operation switch 39a and the second operation switch 39b are executed via the control circuit 33. Examples of the functions assigned to the first operation switch 39a include an eraser function and it is possible to switch the eraser function on and off with the first operation switch 39a. In addition, examples of the functions assigned to the second operation switch 39b include a mouse right-click function and it is possible to turn the right-click functionality of the mouse on and off with the second operation switch 39b.

Here, the eraser function and the mouse right-click function are examples and the present invention is not limited to the eraser function and mouse right-click function. In addition, it is possible to add other functions by providing other operation switches.

Here, regarding the touch signal of the stylus pen S to the touch panel 2, in other words, the first pen charge signal and the second pen charge signal described above, due to the stylus pen S touching the touch panel 2 in a state where the connection switch 32 of the stylus pen S is off (a state where the pen tip shaft 31b is electrically disconnected from the holding portion 30a of the pen main body 30), as described above, the touch position is detected by switching and driving the horizontal signal lines HL₁ to HL_{K} and the vertical signal lines VL₁ to VL_{L}.

In the present reference embodiment, in order to detect the driving of the pen tip 31 in the stylus pen S in the touch panel controller 3a, in the driving of the stylus pen S by the driving circuit 38, a method is adopted in which, in the first signal line driving period, the driving pattern is matched with the driving pattern of the horizontal signal line HL_{K+1} (or higher) of the touch panel 2 according to the touch panel controller 3a, in other words, the driving pattern of the drive line DL_{K+1} (or higher) of the K+1^{th} (or higher) of the driver 112, and in the second signal line driving period, the driving pattern is matched with the driving pattern of the vertical signal line VL_{L+1} (or higher) of the touch panel 2 according to the touch panel controller 3a, in other words, the driving pattern of the drive line DL_{L+1} (or higher) of the L+1^{th} (or higher) of the driver 112. Here, the horizontal signal line HL_{K+1} (or higher) and the vertical signal line VL_{L+1} (or higher) itself is not present.

Here, in FIG. 29 and FIG. 30, the driving pattern may be different (K≠L) according to the driving period such as the drive line DL_{K+1} or the drive line DL_{L+1}; however, the driving pattern is displayed with a virtual line using the notation of the drive line DL_{L+1} for ease of notation. In addition, a drive line DL_{L+1} is also notated in the following description.

(Basic Operation of Synchronization of Touch Panel Controller and Stylus Pen)

Here, the stylus pen S of the present reference embodiment transmits and receives a signal to and from the touch panel controller 3a wirelessly. Accordingly, the pen tip 31 is driven with the same pattern as the drive line DL_{L+1} so as to match the timing of the driving of the drive lines DL₁ to DL_{L} in the touch panel controller 3a. Then, in the stylus pen S, the driving is performed in the same manner as the driver 112 of touch panel controller 3a by providing the driving circuit 38.

On the other hand, the driving of the drive lines DL₁ to DL_{L} in the touch panel controller 3a is based on the driving timing generated in the timing generator 114. For this reason, the stylus pen S needs to be operated in synchronization with the timing for driving the touch panel controller 3a. Then, in the stylus pen S of the present embodiment, by providing the sense circuit 35, the synchronization signal detection circuit 36, and the timing adjustment circuit 37, the timing of the dedicated synchronization signal of the touch panel controller 3a and the timing of the pen synchronization signal generated in the timing adjustment circuit 37 in the stylus pen S are set to be matched by detecting the dedicated synchronization signal for driving the touch panel controller 3a in the stylus pen S.

The connection switch 32 is provided inside of the pen main body 30. The connection switch 32 can be omitted. In a case where the connection switch 32 is omitted, the holding portion 30a of the pen main body 30 is, for example, connected to a reference potential (GND).

The connection switch 32 is an electronic switch formed of a field effect transistor (FET) or the like, and is controlled to be turned on and off by the control circuit 33. Here, in a case where the connection switch 32 is off, the pen tip shaft 31b is electrically disconnected from the holding portion 30a of the pen main body 30. At this time, since the capacity between the pen tip 31 and the touch panel 2 is small, even when the pen tip cover 31a approaches the touch panel 2, it is difficult for the stylus pen S to acquire the synchronization signal of the touch panel.

On the other hand, when the connection switch 32 is turned on, the pen tip shaft 31b is electrically connected to the holding portion 30a of the pen main body 30 and the human body is conductive with the pen tip shaft 31b via the holding portion 30a. Due to this, since the human body has a comparatively large electrostatic capacitance, when the stylus pen S approaches or contacts the touch panel 2, it is easy for the stylus pen S to acquire the synchronization signal with the touch panel.

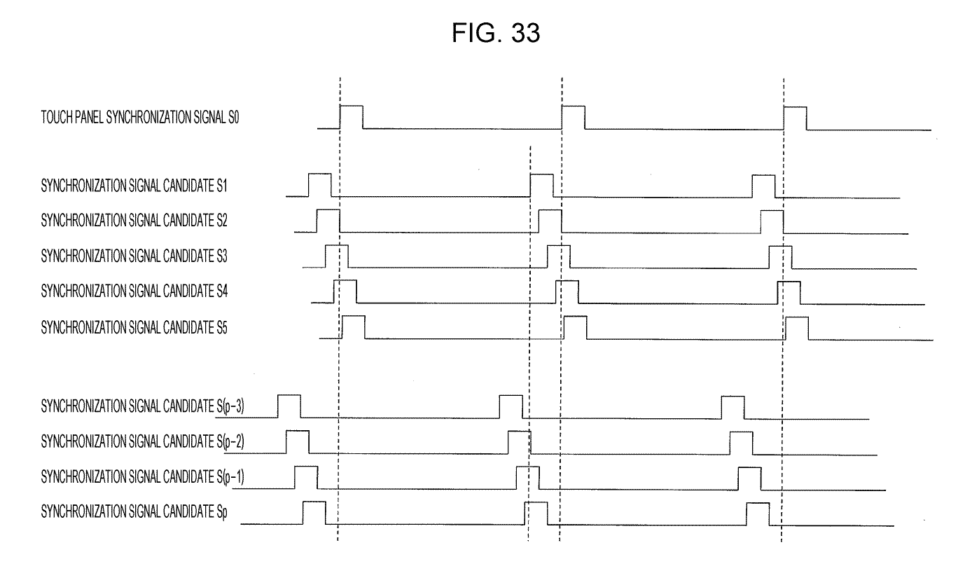

Here, description will be given of the basic principle of acquiring synchronization with the stylus pen S in the touch panel system 1 based on FIG. 33. FIG. 33 is a timing chart which shows the basic principle of acquiring synchronization.

The stylus pen S detects the dedicated synchronization signal generated in the timing generator 114 of the touch panel controller 3a in the sense circuit 35 and the synchronization signal detection circuit 36. Here, for the sake of simplicity, the dedicated synchronization signal is a single pulse.

As shown in FIG. 33, a touch panel synchronization signal S0 which is the dedicated synchronization signal formed of a single pulse is generated at a constant cycle.

In contrast, the stylus pen S generates a plurality of synchronization signal candidates S1 to Sp (p is an integer of 2 or more) in the sense circuit 35. Here, the synchronization signal candidate Sp shown in FIG. 33, the synchronization signal candidate S1 represents a signal delayed by approximately one cycle. The stylus pen S selects a synchronization signal with a high matching rate with the dedicated synchronization signal transmitted from the timing generator 114 of the touch panel controller 3a from among the synchronization signal candidates S1 to Sp and adopts the signal as the synchronization signal for communication with the touch panel controller 3a. In the example shown in FIG. 33, the synchronization signal candidate S4 or S5 with a high matching rate with the touch panel synchronization signal S0 is adopted as the pen synchronization signal of the stylus pen S.

The stylus pen S is in detection mode until the synchronization is acquired and the driving of the driving circuit 38 is not performed.

According to this principle, it is possible to synchronize the stylus pen S with the dedicated synchronization signal in the touch panel controller 3a.

(Characteristic Operation of Synchronization of Touch Panel Controller and Stylus Pen)

Here, in the actual synchronization, since noise is present in the reception of the dedicated synchronization signal from the touch panel controller 3a, the synchronization is not easy. Specifically, since the low-frequency component is superimposed on the dedicated synchronization signal, it is difficult to hold the amplitude of the pulse of the correct dedicated synchronization signal and, as a result, there is a problem in that lost pulses are generated in the dedicated synchronization signal.

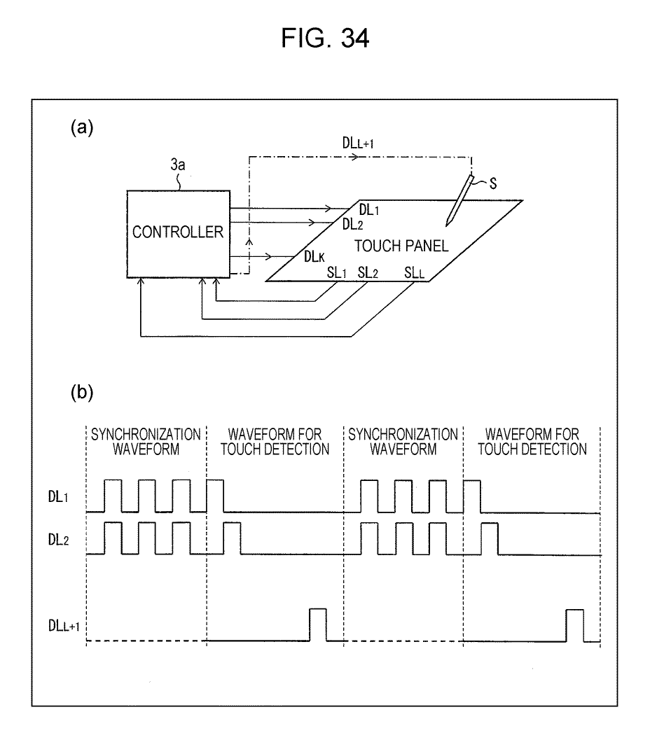

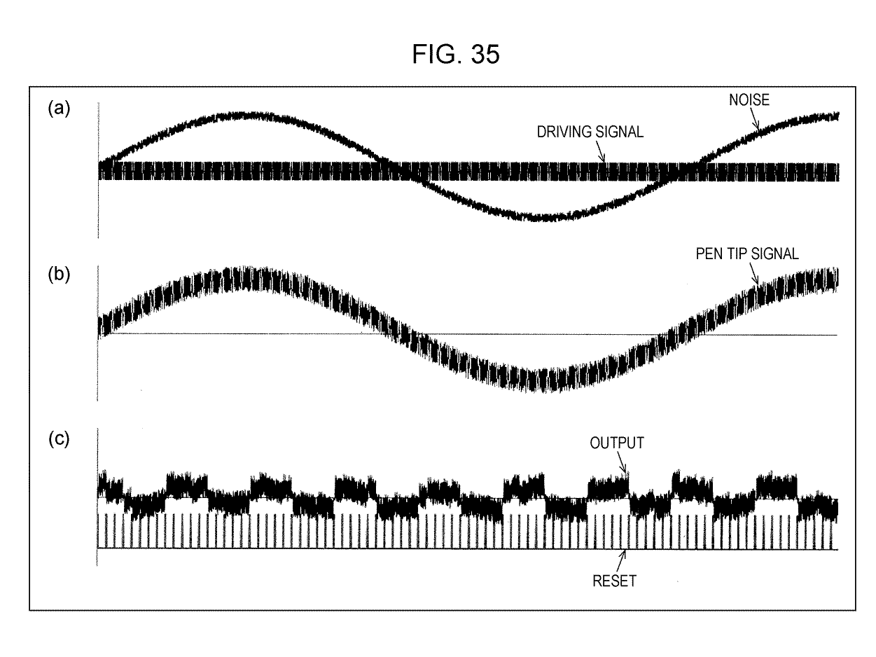

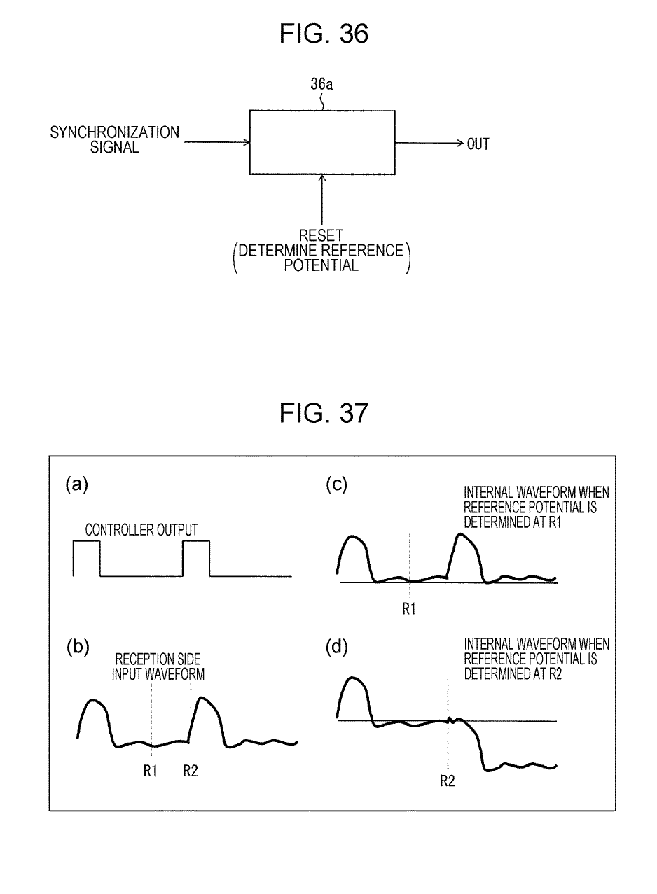

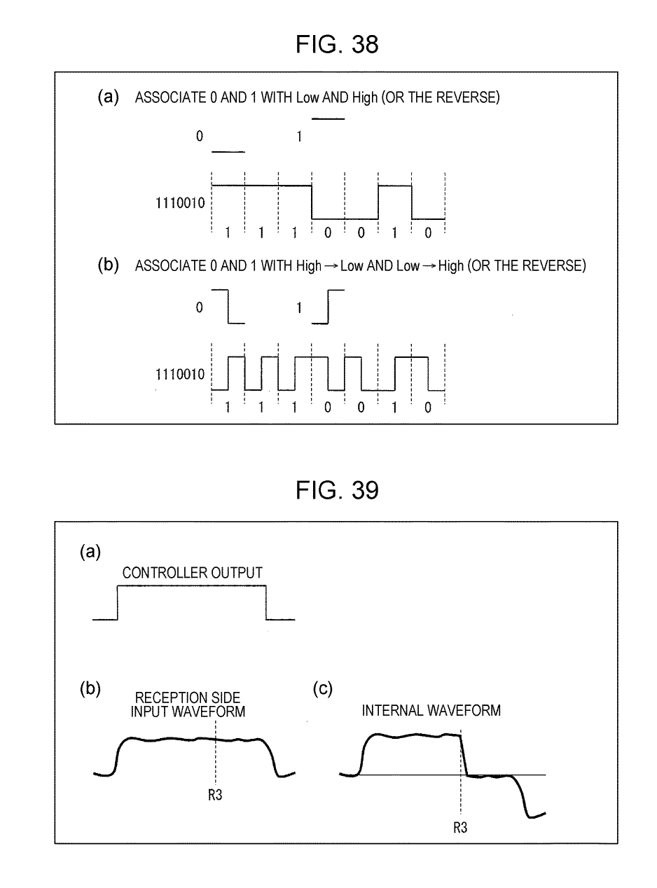

Description will be given of an example of a method of solving such problems based on FIGS. 28(a) and 28(b) and FIGS. 34(a) and 34(b) to FIGS. 39(a) to 39(c). FIG. 28(a) is a diagram which shows a synchronization waveform of a Manchester coded pseudo-random sequence having periodicity transmitted from the touch panel controller to the stylus pen in the touch panel system, and FIG. 28(b) is a waveform diagram which shows a synchronization waveform and a touch detection waveform. FIG. 34(a) is a diagram which shows an output relationship between the touch panel and the stylus pen in the touch panel controller and in the drive lines of the driver and the sense lines of the sense amplifier, and FIG. 34(b) is a waveform diagram which shows a synchronization waveform and a touch detection waveform. FIG. 35(a) is a waveform diagram which shows a driving waveform such as a synchronization waveform and a touch detection waveform transmitted from the touch panel controller to the stylus pen and low-frequency noise, FIG. 35(b) is a waveform diagram which shows a state where the driving waveform and low-frequency noise are superimposed, FIG. 35(c) is a waveform diagram which shows a state of being reset according to a reset timing. FIG. 36 is a diagram which shows a configuration of a reset circuit provided in the synchronization signal detection circuit in the stylus pen. FIG. 37(a) is a waveform diagram which shows an example of a synchronization waveform transmitted from the touch panel controller, FIG. 37(b) is a waveform diagram which shows an input waveform received by the stylus pen, FIG. 37(c) is a waveform diagram which shows an internal waveform when determining the reference potential at the reset timing R1 in FIG. 37(b), and FIG. 37(d) is a waveform diagram which shows an internal waveform when determining the reference potential at a reset timing R2 in FIG. 37(b). FIG. 38(a) is a waveform diagram which shows a synchronization waveform using the M-sequence code “1110010” in a case where Manchester encoding is not performed, FIG. 38(b) is a waveform diagram which shows the synchronization waveform using the M-sequence code “1110010” which is Manchester coded. FIG. 39(a) is a waveform diagram which shows an example of a long synchronization waveform of a High period transmitted from the touch panel controller, FIG. 39(b) is a waveform diagram which shows the reset timing R3 of the input waveform in the stylus pen, which is a reception, and FIG. 39(c) is a waveform diagram which shows an internal waveform when determining the reference potential at the reset timing R3 in FIG. 39(b).

As shown in FIG. 34(a), in the touch panel system 1 of the present reference embodiment, the dedicated synchronization signal of the touch panel controller 3a is created in the timing generator 114 of the touch panel controller 3a and transmitted using the drive lines DL_{L} to DL_{L} according to the driver 112. Then, as a mechanism for providing notification of the dedicated synchronization signal which is the driving timing of the touch panel controller 3a to the stylus pen S as shown in FIG. 34(b), the drive lines DL₁ to DL_{L} are set to be driven with a waveform which represents synchronization separately to a normal touch detection waveform. Specifically, in each of the drive lines DL₁ to DL_{L}, a touch detection waveform is generated after generating the synchronization waveform. Here, for ease of explanation, the waveform for detecting touch is generated in sequential driving. In addition, in the generation of the synchronization waveform, description is given with a plurality of continuous pulses to facilitate the distinction in appearance between the sequential driving waveforms, but in practice, the waveform proposed in the present reference embodiment in which an M-sequence code or the like is Manchester coded is easily detected as the synchronization waveform.

Here, various types of noise, in particular, low-frequency noise is mixed into the signal waveform which is received by the stylus pen S. In FIG. 35(a), the waveform shown by a thick straight line is a dedicated synchronization waveform formed of a plurality of closely spaced pulses driven by the touch panel controller 3a, and the part shown by a sin curve is assumed to be noise.

As shown in FIG. 35(b), the signal waveform received by the stylus pen S is a waveform in which the synchronization waveform from the touch panel controller 3a and the low-frequency noise are superimposed. As a result, in the signal waveform received by the stylus pen S, the amplitude of the low-frequency noise is greater than the amplitude of the synchronization waveform to be extracted from the touch panel controller 3a. For this reason, when handling from the minimum potential up to the maximum potential of the reception signal waveform, since the amplitude of the synchronization waveform signal is a signal with a relatively small amplitude signal in comparison with the noise, it is difficult to extract the synchronization waveform signal.

Then, as the method for finding the synchronization waveform from the waveform in which the synchronization waveform and the low-frequency noise shown in FIG. 35(b) are superimposed, there are, for example, a method for removing the low-frequency noise with a low-frequency cut-off filter, and a method in which a reset operation which determines the reference potential with respect to the waveform in which the synchronization waveform and the low-frequency noise are superimposed is performed and the amplitude of the internal waveform is determined according to the potential difference from the reference potential. However, a low-frequency cut-off filter is expensive.

For this reason, in the present reference embodiment, the stylus pen S which is the reception side of the synchronization waveform adopts the method in which a reset operation which determines the reference potential with respect to the received input waveform is performed and the amplitude of the internal waveform is determined according to the potential difference from the reference potential. However, the present invention is not necessarily limited thereto, and it is also possible to cancel the noise formed of the low-frequency component using a low-frequency cut-off filter.

In the present reference embodiment, in order to perform the reset operation to determine the reference potential with respect to the received input waveform, the synchronization signal detection circuit 36 of the stylus pen S is provided with a reset circuit 36a shown in FIG. 36. In this reset circuit 36a, a reset is performed with respect to the superimposed signal waveform in which the synchronization waveform from the touch panel controller 3a and the low-frequency noise shown in FIG. 35(b) are superimposed. As shown in FIG. 35(c), by performing this reset, the superimposed signal waveform is returned to the reference potential at the reset timing. That is, the reference potential is set to be the same potential as the input signal. Then, when the potential of the input superimposed signal waveform is higher than the reference potential, a positive potential is output, while when the potential of the input superimposed signal waveform is lower than the reference potential, a negative potential is output. Due to this, the low-frequency component is cancelled and it is possible to fit the amplitude of the signal in a certain range.

Here, when the synchronization waveform from the touch panel controller 3a is represented by a sequence of a plurality of pulses at regular intervals, in a case where a reset operation for determining the reference potential with respect to the received input waveform is performed and the reset timing for determining the reference potential of the stylus pen S on the reception side and the pulse of the synchronization waveform are overlapped, there is a problem in that a pulse is lost and it is difficult to determine the dedicated synchronization signal which is the driving timing of the touch panel controller 3a.

For example, in a case where the synchronization waveform shown in FIG. 37(a) is transmitted from the touch panel controller 3a, the input waveform in the stylus pen S which is the reception side is shown by the waveform in FIG. 37(b). At this time, in the waveform of FIG. 37(b), the internal waveform when determining the reference potential at the reset timing R1 is shown in FIG. 37(c). However, in the waveform of FIG. 37(b), when the reset timing R2 is set to the second pulse, the internal waveform when the reference potential is determined is as shown in FIG. 37(d). As a result, the second pulse is lost since the second pulse no longer rises positively. That is, it is difficult to distinguish the dedicated synchronization signal which is the driving timing of the touch panel controller 3a.

Here, in the present reference embodiment, as the synchronization waveform to be transmitted in the touch panel controller 3a, a constant pattern synchronization signal formed of a pseudo-random sequence having periodicity is used. Specifically, an M-sequence code or a gold sequence code is used.

Here, the pseudo-random sequence is a code sequence used in a pseudo-random signal which is an artificially created random signal. That is, although a true irregular signal which is present in nature is normally called a random signal, in contrast, an artificially created irregular signal is called a pseudo-random signal. Since the signal is made artificially, there is a need for certain rules; however, there are various mechanisms for setting the statistical properties of the created signal to be as close as possible to the properties of a true irregular signal. In a normal case, a mechanism is used in which the autocorrelation function of the created signal is as close as possible to the autocorrelation function of white noise δ (t). In a pseudo-random signal, a pseudo-random sequence (a series of numbers) is made to correspond to a physical amount such as a voltage. In pseudo-random sequences, there are finite length series and periodic series; however, in terms of ease of generation and ease of use, periodic sequences are widely used. Then, as representatives of periodic sequences, there are M-sequences and Gold sequences.

The autocorrelation of the M-sequence signal and Gold sequence code exhibits a very sharp peak and has a property in that the correlation value other than to itself is extremely low. The M-sequence and Gold sequence are formed of binary 0's and 1's and the binary sequence is a sequence having a continuous periodicity. Here, it is also possible to represent the sequences by replacing 0 with −1.

By using the M-sequence code or Gold sequence code as the synchronization waveform transmitted in the touch panel controller 3a, since a timing matching the M-sequence code may be determined as the correct synchronization timing, the reliability of the synchronization determination is increased even in a case where the reset timing is overlapped with one pulse.

For example, as shown in FIG. 38(a), in a case of using the M-sequence code “1110010”, by associating “0” with Low in the synchronization waveform and associating “1” with High in the synchronization waveform, it is possible to obtain the synchronization waveform shown in FIG. 38(a).

Here, as described above, the M-sequence code is used as the synchronization waveform transmitted in the touch panel controller 3a and, by determining the match with the same M-sequence code in the sense circuit 35 and the synchronization signal detection circuit 36 of the stylus pen S, the tolerance to lost pulses is increased. However, since a pattern where the number of consecutive Highs or Lows is increased is included when the sequence is lengthened, unnecessary potential changes are generated when there is a reset timing for determining the reference potential at this portion and it is difficult to determine the waveform.

For example, as shown in FIG. 39(a), in the synchronization waveform transmitted in the touch panel controller 3a, a pulse with a long period of High is present, and, in the received input waveform of the stylus pen S shown in FIG. 39(b), the internal waveform when determining the reference potential in the reset timing R3 is shown in FIG. 39(c) and detection is difficult.

Here, in the present reference embodiment, with respect to a code where the autocorrelation characteristics of the M-sequence or the like are good, driving is performed using a Manchester coded waveform as the synchronization waveform of the touch panel controller 3a. Here, as shown in FIG. 38(b), in the Manchester coded waveform, “0” is associated with High→Low of the synchronization waveform and “1” is associated with Low→High of the synchronization waveform. Here, the above may be reversed. Due to this, as shown in FIG. 38(b), in a case of using the M-sequence code “1110010”, it is possible to prevent cases of long periods of High or Low from being generated.

In this manner, in consideration of the reset operation, it is preferable to use a Manchester coded M-sequence code or a Gold sequence code.

As shown in FIG. 28(a), in the present reference embodiment, the pulse is adapted using, for example, a code where the 7-bit M-sequence code “1110010” described above is Manchester coded as shown in FIG. 28(a). Then, as shown in FIG. 28(b), the above is used as the synchronization waveform of the touch panel controller 3a.

Due to this, there is a state where periods of High or Low continuing for a long time do not appear in the synchronization waveform, and it is possible to use a synchronization pattern which is easy to detect using the autocorrelation characteristics. In addition, since High or Low only continues for a time expressing a maximum of 1 bit in the synchronization waveform, it is also possible to adjust the reset timing which determines the reference potential in the stylus pen S which is the reception side.

For example, in a case where a state where the potential is High continues for a time expressing 1 bit or more, the state is regarded as the influence of noise and the potential at that time is set to the following reference potential. In addition, in a case where the potential approaches the reference potential from the high state, the potential at that time is set to the following reference potential. Due to this, even in a case where the potential is greatly decreased due to the noise or the like, it is possible to follow the potential.

(Continuous Operation of Synchronization of Touch Panel System and Stylus Pen and Touch Position Detection)

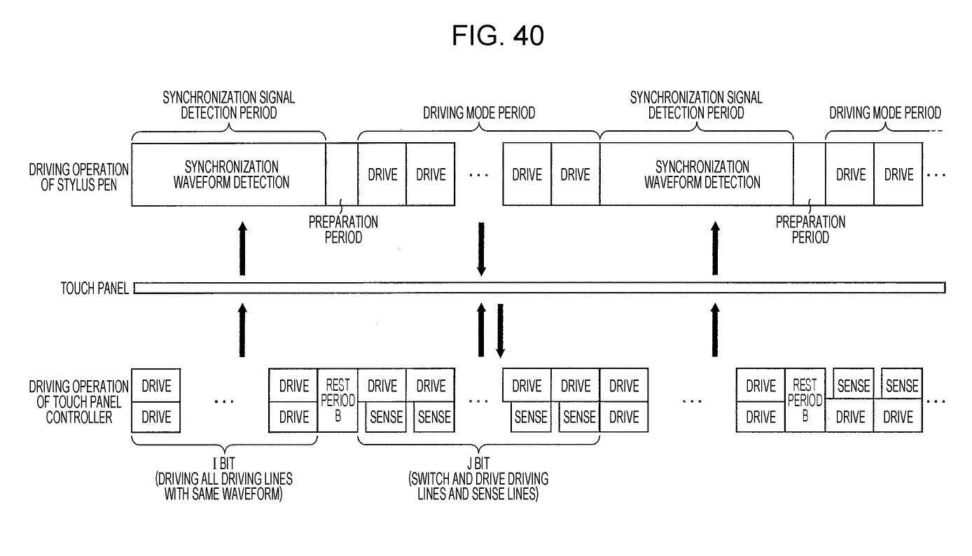

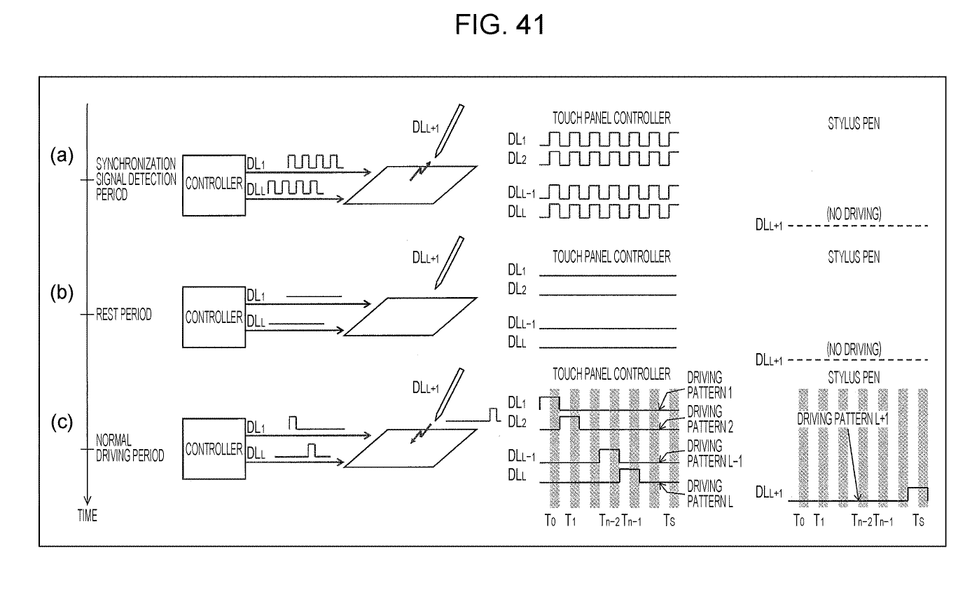

Description will be given of the continuous operation of the synchronization of the touch panel system 1 and the stylus pen S and the touch position detection of this configuration based on FIG. 40 and FIGS. 41(a) to 41(c). FIG. 40 is an operation image diagram which shows a correspondence relationship between the driving operation of the touch panel controller 3a and the driving operation of the stylus pen S. FIGS. 41(a) to 41(c) are diagrams which show specific driving operations of a synchronization signal detection period, a rest period, and a normal driving period shown in FIG. 40.

As shown in FIG. 40, the driving operation of the stylus pen S is configured to repeat three periods of a synchronization signal detection period for detecting a synchronization signal from the touch panel controller 3a, a preparation period, and a driving mode period for driving the pen tip 31 using the driving circuit 38 by turning the operation switching switch 34a off and the operation switching switch 34b on, by using the sense circuit 35 and the synchronization signal detection circuit 36 which turn the operation switching switch 34a on and the operation switching switch 34b off.

The synchronization signal detection period is a waiting period for detecting a bit pattern representing a synchronization waveform and is a period in which the driving of the pen tip 31 is stopped and the synchronization signal pattern is detected from a pen tip signal waveform. In particular, in the synchronization signal detection period, as shown in FIG. 41(a), the drive lines DL₁ to DL_{L} of the driver 112 are respectively driven with the same waveform. The pattern of the waveform uses a pattern which includes a pattern which has an autocorrelation characteristic such as, for example, an M-sequence.

The preparation period shown in FIG. 40 is a preparation period for selecting a code for driving based on the additional information and the state of the stylus pen S itself after detecting the synchronization signal pattern and starting to drive the pen tip in accordance with the timing of the touch panel controller 3a, and is a period in which the additional information for acquiring the timing of the start of the driving is interpreted.

In addition, the driving mode period is a period for driving the pen tip 31 using the driving circuit 38 and is a period for driving the pen tip 31 with a selected code while minutely adjusting the edge of the driving waveform so as to match the driving timing of the touch panel controller 3a. At this time, the driving circuit 38 of the stylus pen S is driven in accordance with the driving timing of the touch panel controller 3a.

On the other hand, the driving operation of the touch panel controller 3a is formed to repeat three periods of a period for driving the drive lines DL₁ to DL_{L} at the same waveform, a rest period B, and a period for switching and driving the drive lines DL₁ to DL_{K} to DL_{L} and the sense lines SL₁ to SL_{K} to SL_{L}.

The period for driving the drive lines DL₁ to DL_{L} with the same waveform is a driving period of the synchronization waveform and the additional information for obtaining synchronization with the stylus pen S. Specifically, as shown in FIG. 41(a), the drive lines DL₁ to DL_{L} are driven with the same waveform.

The rest period B is a period in which the stylus pen S finishes synchronization detection and is a period for driving preparation. Specifically, as shown in FIG. 41(b), the rest period B is a waiting time for providing a preparation period in which the stylus pen S detects the synchronization waveform to perform normal driving. For this reason, the rest period B is completely arbitrary without significance for the driving waveform. Accordingly, driving may not be carried out. Here, in a case where the preparation period on the stylus pen S side is unnecessary, this section is unnecessary.

Next, the period for switching and driving the drive lines DL₁ to DL_{K} to DL_{L} and the sense lines SL₁ to SL_{K} to SL_{L} is a normal driving period for position detection for obtaining the data of one surface of the touch panel 2. Specifically, in the normal driving period, as shown in FIG. 41(c), the driving and sensing of the drive lines DL₁ to DL_{L} are repeated with the necessary waveform in the touch position detection of the stylus pen S. As the driving method, sequential driving or parallel driving is performed. Here, in FIG. 41(c), sequential driving is represented so that the order of the driving pattern is easy to understand visually.

In a case where the synchronization waveform is detected, the stylus pen S drives the pen tip 31 with the same waveform as the drive line DL_{L+1} corresponding to the outside of the touch panel 2. Here, in FIG. 41(c), the colored part in the background indicates the sense period, in other words, the period for detecting the electrostatic capacitance for the touch position detection.

In this manner, the touch panel system 1 of the present reference embodiment is provided with the touch panel 2 having electrostatic capacitances formed respectively at intersections between horizontal signal lines HL₁ to HL_{K} as the plurality of first signal lines and the vertical signal lines VL₁ to VL_{L} as the plurality of second signal lines, a stylus pen S as a touch pen, and the touch panel controller 3a, in which the touch panel controller 3a detects the touch position based on changes in the electrostatic capacitance according to the stylus pen S by touching the touch panel 2 while driving the pen tip 31 of the stylus pen S with the waveform of the drive line DL_{L+1} when repeatedly performing switching and driving in which a charge signal is output from each of the vertical signal lines VL₁ to VL_{L} based on each electrostatic capacitance by driving the plurality of horizontal signal lines HL₁ to HL_{K} in the first signal line driving period and a charge signal is output from each of the horizontal signal lines HL₁ to HL_{K} based on each electrostatic capacitance by driving the plurality of vertical signal lines VL₁ to VL_{L} in the second signal line driving period.

Due to this, in a case where the stylus pen S touches the touch panel 2, the detection position in the first signal line driving period and the detection position in the second signal line driving period are represented at the same position. On the other hand, a false signal due to noise generated at another position different from the touch position generated by the touch of the hand, finger, or the like of a human body receiving electromagnetic noise on the touch panel is not represented at the same position in the second signal line driving period even when represented in the first signal line driving period, due to switching and driving the first signal lines and the second signal lines.

Accordingly, the touch signal of the stylus pen S and the false signal due to noise are distinguished and it is possible to easily cancel the false signal due to noise.

Here, as the touch pen, in a case where the stylus pen S is used as an electronic pen which is able to input and output signals, it is necessary to obtain the synchronization with the synchronization signal used in the touch panel controller 3a in the stylus pen S.

In such a case, in the present reference embodiment, since the driver 112 as the synchronization signal transmission unit of the touch panel controller 3a transmits a synchronization signal to the stylus pen S in the respective synchronization signal transmission periods directly before the first signal line driving period and directly before the second signal line driving period, it is possible to create a synchronization signal using the driving signals for driving the first signal lines and the second signal lines. For this reason, since a separate circuit for creating a synchronization signal is not provided, it is possible to reduce the number of components.

Here, in a case of sending a synchronization signal from the touch panel controller 3a to the stylus pen S, since the low-frequency signal is superimposed as noise, when the separation of the noise is not correctly performed in a single pulse, the synchronization signal may be lost. On the other hand, in a plurality of pulses with no change in the same pitch, it is not clear which portion corresponds to the synchronization signal.

Here, in the present reference embodiment, the driver 112 of the touch panel controller 3a transmits the synchronization signal of the waveform which is a pseudo-random sequence having periodicity such as an M-sequence code or a Gold sequence code to the stylus pen S in the synchronization signal transmission period, and the stylus pen S is provided with the sense circuit 35 and the synchronization signal detection circuit 36 as a synchronization signal detection unit for detecting the synchronization signal.

For this reason, since the synchronization signal is transmitted with the waveform which is a pseudo-random sequence having periodicity, the autocorrelation characteristics are good. For this reason, the accuracy for identifying whether a signal is a synchronization signal or not is increased and it is possible to reduce lost synchronization signals.

Accordingly, it is possible to provide the touch panel system 1 which can correctly detect the synchronization signal.

Here, for example, when a synchronization signal where a low-frequency component is superimposed is received, in a case where the amplitude of the synchronization signal is detected by the received input waveform returning to the reference potential by periodically performing the reset operation, if the reset operation is performed when a High period or a Low period of the pulse is long, an unnecessary potential change is performed and the waveform determination is not easily performed.

Then, in the present reference embodiment, the synchronization signal of the waveform which is a pseudo-random sequence is Manchester coded. That is, in the Manchester encoding process, a process is performed in which “0” in the pseudo-random sequence is associated with High→Low of the synchronization waveform and “1” is associated with Low→High of the synchronization waveform. The above may be reversed. Due to this, it is possible to prevent the High or Low period from becoming long.

In addition, in the touch panel system 1 of the present reference embodiment, the driver 112 as the synchronization signal transmission unit of the touch panel controller 3a serves as the driver 112 as the driving unit which supplies a driving signal for driving the horizontal signal lines HL₁ to HL_{K} as the plurality of first signal lines or the vertical signal lines VL₁ to VL_{L} as the plurality of second signal lines, and the driver 112 transmits the synchronization signal by changing the driving signal for driving the plurality of horizontal signal lines HL₁ to HL_{K} or the plurality of vertical signal lines VL₁ to VL_{L} to a waveform which is a Manchester coded pseudo-random sequence having periodicity.

Due to this, since the synchronization signal transmission unit is the driver 112 serving as the driving unit, it is possible to create a synchronization signal simply by changing the waveform pattern of the driving signal of the drive lines DL₁ to DL_{L} for driving the horizontal signal lines HL₁ to HL_{K} and the vertical signal lines VL₁ to VL_{L}. For this reason, since a separate circuit for creating a synchronization signal is not provided, it is possible to reliably reduce the number of components.

### Reference Embodiment 6

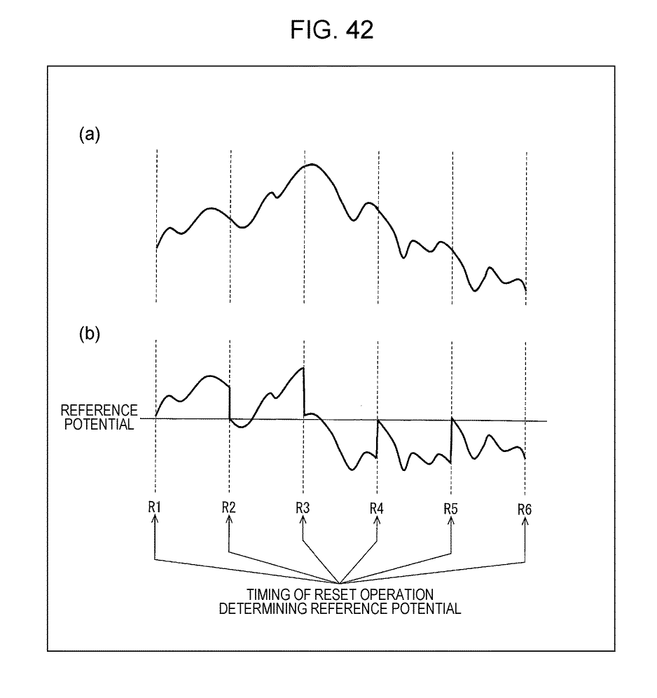

Description will be given below of another reference embodiment of the present invention based on FIG. 42 to FIG. 48. Here, the configuration other than as described in the present reference embodiment is the same as reference embodiment 5. In addition, for convenience of explanation, members having the same functions as members of reference embodiment 5 shown in the drawings are given the same reference numerals and description thereof is omitted.

(Characteristic Operation of Synchronization between Touch Panel Controller and Stylus Pen)

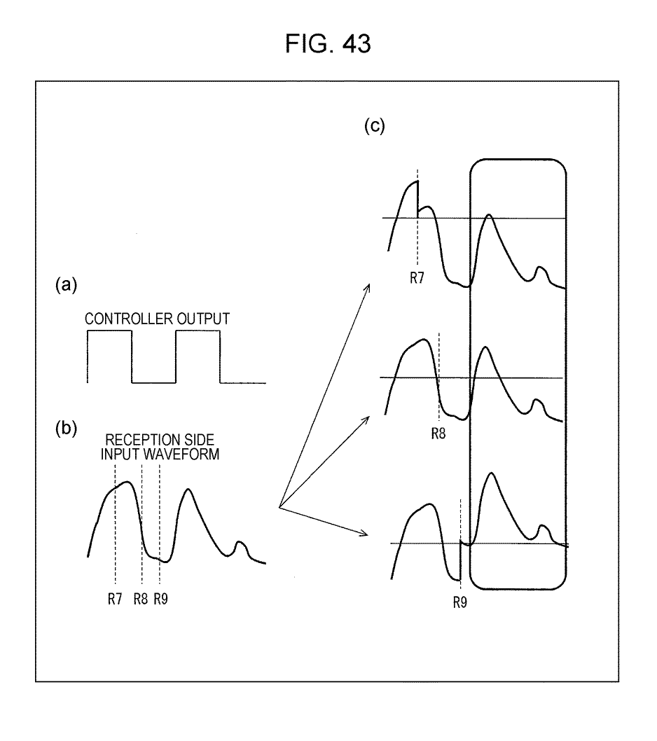

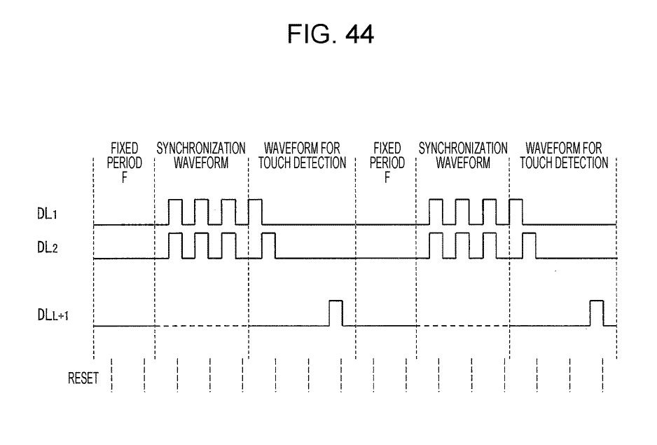

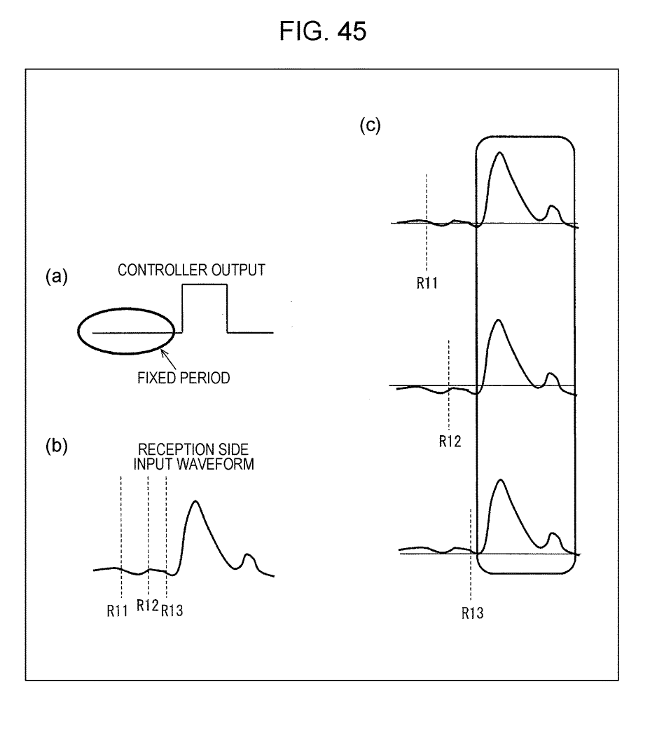

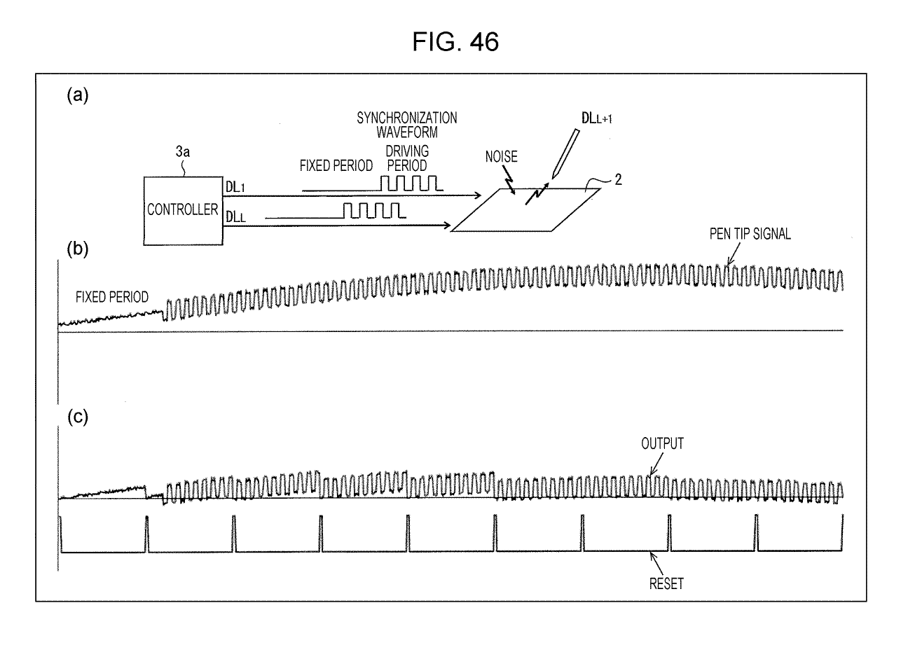

In the present reference embodiment, in the manner of obtaining the synchronization with the stylus pen S, description will be given of a method for preventing the generation of lost pulses of the dedicated synchronization signal based on FIGS. 42(a) and 42(b) to FIGS. 46(a) to 46(c). FIG. 42(a) is a waveform diagram which shows an input waveform of a signal received by the stylus pen in the touch panel system in the present reference embodiment, and FIG. 42(b) is a waveform diagram which shows an internal waveform when determining the reference potential at the reset timings R1 to R6. FIG. 43(a) is a waveform diagram which shows an example of a synchronization waveform transmitted from the touch panel controller, FIG. 43(b) is a waveform diagram which shows the reset timings R7, R8, and R9 of the input waveform received by the stylus pen, and FIG. 43(c) is a waveform diagram which shows the synchronization waveform when determining the reference potential at the reset timings R7, R8, and R9 shown in FIG. 43(b). FIG. 44 is a timing chart which shows an output waveform of the touch panel controller provided with a fixed period directly before the synchronization waveform is output. FIG. 45(a) is a waveform diagram which shows an example of a synchronization waveform transmitted from the touch panel controller, FIG. 45(b) is a waveform diagram which shows the reset timings R11, R12, and R13 of the input waveform received by the stylus pen, and FIG. 45(c) is a waveform diagram which shows the synchronization waveform when determining the reference potential at the reset timings R11, R12, and R13 shown in FIG. 45(b). FIG. 46(a) is a diagram which shows a method of transmitting a synchronization waveform transmitted by the drive lines DL₁ to DL_{L} of the driver in the touch panel controller, FIG. 46(b) is a waveform diagram which shows an input waveform received by a stylus pen, and FIG. 46(c) is a waveform diagram which shows the synchronization waveform when determining the reference potential by initially resetting in a fixed period shown in FIG. 46(b).

In the stylus pen S, for example, in a case where the input waveform shown in FIG. 42(a) is obtained, when a reset is carried out at reset timings R1 to R6 for determining the reference potential, the internal waveform shown in FIG. 42(b) is obtained.

In such a case, even when using the Manchester coded M-sequence code, as shown in FIGS. 43(a) to 43(c), depending on the timing of the reset operation for determining the reference potential, the potential may be different even in the same signal, and the fact that is it difficult to determine whether the output of the synchronization waveform of the touch panel controller 3a is High or Low is not changed. In other words, it is not known whether the second peak is High or Low.

Then, in the present reference embodiment, as shown in FIG. 44, directly before the synchronization waveform is output, the output waveform of the touch panel controller 3a is fixed by providing a fixed period F. The fixing time is set to a time which includes at least one reset operation timing for determining the reference potential in the stylus pen S which is the reception side.

Due to this, in the stage before the synchronization waveform is output, it is possible to determine a stable potential as the reference potential.

Specifically, as shown in FIGS. 45(a) and 45(b), the reference potential is determined by providing reset timings R11, R12, and R13 in the fixed period F. Due to this, as shown in FIG. 45(c), when detecting the synchronization waveform, it is easy to determine whether the output of the touch panel controller 3a is High or Low.

As a result, as shown in FIG. 44, by providing the fixed period F at the stage before the synchronization waveform is output, the potential of the time at which the reset operation is finished is the reference potential. For this reason, as shown in FIGS. 46(a) to 46(c), in the stylus pen S, by providing the fixed period F which is longer than the reset interval, the touch panel controller 3a always implements the reset one or more times before the synchronization signal detection period in a state where the driving potential is determined and it is possible to adjust the waveform in a stable state from the leading end of the synchronization signal detection period.

(Overall Operation of Touch Panel System and Stylus Pen)

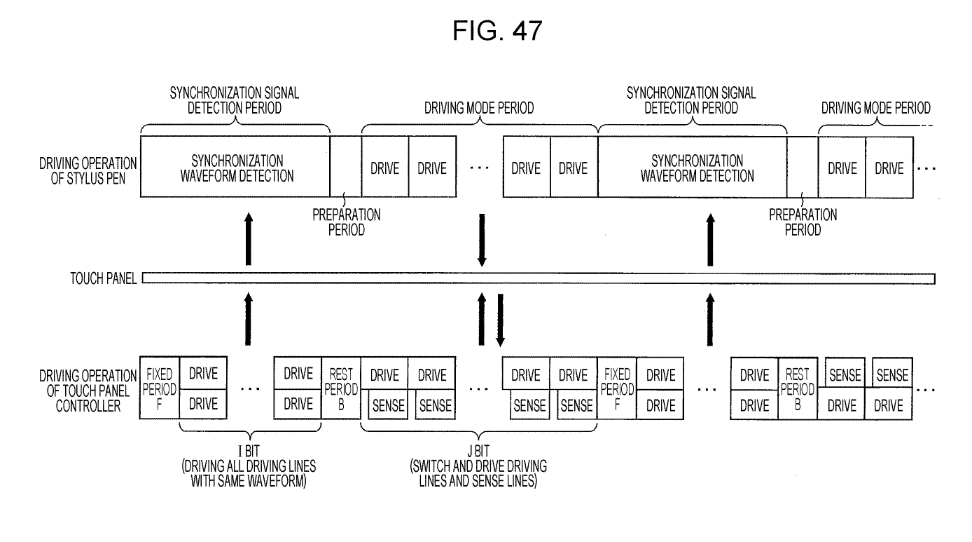

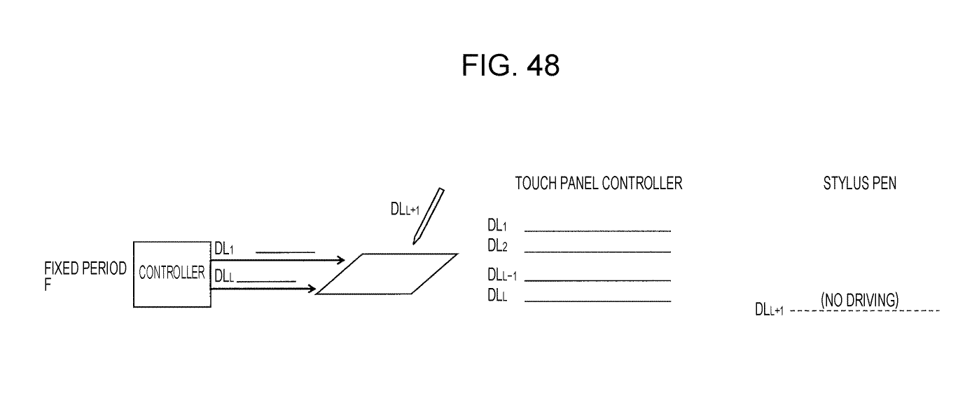

Description will be given of the overall operation of the touch panel system 1 and the stylus pen S of this configuration based on FIG. 47 and FIG. 48. FIG. 47 is an operation image diagram which shows a correspondence relationship between the driving operation of the touch panel controller 3a and the driving operation of the stylus pen S. FIG. 48 is a diagram which shows a specific driving operation of the fixed period shown in FIG. 47. Here, in the description of FIG. 47 and FIG. 48, the portions which are the same as FIG. 40 and FIGS. 41(a) to 41(c) of reference embodiment 5 will be described briefly.

As shown in FIG. 47, the stylus pen S includes a synchronization signal detection period for detecting the synchronization signal from the touch panel controller 3a using the sense circuit 35 and the synchronization signal detection circuit 36, a preparation period, and a driving mode period for driving the pen tip 31 using the driving circuit 38.

The synchronization signal detection period, the preparation period, and the driving mode period are as illustrated in FIG. 40 and FIGS. 41(a) to 41(c).

On the other hand, the touch panel controller 3a has a fixed period F, a period for driving the drive lines DL₁ to DL_{L} with the same waveform, a rest period B, and a period for driving the drive lines DL₁ to DL_{L} and reading the changes in the electrostatic capacitance in the sense lines SL₁ to SL_{L}.

The fixed period F is a period in which the stylus pen S stabilizes the signal level for detecting synchronization. In particular, as shown in FIG. 48, in the fixed period F, the drive lines DL₁ to DL_{L} are fixed at either Low or High. Here, the drive lines DL₁ to DL_{L} may be Low or High, but are Low in the present reference embodiment. For this reason, the drive lines DL₁ to DL_{L} of the touch panel controller 3a are 0. At this time, the drive line DL_{L+1} of the stylus pen S is not driven.

The period for driving the drive lines DL₁ to DL_{L} with the same waveform is a driving period of the synchronization waveform and the additional information for obtaining synchronization with the stylus pen S. Specifically, as shown in FIG. 41(b), the drive lines DL₁ to DL_{L} are driven with the same waveform.

The rest period B is a period in which the stylus pen S finishes synchronization detection and is a period for driving preparation. Specifically, as shown in FIG. 41(b), since the rest period B is a waiting time for providing a preparation period in which the stylus pen S detects the synchronization waveform to perform normal driving, the rest period B is completely arbitrary without significance for the driving waveform. Accordingly, driving need not be carried out. In addition, the drive line DL_{L+1} of the stylus pen S is also not driven. Here, in a case where the preparation period on the stylus pen S side is unnecessary, this section is unnecessary.

Next, the period for driving the drive lines DL₁ to DL_{L} and reading the changes in the electrostatic capacitance in the sense lines SL₁ to SL_{L} is a normal driving period for detecting the position for obtaining the data of one surface of the touch panel 2. Specifically, as shown in FIG. 41(c), in the normal driving period, the driving of the drive lines DL₁ to DL_{L} and the reading from the sense lines SL₁ to SL_{L} are repeated. As the driving method, sequential driving or parallel driving is performed. Here, in FIG. 41(c), sequential driving is represented so that the order of the driving pattern is easy to understand visually.

In a case where the stylus pen S detects the synchronization waveform, the drive line DL_{L+1} which corresponds to the outside of the touch panel 2 is driven. That is, by matching the driving of the drive lines DL₁ to DL_{L} according to the touch panel controller 3a, the waveform corresponding to the drive line DL_{L+1} is output. Here, in FIG. 41(c), the colored part in the background indicates the sense period, in other words, the period for detecting the electrostatic capacitance.

In this manner, in the touch panel system 1 of the present reference embodiment, when the sense circuit 35 and the synchronization signal detection circuit 36 as a synchronization signal detection unit of the stylus pen S as an electronic pen receive the synchronization signal where the low-frequency component is superimposed, the amplitude of the synchronization signal is detected by the received input waveform returning to the reference potential by periodically performing the reset operation. Due to this, it is possible to detect the amplitude of the synchronization signal at low cost without using an expensive low-frequency cut-off filter for the low-frequency component superimposed as noise.

Here, in a case where the reset operation is arbitrarily performed with respect to the received input waveform, when the reset operation is overlapped with the High portion of the pulse, since the signal waveform thereafter is negative, it is not possible to correctly recognize the High portion of the positive pulse. As a result, there is a concern that the synchronization signal will be lost.

Here, in the present reference embodiment, the synchronization signal transmission period is formed of a fixed period F in which the fixed synchronization signal where the waveform is fixed to be High or Low, and a pseudo-random sequence waveform period in which the synchronization signal of a waveform which is a pseudo-random sequence having periodicity such as an M-sequence code or a Gold sequence code is transmitted. Then, in the fixed period F, the reset operation is performed at least once.

Due to this, in the fixed period F in which the waveform is fixed to be High or Low, since the input waveform returns to the reference potential, it is possible to correctly determine whether the subsequent pulse is High or Low.

### Embodiment 1

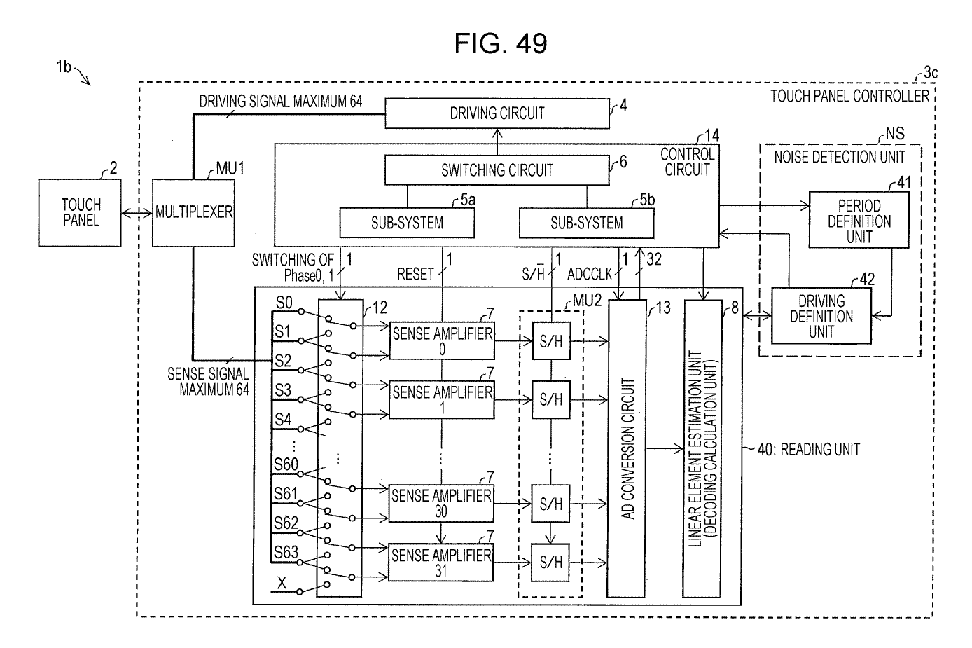

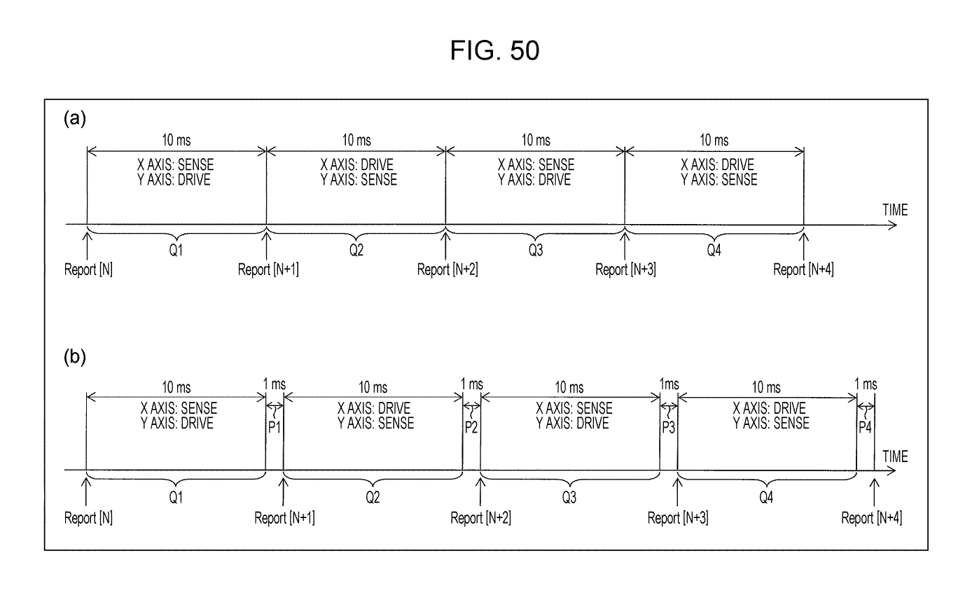

Description will be given of the first embodiment of the present invention based on FIG. 49 and FIG. 50. Here, for convenience of explanation, members having the same functions as the members described above are given the same reference numerals and description thereof will be omitted.

<<Configuration of Touch Panel System>>

FIG. 49 is a circuit diagram which shows a configuration of the touch panel system 1b of the present embodiment.

As shown in FIG. 49, the touch panel system 1b is provided with the touch panel 2 and a touch panel controller 3c.

The touch panel controller 3c is provided with the driving circuit 4, the control circuit 14, the reading unit 40, a noise detection unit NS, and multiplexers MU1 and MU2.

(Reading Unit)

The reading unit 40 includes the switching circuit 12, the amplifier circuit 7 (sense amplifier), the AD conversion circuit 13, and the decoding calculation circuit 8.

In addition, the reading unit 40 is connected to the touch panel 2, the control circuit 14, and the noise detection unit NS.

In addition, the reading unit 40 is provided in order to read a linear sum signal along the horizontal signal lines (second signal lines) described above based on the charge accumulated in the capacitor of the touch panel 2 driven by the driving circuit 4.

(Noise Detection Unit)

The noise detection unit NS includes a period definition unit 41 and a driving definition unit 42.

In addition, the noise detection unit NS is connected to the control circuit 14 and the reading unit 40.

(Period Definition Unit)

The period definition unit 41 is connected to the control circuit 14 and the driving definition unit 42.

In addition, the period definition unit 41 acquires a driving pattern of the driving circuit 4 via the control circuit 14. Then, the period definition unit 41 defines a noise reading period for reading a noise signal mixed into the touch panel 2 while the driving circuit 4 does not drive the capacitor of the touch panel 2.

Here, examples of the “driving pattern” include the patterns listed below.

Frame unit driving shown in FIG. 11(a)

Phase continuous driving shown in FIG. 11(b)

Same vector continuous driving shown in FIG. 11(c)

Plural vector continuous driving shown in FIG. 11(d) Phase continuous reverse driving shown in FIG. 12(a) which reverses the even-numbered times of driving in the phase continuous driving shown in FIG. 11(b)

Same vector continuous reverse driving shown in FIG. 12(b) which reverses the two phase driving of even-numbered times in the same vector continuous driving shown in FIG. 11 (c)

Plural vector continuous reverse driving shown in FIG. 12(c) which reverses the driving of a plurality of vectors of even-numbered times in the plural vector continuous driving shown in FIG. 11(d)

Description will be given below of the details of the operation in which the period definition unit 41 defines the noise reading period.

(Driving Definition Unit)

The driving definition unit 42 is connected to the control circuit 14, the reading unit 40, and the period definition unit 41.

In addition, the driving definition unit 42 defines the driving pattern of the touch detection period based on the noise signal read by the reading unit 40 in the noise reading period. Then, in the control circuit 14, the switching circuit 6 is linked to the driving circuit 4 by switching the sub-systems 5a and 5b such that the driving circuit 4 drives the drive lines of the touch panel 2 according to the driving pattern defined by the driving definition unit 42.

(Multiplexer)

The multiplexer MU1 is provided with the configuration described above. The multiplexer MU2 includes a plurality of sample and hold (S/H) circuits. In addition, the multiplexer MU2 is connected between the amplifier circuit 7 (sense amplifier) and the AD conversion circuit 13.

<<Operation of Touch Panel System>>

(Definition of Noise Reading Period)

FIG. 50 are timing charts for illustrating an operation in which the period definition unit 41 defines noise reading periods P1 to P4 in the touch panel system 1b shown in FIG. 49; FIG. 50(a) shows an operation before the noise reading periods P1 to P4 are defined, and FIG. 50(b) shows an operation after the noise reading periods P1 to P4 are defined.

As shown in FIG. 50(a), the touch panel system 1b switches the connection state of the drive lines and the sense lines for each touch detection period Q1 to Q4 (for example, 10 milliseconds (ms)), for example, according to the configuration shown in FIG. 24 to FIG. 27.

Here, the present invention is not limited to the operation for switching the connection state between the drive lines and the sense lines for each touch detection period Q1 to Q4, and may carry out an operation in which touch detection periods of the same type are continuous.

In FIGS. 50(a) and 50(b), the “X axis: Sense” has the meaning of a state in which the multiplexer MU1 shown FIG. 49 and FIG. 24 connects the horizontal signal lines HL1 to HLM shown in FIG. 25 to the sense lines SL1 to SLM. In addition, “Y axis: drive” has the meaning of a state in which the multiplexer MU1 connects the vertical signal lines VL1 to VLM to the drive lines DL1 to DLM.

In addition, “X axis: drive” has the meaning of a state where the multiplexer MU1 connects the horizontal signal lines HL1 to HLM to the drive lines DL1 to DLM. In addition, “Y axis: sense” has the meaning of a state where the multiplexer MU1 connects the vertical signal lines VL1 to VLM to the sense lines SL1 to SLM.

As shown in FIG. 50(b), the period definition unit 41 defines the noise reading periods P1 to P4 in a period with a length of 1 ms in which each time period shown by Report [N+1] to Report [N+4] set as an ending point.

Here, 1 ms before the time Report [N+1], since the driving of the capacitor is completed by the driving circuit 4, the value of the linear sum signal is converged due to the driving of the capacitor by the driving circuit 4. The same applies to the other time Report [N+2] to Report [N+4].

(Determination of Noise)

In the noise reading periods P1 to P4, the value of the linear sum signal generated by the driving of the capacitors by the driving circuit 4 is converged (for example, 0). Therefore, in the noise reading periods P1 to P4, as the linear sum signal read by the reading unit 40, it is possible to read a linear sum signal not generated in the driving of the capacitors (in other words, noise) by the driving circuit 4.

Noise is generated, for example, by an object (a human finger or a touch pen) contacting the touch panel such that a signal is mixed in from a noise source (AC adapter, fluorescent light, or the like) other than this object.

Based on the noise read in the predetermined noise reading period P1, the driving definition unit 42 defines the driving pattern in the touch detection period Q2 which is a period after the predetermined noise reading period P1. At this time, based on the method described above, as the driving pattern, it is possible to define a pattern with a large amount of noise suppression. Here, the same applies to the touch detection periods Q3 and Q4 which are periods after the noise reading periods P2 and P3 respectively. In addition, a noise reading period may also be provided before the touch detection period Q1.

According to the above, in order to detect the noise, it is not necessary to switch the connection state between the drive lines and sense lines. Then, the noise is read in the operation of the touch panel 2 and it is possible to suppress the influence of noise which changes over time in a timely manner in the touch detection. Furthermore, it is not necessary to operate the touch panel simply to read the noise and noise is read in a timely manner at a frequency (frequency 90.9 Hz) of once every 11 ms.

### Comparative Example

The electrostatic capacitance value distribution detection apparatus of PTL 1 switches the connection state between the drive lines and the sense lines at regular times in the same manner as the operation shown in FIG. 50(a). However, in a case where the electrostatic capacitance value distribution detection apparatus of PTL 1 detects the noise in the time Report [N], the time for detecting the subsequent noise has to be in the time Report [N+2] after the touch detection period Q2. This is because, if the electrostatic capacitance value distribution detection apparatus of PTL 1 does not compare the electrostatic capacitance value distribution detection result in the touch detection period Q1 and the electrostatic capacitance value distribution detection result in the touch detection period Q2, it is not possible to detect the noise.

In other words, in the electrostatic capacitance value distribution detection apparatus of PTL 1, it is necessary to operate the touch panel simply to read the noise and it is only possible to read the noise at a frequency (frequency of 50 Hz) of at least once every 20 ms.

<<Effect of Touch Panel System>>

In order to detect the noise, it is not necessary to switch the connection state between the drive lines and the sense lines. Then, the noise is read in the operation of the touch panel 2 and it is possible to suppress the influence of noise which changes over time in a timely manner in the touch detection. Furthermore, it is not necessary to operate the touch panel simply in order to read the noise, and it is possible to read the noise in a timely manner compared to a related art technique such as the electrostatic capacitance value distribution detection apparatus of PTL 1.

Here, as shown in FIG. 23, the touch panel system 1b can be incorporated into a part of the mobile phone 90 (electronic equipment).

### Embodiment 2

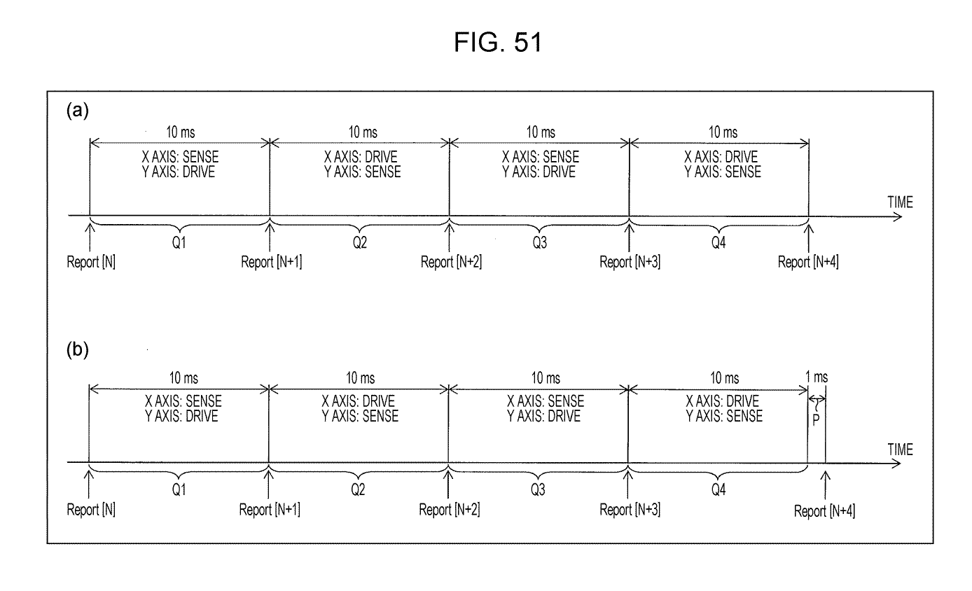

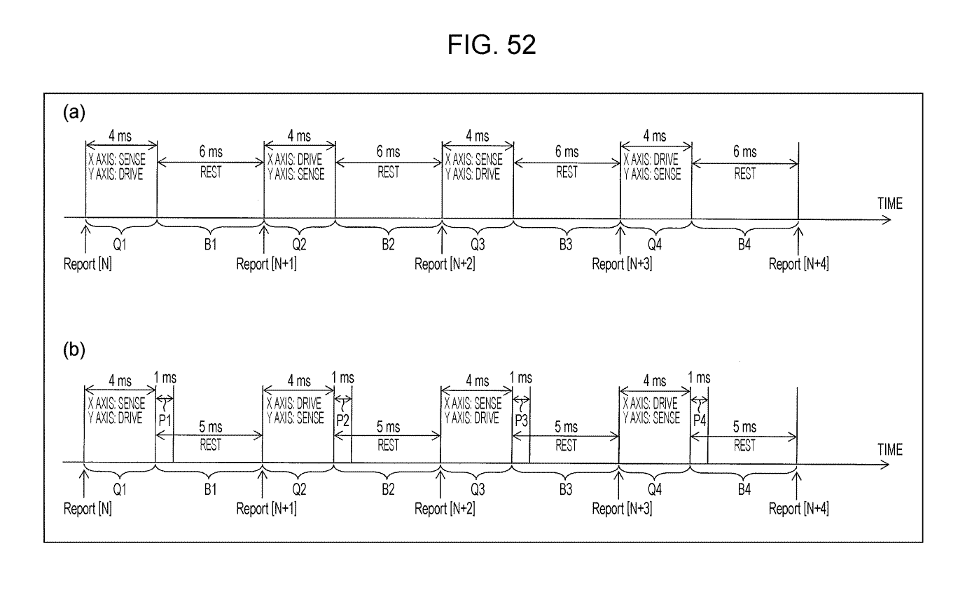

Description will be given of the second embodiment of the present invention based on FIG. 51 and FIG. 52. Here, for convenience of explanation, members having the same functions as the members described in the embodiments are given the same reference numerals and description thereof will be omitted.

<<Various Configurations and Operations for Defining Noise Reading Period and Effects Thereof>>

(Noise Reading Period Definition Position)

FIG. 51 are timing charts for illustrating the operation in which the period definition unit 41 defines the noise reading period P in the touch panel system 1b of the present embodiment shown in FIG. 49; FIG. 51(a) shows the operation before the noise reading period P is defined and FIG. 51(b) shows the operation after the noise reading period P is defined.

As shown in FIG. 51(a), the touch panel system 1b switches the connection state between the drive lines and the sense lines every 10 ms, for example, according to the configuration shown in FIG. 24 to FIG. 27.

Then, as shown in FIG. 51(b), the period definition unit 41 may define the noise reading period P in a period of 1 ms in which the time Report [N+4] is set as the end point.

In this manner, when the period definition unit 41 defines the noise reading period P from the driving pattern of the driving circuit 4, it is not always necessary to define the noise reading period P every touch detection period Q1 to Q4.

In the example shown in FIG. 51(b), the reading unit 40 reads the noise at a frequency (frequency of 24.4 Hz) of once in 41 ms. If the desired noise reading frequency is 24.4 Hz or less, the noise reading period P may be defined as shown in FIG. 51(b).

In addition, a configuration may be adopted in which the related art method shown in PTL 1 (for example, acquiring a noise metric) is continuously performed and a noise reading period is provided when the threshold level which is the noise metric is exceeded. In this method, the change itself in the noise frequency or noise amount is determined by the related art technique. In order to perform the operation of the driving definition unit 42, in the period definition unit 41, the period for reading the noise signal mixed in the touch panel 2 is determined while the driving circuit 4 does not drive the capacitor of the touch panel 2.

(Definition of Noise Reading Period in Power-Saving Rest Period)

FIG. 52 are timing charts for illustrating an operation in which the period definition unit 41 defines the noise reading periods P1 to P4 in the touch panel system 1b shown in FIG. 49; FIG. 52(a) represents an operation before the noise reading periods P1 to P4 are defined and FIG. 52(b) represents an operation after the noise reading periods P1 to P4 are defined.

As shown in FIG. 52(a), in order to suppress the power consumption of the touch panel system 1b, the driving circuit 4 may pause the driving of the drive lines in rest periods B1 to B4 (power-saving periods; for example, 6 ms periods) between the touch detection periods Q1 to Q4 (for example, 4 ms periods).

In such a case, as shown in FIG. 52(b), the period definition unit 41 may define the noise reading period P1 (for example, a period of 1 ms) in the rest period B1. The same applies to the noise reading periods P2 to P4.

By the above, it is possible to read the noise in a timely manner at a frequency (frequency 100 Hz) of once every 10 ms while reducing the power consumption of the touch panel system 1b.

(Definition of Noise Reading Period in Form Used with Touch Pen)

The touch panel system 1b may be used with a touch pen as described above.

In such a case, the period definition unit 41 may define one or a plurality of noise reading periods in a part or all of the rest period B (period in which the controller does not transmit a synchronization signal) shown in FIG. 40. In addition, the period definition unit 41 may define one or a plurality of noise reading periods in a part or all of the rest period B or the fixed period F shown in FIG. 47.

By the above, it is possible to read the noise in a timely manner while distinguishing the touch signal of the touch pen and the false signal due to noise and easily cancelling the false signal due to noise.

### Embodiment 3

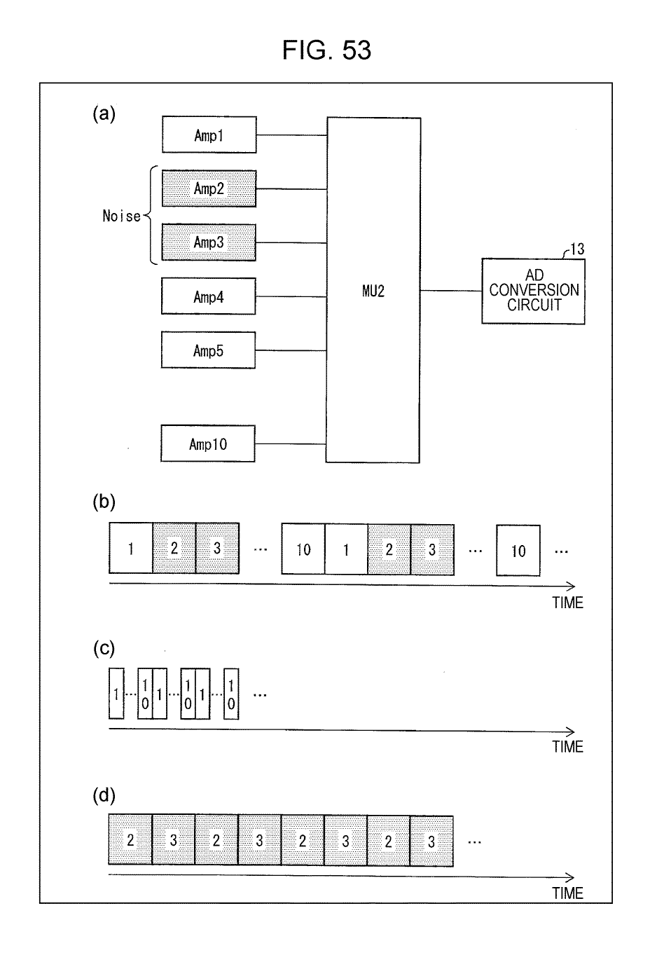

Description will be given of the third embodiment of the present invention based on FIG. 53. Here, for convenience of explanation, members having the same functions as the members described in the embodiments are given the same reference numerals and description thereof will be omitted.

<<Configuration and Operation for Optimizing Sampling Frequency and Effects Thereof>>

(Optimizing Sampling Frequency)

FIG. 53 are block diagrams which show a simplification of the reading unit 40 provided in the touch panel system 1b of the present embodiment shown in FIG. 49; FIG. 53(a) shows a simplified configuration of the reading unit 40, FIG. 53(b) shows a simplified operation of the reading unit 40, FIG. 53(c) shows another simplified operation of the reading unit 40, and FIG. 53(d) shows yet another simplified operation of the reading unit 40.

As shown in FIG. 53(a), the number of the amplifier circuits 7 included in the reading unit 40 is simplified to 10 (amplifier circuits Amp 1 to Amp 10). In addition, a plurality of S/H circuits shown in FIG. 49 are simplified as one multiplexer MU2.

As shown in FIG. 53(b), each of the outputs of the amplifier circuits Amp 1 to Amp 10 indicated by “1” to “10” is AD converted in order by the AD conversion circuit 13 via the multiplexer MU2.

Here, if the sampling frequency of the AD conversion circuit 13 is 10 mega-samples/sec (Msps) (in other words, if the sampling frequency of the AD conversion circuit 13 is 10 MHz), the frequency with which the output of one of the amplifier circuits in the amplifier circuits Amp 1 to Amp 10 is AD converted is 1 Msps. At this time, according to this sampling theory, the maximum frequency of the signal which is able to be restored from the output is 0.5 MHz.

In the above case, when the driving definition unit 42 defines the driving pattern in the period after the predetermined noise reading period based on the linear sum signal read in the predetermined noise reading period, by performing a high-speed Fast Fourier Transform (FFT) calculation or the like, it is possible to correctly estimate the noise frequency with respect to the noise of the low-frequency component up to a maximum of 0.5 MHz and it is possible to correctly define a driving pattern with a large suppression amount of noise with respect to the noise of the frequency component up to a maximum of 0.5 MHz.

Here, the AD conversion circuit 13 may be set with a low sampling frequency in order to save power. In such a case, as shown in FIG. 53(c), the sampling frequency of the AD conversion circuit 13 is, for example, raised up to 100 Msps and the cycle in which the output of one amplifier circuit out of the amplifier circuits Amp 1 to Amp 10 is set to 10 Msps.

In the above case, when the driving definition unit 42 defines the driving pattern in the period after the predetermined noise reading period based on the linear sum signal read in the predetermined noise reading period, by performing FFT calculation or the like, it is possible to correctly estimate the noise frequency with respect to the noise of the low-frequency component up to a maximum of 5 MHz and it is possible to correctly define a driving pattern with a large suppression amount of noise with respect to the noise of the frequency component up to a maximum of 5 MHz.

Here, it is also possible to increase the sampling frequency of the AD conversion circuit 13 by increasing the number of AD conversion circuits 13 or setting the AD conversion circuits 13 in parallel. In such a case, the sampling frequency may be increased up to the maximum frequency at which it is possible to measure a significant noise.

Specifically, the driving definition unit 42 may define the sampling frequency number of the AD conversion circuit 13 with twice the maximum frequency of the noise signal read by the AD conversion circuit 13 in the noise reading period described above as the upper limit.

(Optimization of Horizontal Signal Line for Sampling)

In the configuration shown in FIG. 53(a), in a case where the amplifier circuits 7 (in this example, the amplifier circuits Amp 2 and Amp 3) in which the noise is measured in advance are determined, the multiplexer MU2 may transmit only the output of the amplifier circuits Amp 2 and Amp 3 to the AD conversion circuit 13. In such a case, when the sampling frequency of the AD conversion circuit 13 is 10 Msps, it is possible to set the period in which the output of the amplifier circuits Amp 2 and Amp 3 is AD converted to 5 Msps.

When the driving definition unit 42 defines the driving pattern in the period after the predetermined noise reading period based on the linear sum signal read in the predetermined noise reading period, by performing FFT calculation or the like, it is possible to correctly estimate the noise frequency with respect to the noise of the low-frequency component up to a maximum of 2.5 MHz and it is possible to correctly define a driving pattern with a large suppression amount of noise.

Here, in order to specify the amplifier circuit where the noise is measured, a plurality of the amplifier circuits 7 may be examined in order.

In addition, as described above, by an object coming into contact with (touching) the touch panel, noise caused by a signal flowing from a noise source other than the object may be detected. Thus, in order to specify the amplifier circuit where noise is measured, the amplifier circuit 7 which is touched often (for example, the amplifier circuit 7 corresponding to the signal line of a sense line touched recently) may be examined as a priority. In such a case, in the noise reading period, the reading unit 40 may read the linear sum signal along the signal line of the sense line where touch is detected in the touch detection period before the noise reading period.

### Embodiment 4

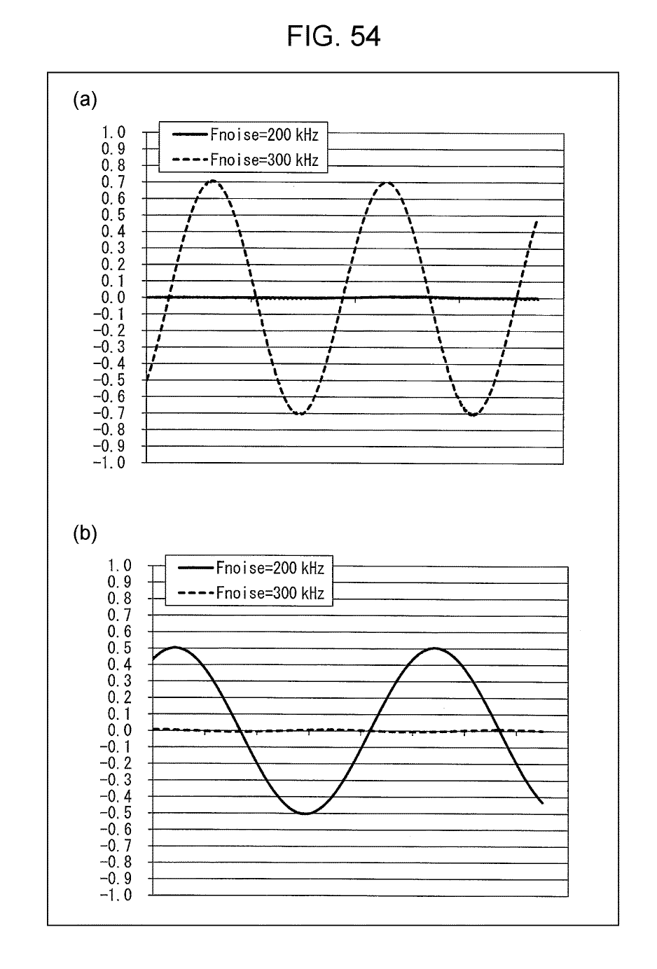

Description will be given of a fourth embodiment of the present invention based on FIG. 54. Here, for convenience of explanation, members having the same functions as the members described in the embodiments are given the same reference numerals and description thereof will be omitted.

<<Noise Identification of Frequency of Half Sampling Frequency or More>>

In order for the driving definition unit 42 shown in FIG. 49 to define a driving pattern with a greater noise reduction amount, it is desirable to be able to specify the correct noise frequency. In other words, the sampling frequency of the reading unit 40 is desirably as high as possible. However, the sampling frequency is limited by restrictions such as the operation frequency of the reading unit 40.

(Example of Anticipated Adverse Effects)

In a case where the sampling frequency Fs of the reading unit 40 is 500 kHz (corresponding to a sampling interval of 2 us), the maximum frequency of the signal which the reading unit 40 is able to correctly measure is 250 kHz. Then, the frequency component of 250 kHz or more in the signals measured by the reading unit 40 is measured as a frequency different from the original frequency (so-called “folding”).

At this time, assuming that noise of 300 kHz is superimposed on the signal to be measured by the reading unit 40, the frequency component of the signal to be measured by the reading unit 40 may be estimated (erroneously determined) to be 200 kHz.

Then, when the driving definition unit 42 defines (assigns a notch) the driving pattern where the suppression amount of the influence of noise where the frequency is 200 kHz, the frequency component of 300 kHz which is the actual noise may not be sufficiently suppressed.

(Noise Identification of Frequency of Half Sampling Frequency or More)

Here, the sampling frequency Fs of the reading unit 40 is known. At this time, when the noise frequency superimposed on the signal measured by the reading unit 40 is F noise, the folding frequency Ff is determined by “Ff=Fs−F noise”.

Then, the driving definition unit 42 defines a driving pattern where the suppression amount is great with respect to the signal of the noise frequency F noise (assigns a notch corresponding to the noise frequency F noise), and it is determined whether or not the influence of noise is reduced by the method described below. When the influence of noise is not reduced, the driving definition unit 42 defines a driving pattern where the suppression amount is great with respect to the signal of the folding frequency Ff and it is determined whether or not the influence of noise is reduced.

(Method for Determining Whether or Not Influence of Noise is Reduced)

The time of one phase (phase length) is determined with respect to the driving pattern (defined by the driving definition unit 42) which assigns a notch. In the noise reading period with this phase length (period in which the drive lines are not driven), the reading unit 40 is operated in the same manner as the noise analysis operation described above, the output of the AD conversion circuit 13 (the AD damping value) is acquired, and, when an averaging process including addition and subtraction corresponding to the driving pattern which the driving definition unit 42 is to define, it is possible to determine whether or not the influence of noise is reduced (magnitude of the noise mixing amount).

FIG. 54 are graphs which show the result of simple addition-averaging two continuous outputs of the AD conversion circuit 13 according to the setting of the phase length; FIG. 54(a) shows a graph in a case where the sampling frequency of the AD conversion circuit 13 is 400 kHz, and FIG. 54(b) shows a case where the sampling frequency is 600 kHz.

As shown in FIG. 54(a), in a case where the sampling frequency of the AD conversion circuit 13 is 400 kHz, the value of the simple addition average is suppressed to 0 (a solid line) when the actual noise frequency F noise is 200 kHz. However, when the actual noise frequency F noise is 300 kHz, the value is not suppressed to 0 (a dashed line).

Next, as shown in FIG. 54(b), in a case where the sampling frequency of the AD conversion circuit 13 is 600 kHz, the value of the simple addition average is suppressed to 0 (a dashed line) when the actual noise frequency F noise is 300 kHz. However, when the actual noise frequency F noise is 200 kHz, the value is not suppressed to 0 (a solid line).

As described above, by comparing FIGS. 54(a) and 54(b), it is determined whether or not a notch is assigned, and it is possible to identify the actual noise frequency F noise of the noise superimposed on the signal measured by the reading unit 40. Then, it is possible to determine whether or not the influence of noise is reduced more quickly than in the related art methods (for example, a method for acquiring a noise metric).

Here, the above is an example of a case of phase continuous driving in which the driving pattern which is defined by the driving definition unit 42 drives a capacitor with two continuous phrases which are the same, and, for the determination of whether or not the influence of noise is reduced, the output of the AD conversion circuit 13 (AD damping value) may be acquired and an averaging process including addition and subtraction corresponding to the driving pattern to be defined by the driving definition unit 42 may be performed.

### Embodiment 5

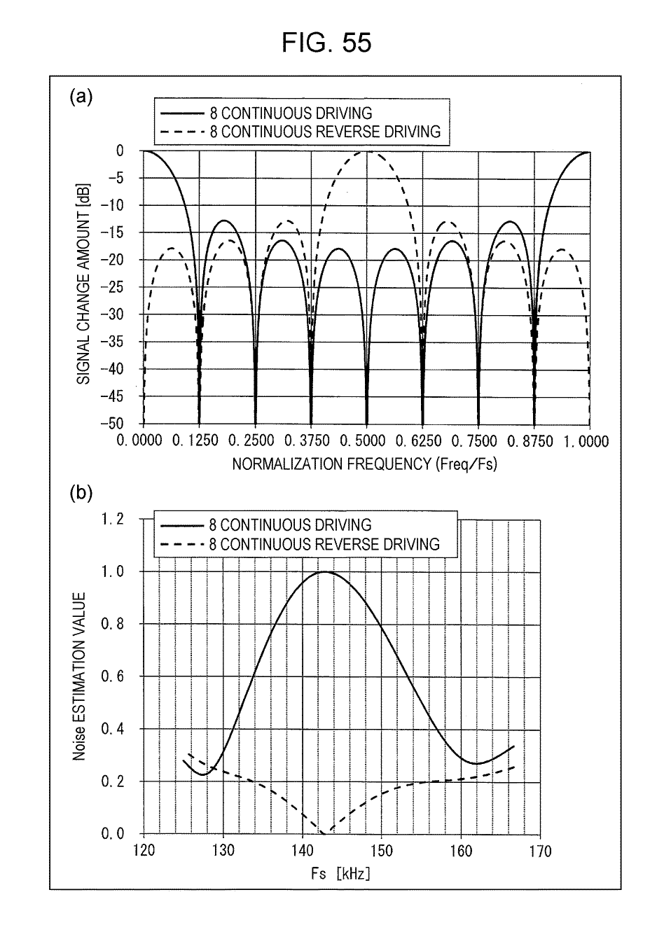

Description will be given of the fifth embodiment of the present invention based on FIG. 55. Here, for convenience of explanation, members having the same functions as the members described in the embodiments are given the same reference numerals and description thereof will be omitted.

<<Optimization of Sampling Frequency in Specific Driving Pattern>>

In the noise reading period, by the reading unit 40 reading the linear sum signal, the frequency of the noise superimposed on the signal measured by the reading unit 40 is determined in the touch detection period. In such a case, it is possible to optimize the sampling frequency and to suppress the influence of noise with the following method.

(Optimization in Same Vector Continuous Driving Pattern where Sampling Number is 8)

The driving pattern defined by the driving definition unit 42 is set to, for example, the same vector continuous driving pattern of FIG. 11(c) in which the sampling number is 8.

In such a case, for the relationship between the sampling frequency Fs and the noise frequency F noise, the sampling frequency Fs which satisfies the following formula is determined with the predetermined allowable error set as ΔE. Here, N is an integer in the following formula.

F noise/Fs=N+((⅛±ΔE) or ( 2/8±ΔE) or (⅜±ΔE) or ( 4/8±ΔE) or (⅝±ΔE) or ( 6/8±ΔE) or (⅞±ΔE)) Formula (1)

Hereinafter, the phase period has the meaning represented by the relational expression “Fs=Fclk/(PP×2)” when the phase period is PP, the sampling frequency is Fs, and the reference clock frequency of the touch panel system 1b is Fclk.

In addition, the normalization frequency has the meaning of the numerical value represented by “F noise/Fs” (the left hand side of the above Formula (1)) when the noise frequency superimposed on the signal to be measured by the reading unit 40 is set as F noise.

Here, the following (A) to (C) are assumed.

(A) The phase period PP is included in the search range 120 to 160, for example, 133.

(B) The frequency of the reference clock of the touch panel system 1b shown in FIG. 49 is 40 MHz.

(C) The noise frequency F noise is 93.75 kHz.

At this time, since the sampling frequency Fs is determined to be 40 [MHz]/(133×2)=150.376 [kHz], the normalization frequency F noise/Fs is determined to be 0.623.

Then, when the allowable error ΔE in the above Formula (1) is set to 0.01, the normalization frequency F noise/Fs is included in the range of (⅝±ΔE).

Thus, when the sampling frequency is 150.376 kHz (in other words, the phase period PP is 133), by the driving definition unit 42 defining the same vector continuous driving pattern in FIG. 11(c) in which the sampling number is 8 as the driving pattern, it is understood that it is possible to suppress the influence of noise (assigns a notch).

Here, it is desirable to optimize the sampling frequency so as to minimize ΔE.

As described above, the driving definition unit 42 defines the sampling frequency of the reading unit from the driving pattern (for example, a same vector continuous driving pattern where the sampling number is 8) and the frequency (for example, 93.75 kHz) of the signal based on the linear sum signal read in the predetermined noise reading period.

<<Suppression of Influence of Noise Included in Plurality of Frequency Components>>

In the noise reading period, the frequency of the noise superimposed on the signal measured by the reading unit 40 is determined by the reading unit 40 reading the linear sum signal. Thus, there are a plurality of noise frequencies. Even in such a case, it is possible to suppress the influence of plurality of noise frequencies by the following method.

In the example of the present embodiment, the candidates of the driving pattern which can be defined by the driving definition unit 42 are set as the following two driving patterns (a) and (b).

(a) Same vector continuous driving of FIG. 11(c) in which the sampling number is 8 in a case where reverse driving is not performed

(b) Same vector continuous reverse driving of FIG. 12(b) in which the sampling number is 8 in a case where reverse driving is performed

FIG. 55 are graphs which show noise transfer characteristics in the same vector continuous driving of FIG. 11(c) in which the sampling number is 8 and in the same vector continuous reverse driving of FIG. 12(b) in the present embodiment of the present invention; FIG. 55(a) shows a relationship between the signal change amount and the normalization frequency, and FIG. 55(b) shows the noise estimate amount with respect to the sampling frequency.

Here, the “signal change amount” has the same meaning as the signal change amount shown in the vertical axis of FIG. 18 to FIG. 20 described above.

As shown in FIG. 55(a), even when the driving pattern is the same, the signal change amount (in other words, the noise suppression amount) with respect to the normalization frequency changes in a case where reverse driving is not performed and a case where reverse driving is performed.

Thus, for example, when the frequency of the noise superimposed on the signal measured by the reading unit 40 is noise frequency F noise 1 (35.714 kHz) and noise frequency F noise 2 (142.857 kHz), based on the graph of FIG. 55(a), it is difficult to determine whether or not reverse driving is to be performed.

Then, a noise estimate amount Nest represented by the following formula is introduced. In the following formula, the signal change amount shown in FIG. 55(a) is f(Fn) when the amplitude of the noise where the noise frequency is F noise 1 is A noise 1, the amplitude of the noise where the noise frequency is F noise 2 is A noise 2, and the normalization frequency is Fn.

Nest=sqrt((A noise 1×f(F noise 1/Fs))̂2+(A noise 2×f(F noise 2/Fs))̂2) Formula (2)

As shown in FIG. 55(b), it is understood that the noise estimation amount Nest represented by the above Formula (2) is set to a minimum value when the sampling frequency is 142.857 kHz (in other words, the phase period PP is 140) in a case where the driving pattern is a driving pattern in which reverse driving is performed.

As described above, the driving definition unit 42 defines the sampling frequency of the reading unit 40 from the noise frequency (for example, the noise frequency F noise 1 or the noise frequency F noise 2) which is the signal frequency based on the linear sum signal read in the predetermined noise reading period, and the signal change amount (for example, the signal change amount shown in FIG. 55(a)) of the driving pattern in the noise frequency.

<<Effect of Present Embodiment>>

In a specific driving pattern defined by the driving definition unit 42, it is possible to suppress the influence of noise by optimizing the sampling frequency of the reading unit 40.

In addition, as shown in FIG. 49, the plurality of sub-systems provided in the control circuit 14 can be configured as various types based on the explanation described above in order to reduce the influence of external noise. In other words, as the driving pattern defined by the driving definition unit 42, there are various patterns.

Here, for example, a sub-system in which the embodiment unit which adds and averages a plurality of linear sum signals based on the same phase driving in the same vector driving is set as a frame unit, a sub-system in which the embodiment unit which adds and averages is set as a phase unit, a sub-system in which the embodiment unit which adds and averages is set as a vector unit, and a sub-system in which the embodiment unit which adds and averages is set as a plurality of vector units are provided, and these sub-systems can be configured to be selected in order to reduce the influence of external noise based on the frequency characteristics between the normalization frequency and the amplitude change rate (signal change amount).

In this manner, even in a situation in which it is possible to select a plurality of driving patterns, it is possible to optimize the sampling frequency of the reading unit 40 and to suppress the influence of noise with a plurality of frequencies.

[Summary]

The touch panel system according to aspect 1 of the present invention is the touch panel system 1, 1a, or 1b provided with the touch panel 2 having a plurality of capacitors formed respectively at intersections between a plurality of first signal lines (vertical signal lines VL₁ to VLM) and a plurality of second signal lines (horizontal signal lines HL₁ to HLM), and a controller (the touch panel controller 3, 3a, 3b, or 3c) controlling the touch panel, in which the controller is provided with the driving circuit 4 which drives the capacitors along the first signal lines based on a driving pattern in touch detection periods Q1 to Q4 which are periods for detecting a touch position on the touch panel, the reading unit 40 which is provided to read a linear sum signal along the second signal lines based on electrical charges stored in the capacitors driven by the driving circuit, the period definition unit 41 which defines noise reading periods P and P1 to P4 for reading a noise signal mixed into the touch panel in a period in which the driving circuit does not drive the capacitors, and the driving definition unit 42 which defines the driving pattern of the touch detection period based on the noise signal read by the reading unit in the noise reading period.

According to the above configuration, the driving definition unit is able to define a driving pattern where the suppression amount of the noise signal is great based on the noise signal in the noise reading period defined by the period definition unit.

According to the above, in order to detect the noise, it is not necessary to switch the connection state between the drive lines and the sense lines. Then, the noise is read in the operation of the touch panel and it is possible to suppress the influence of noise which changes over time in a timely manner in the touch detection. Furthermore, it is not necessary to operate the touch panel simply to read the noise, and it is possible to read the noise in a timely manner.

In the touch panel system according to aspect 2 of the present invention, the period definition unit in embodiment 1 may define the noise reading period in a power-saving period (rest periods B1 to B4) of the touch panel.

In the touch panel system according to aspect 3 of the present invention, aspect 1 or 2 is further provided with a touch pen which is able to input and output signals, in which the controller may transmit a synchronization signal to the touch pen and the period definition unit may define the noise reading period in a period (rest period B or fixed period F) where the controller does not transmit the synchronization signal.

In the touch panel system according to aspect 4 of the present invention, the driving definition unit in any one of aspects 1 to 3 may define a sampling frequency Fs of the reading unit from the driving pattern and a frequency of a signal based on the linear sum signal read in the predetermined noise reading period.

In the touch panel system according to aspect 5 of the present invention, the driving definition unit in any one of aspects 1 to 3 may define one driving pattern out of the driving patterns which are a plurality of candidates and a sampling frequency Fs of the reading unit from a noise frequency F noise, F noise 1, and F noise 2 which is a frequency of a signal based on the linear sum signal read in the predetermined noise reading period and a signal change amount of the driving patterns which are a plurality of candidates in the noise frequency.

In the touch panel system according to aspect 6 of the present invention, the driving definition unit of any one of aspects 1 to 5 may define a sampling frequency Fs of the reading unit by setting twice the maximum frequency of the noise signal read by the reading unit in the noise reading period as an upper limit.

In the touch panel system according to aspect 7 of the present invention, the reading unit of any one of aspects 1 to 6 may read the linear sum signal along the second signal lines where a touch is detected in the touch detection period.

In the touch panel system according to aspect 8 of the present invention, the driving definition unit of any one of aspects 1 to 7 may compare a noise mixing amount in the driving pattern in a noise frequency which is a frequency of a signal based on the linear sum signal read in the predetermined noise reading period and a noise mixing amount of the driving pattern in a folding frequency corresponding to the noise frequency, and may define the driving pattern where the noise mixing amount is small.

Electronic equipment according to aspect 9 of the present invention is provided with the touch panel system of any one of aspects 1 to 8.

[Additional Matters]

The present invention is not limited to each of the embodiments described above, various modifications within the scope of the claims are possible, and embodiments obtained by appropriately combining the technical means disclosed in each of the different embodiments are included in the technical scope of the present invention. Furthermore, it is possible to form new technical features by combining each technical means disclosed in each embodiment.

### INDUSTRIAL APPLICABILITY

The present invention can be used in a touch panel system and electronic equipment provided with a signal processing system which estimates the input of the value of the linear elements or the input of the linear elements by performing signal processing based on the addition and subtraction on a plurality of time-sequence signals based on linear elements which are sampled at discontinuous times, a touch panel which has a plurality of capacitors respectively formed at intersections between a plurality of drive lines and a plurality of sense lines, and a touch panel controller which controls the touch panel.

In addition, the present invention can be used in a touch panel system and electronic equipment detecting a touch position of a touch pen on a touch panel having electrostatic capacitance (capacitors) respectively formed at intersections between a plurality of first signal lines and a plurality of second signal lines, for example, use is possible in a mobile phone.

### REFERENCE SIGNS LIST

1, 1a, 1b TOUCH PANEL SYSTEM
3, 3a, 3b, 3c TOUCH PANEL CONTROLLER
4 DRIVING CIRCUIT
40 READING UNIT
41 PERIOD DEFINITION UNIT
42 DRIVING DEFINITION UNIT
90 MOBILE PHONE (ELECTRONIC EQUIPMENT)
B1 to B4 REST PERIOD (POWER-SAVING PERIOD)
B REST PERIOD (PERIOD IN WHICH CONTROLLER DOES NOT TRANSMIT SYNCHRONIZATION SIGNAL)
F FIXED PERIOD (PERIOD IN WHICH CONTROLLER DOES NOT TRANSMIT SYNCHRONIZATION SIGNAL)
Ff FOLDING FREQUENCY
F noise, F noise 1, F noise 2 NOISE FREQUENCY
Fs SAMPLING FREQUENCY
HL1 to HLM HORIZONTAL SIGNAL LINES (SECOND SIGNAL LINES)
MU1, MU2 MULTIPLEXER
P, P1 to P4 NOISE READING PERIOD
Q1 to Q4 TOUCH DETECTION PERIOD
VL1 to VLM VERTICAL SIGNAL LINES (FIRST SIGNAL LINES)

1. A touch panel system comprising:
a touch panel which has a plurality of capacitors respectively formed at intersections between a plurality of first signal lines and a plurality of second signal lines; and
a controller which controls the touch panel,
wherein the controller includes
a driving circuit which drives the capacitors along the first signal lines based on a driving pattern in a touch detection period which is a period for detecting a touch position on the touch panel,
a reading unit which is provided to read a linear sum signal along the second signal lines based on electrical charges stored in the capacitors driven by the driving circuit,
a period definition unit which defines a noise reading period for reading a noise signal mixed into the touch panel in a period in which the driving circuit does not drive the capacitors, and
a driving definition unit which defines the driving pattern of the touch detection period based on the noise signal read by the reading unit in the noise reading period.

2. The touch panel system according to claim 1,
wherein the period definition unit defines the noise reading period in a power-saving period of the touch panel.

3. The touch panel system according to claim 1, further comprising:
a touch pen which is able to input and output signals,
wherein the controller transmits a synchronization signal to the touch pen and the period definition unit determines the noise reading period in a period in which the controller does not transmit the synchronization signal.

4. The touch panel system according to claim 1,
wherein the driving definition unit defines a sampling frequency of the reading unit from the driving pattern and a frequency of a signal based on the linear sum signal read in the predetermined noise reading period.

5. The touch panel system according to claim 1,
wherein the driving definition unit defines one driving pattern out of driving patterns which are a plurality of candidates and a sampling frequency of the reading unit from a noise frequency which is a frequency of a signal based on the linear sum signal read in the predetermined noise reading period and a signal change amount of the driving patterns which are a plurality of candidates in the noise frequency.

6. The touch panel system according to claim 1,
wherein the driving definition unit defines a sampling frequency of the reading unit by setting twice a maximum frequency of the noise signal read by the reading unit in the noise reading period as an upper limit.

7. The touch panel system according to claim 1,
wherein the reading unit reads the linear sum signal along the second signal lines where a touch is detected in the touch detection period.

8. The touch panel system according to claim 1,
wherein the driving definition unit compares a noise mixing amount in the driving pattern in a noise frequency which is a frequency of a signal based on the linear sum signal read in the predetermined noise reading period and a noise mixing amount of the driving pattern in a folding frequency corresponding to the noise frequency, and defines the driving pattern where the noise mixing amount is small.

9. Electronic equipment comprising:
the touch panel system according to claim 1.
